(19) United States
(12) Patent Application Publication
(10) Pub. No.: US 2024/0281796 A1
(43) Pub. Date: Aug. 22, 2024

(54) Systems and Methods for Facilitating Digital Wallet-Based Transactions

(71) Applicant: Artema Labs, Inc, Los Angeles, CA (US)

(72) Inventors: Keir Finlow-Bates, Eura (FI); Bjorn Markus Jakobsson, New York, NY (US)

(73) Assignee: Artema Labs, Inc, Los Angeles, CA (US)

(21) Appl. No.: 18/582,328

(22) Filed: Feb. 20, 2024

Related U.S. Application Data
(60) Provisional application No. 63/485,792, filed on Feb. 17, 2023.
(60) Provisional application No. 63/485,785, filed on Feb. 17, 2023.
(60) Provisional application No. 63/597,605, filed on Nov. 9, 2023.
(60) Provisional application No. 63/609,747, filed on Dec. 13, 2023.

(51) Int. Cl. G06Q 20/36; H04L 9/00

(52) U.S. Cl. CPC G06Q 20/3674; H04L 9/50

(57) ABSTRACT

Systems and methods for facilitating token-based transactions performed in accordance with many embodiments of the invention are illustrated. One embodiment includes a method that receives a request to perform a transaction corresponding to a transfer of at least one token. The method selects, from a plurality of verifiers, a transaction verifier for the request. The method transmits a collection of data to the transaction verifier, wherein the collection of data: corresponds to at least one of the transaction or the request, and includes a recipient identifier and an authentication value for a requesting user. The method receives a validity evaluation for the transaction including: an assessment of whether the request is properly authenticated; and an assessment of whether the request complies with at least one security policy associated with the at least one token. The method evaluates the request based on the assessment(s).

### CROSS-REFERENCE TO RELATED APPLICATIONS

The current application claims the benefit of and priority under 35 U.S.C. § 119(e) to U.S. Provisional Patent Application No. 63/485,792, entitled “Voting System and Method for Non-Fungible Token Metadata and Assets Storage,” filed Feb. 17, 2023, U.S. Provisional Patent Application No. 63/485,785, entitled “Blockchain Wallet with Authentication Codes,” filed Feb. 17, 2023, U.S. Provisional Patent Application No. 63/597,605, entitled “Improvements to Blockchain Wallet Technology,” filed Nov. 9, 2023, and U.S. Provisional Patent Application No. 63/609,747, entitled “Trustee-Monitored Wallet Transactions,” filed Dec. 13, 2023, the disclosures of which are hereby incorporated by reference in their entireties for all purposes.

### FIELD OF THE INVENTION

The present invention generally relates to token storage, and more specifically, to digital wallet security.

### BACKGROUND

Non-fungible tokens (NFTs) provide a means for access management within computer systems and token marketplaces. This provides computer services and information vendors with an opportunity to sell NFTs as ownable assets providing access to particular content. In particular, an NFT may be used for assigning a digital representation of ownership for digital items, such as images, but also other physical items. A current holder of an NFT is typically provided asset usage rights for the underlying NFT asset. NFTs and other forms of tokens representing content have the capability to bolster a number of industries including but not limited to art, music, and technology.

Blockchain wallets are used to store tokens (e.g., NFTs) manage private keys, construct transactions based on user input, and transmit transactions to nodes maintaining a blockchain. The trading of tokens, such as NFTs may be used for (re-)assigning digital representations of ownership for digital items, such as images, but also other physical items. The current holder of the NFT is typically provided asset usage rights for the underlying NFT asset. Different tokens may be associated with different values, wherein some tokens, e.g., some NFTs, may be associated with very high values and some tokens may be associated with more moderate value. Nevertheless, these tokens can be fraudulently obtained through taking advantage of shortcomings in wallet security, allowing malign entities to access the stored assets.

### SUMMARY OF THE INVENTION

Systems and methods for facilitating token-based transactions performed in accordance with many embodiments of the invention are illustrated. One embodiment includes a method for authenticating a token transaction. The method receives a request to perform a transaction from a device, wherein the transaction corresponds to a transfer of at least one token. The method selects, from a plurality of verifiers, a transaction verifier for the request. The method transmits a collection of data to the transaction verifier, wherein the collection of data: corresponds to at least one of the transaction or the request, and includes a recipient identifier and an authentication value for a requesting user. The method receives, from the transaction verifier, a validity evaluation for the transaction, wherein the validity evaluation includes: a first preliminary assessment of whether the request is properly authenticated; and a second preliminary assessment of whether the request complies with at least one security policy associated with the at least one token. The method evaluates the request, wherein evaluating the request is based, at least in part, on at least one of the first preliminary assessment or the second preliminary assessment. Evaluating the request includes when the request is evaluated as unsafe, rejecting the request, and when the request is evaluated as safe, processing the request.

In a further embodiment, rejecting the request includes at least one of encrypting the request, removing authentication information from the request, requiring a second-factor authentication to proceed with the request, transmitting a request rejection to the device, or performing a direct verification of authorization to make the transaction. Further, processing the request includes at least one of transmitting the request to a blockchain node and transmitting a request acceptance to the device.

In another embodiment, a token of the at least one token is a non-fungible token (NFT).

In yet another embodiment, the authentication value includes at least one of a digital signature, a message authentication code, a one-time code, a password, or a personal identification number. Further, the first preliminary assessment includes a verification of whether the authentication value for the requesting user corresponds to an owner of a first token of the at least one token.

In yet another embodiment, evaluating the request first includes deriving a risk score for an initial sender of the transaction. The risk score is derived based on at least one of: the identity of the requesting user, or potential maliciousness of the transaction. The request is evaluated as unsafe when the risk score falls below a predetermined threshold. The request is evaluated as safe when the risk score meets or exceeds the predetermined threshold.

In another embodiment, each verifier in the plurality of verifiers is associated with a trust score. The trust score corresponds to an accuracy estimation of the verifier when authenticating requested transactions.

In still yet another embodiment, the transaction verifier is an automated agent that executes in a secure environment.

In a further embodiment, the automated agent is a machine learning model trained on evaluations performed for other requests by other verifiers of the plurality of verifiers.

In another embodiment, the collection of data further includes at least one of: a valuation of the transaction, a time limit corresponding to the transaction, a nonce corresponding to the transaction, a metadata file corresponding to the transaction, or a request header corresponding to the transaction.

In a further embodiment, the at least one security policy includes a requirement for one or more of: the recipient identifier not being on a recipient banlist; the recipient identifier being on a recipient allowlist; an internet protocol address of the device not being a requestor banlist; the internet protocol address of the device not being a requestor banlist; the valuation of the transaction falling under a predetermined transaction maximum; or the request being received during a certain time of day.

One embodiment includes a non-transitory computer-readable medium including instructions that, when executed, are configured to cause a processor to perform a process for authenticating a token transaction. The process receives a request to perform a transaction from a device, wherein the transaction corresponds to a transfer of at least one token. The process selects, from a plurality of verifiers, a transaction verifier for the request. The process transmits a collection of data to the transaction verifier, wherein the collection of data: corresponds to at least one of the transaction or the request, and includes a recipient identifier and an authentication value for a requesting user. The process receives, from the transaction verifier, a validity evaluation for the transaction, wherein the validity evaluation includes: a first preliminary assessment of whether the request is properly authenticated; and a second preliminary assessment of whether the request complies with at least one security policy associated with the at least one token. The process evaluates the request, wherein evaluating the request is based, at least in part, on at least one of the first preliminary assessment or the second preliminary assessment. Evaluating the request includes when the request is evaluated as unsafe, rejecting the request, and when the request is evaluated as safe, processing the request.

In a further embodiment, rejecting the request includes at least one of encrypting the request, removing authentication information from the request, requiring a second-factor authentication to proceed with the request, transmitting a request rejection to the device, or performing a direct verification of authorization to make the transaction. Further, processing the request includes at least one of transmitting the request to a blockchain node and transmitting a request acceptance to the device.

In another embodiment, a token of the at least one token is a non-fungible token (NFT).

In yet another embodiment, the authentication value includes at least one of a digital signature, a message authentication code, a one-time code, a password, or a personal identification number. Further, the first preliminary assessment includes a verification of whether the authentication value for the requesting user corresponds to an owner of a first token of the at least one token.

In yet another embodiment, evaluating the request first includes deriving a risk score for an initial sender of the transaction. The risk score is derived based on at least one of: the identity of the requesting user, or potential maliciousness of the transaction. The request is evaluated as unsafe when the risk score falls below a predetermined threshold. The request is evaluated as safe when the risk score meets or exceeds the predetermined threshold.

In another embodiment, each verifier in the plurality of verifiers is associated with a trust score. The trust score corresponds to an accuracy estimation of the verifier when authenticating requested transactions.

In still yet another embodiment, the transaction verifier is an automated agent that executes in a secure environment.

In a further embodiment, the automated agent is a machine learning model trained on evaluations performed for other requests by other verifiers of the plurality of verifiers.

In another embodiment, the collection of data further includes at least one of: a valuation of the transaction, a time limit corresponding to the transaction, a nonce corresponding to the transaction, a metadata file corresponding to the transaction, or a request header corresponding to the transaction.

In a further embodiment, the at least one security policy includes a requirement for one or more of: the recipient identifier not being on a recipient banlist; the recipient identifier being on a recipient allowlist; an internet protocol address of the device not being a requestor banlist; the internet protocol address of the device not being a requestor banlist; the valuation of the transaction falling under a predetermined transaction maximum; or the request being received during a certain time of day.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with some embodiments of the invention.

FIG. 2 is a network architecture diagram of an NFT platform in accordance with numerous embodiments of the invention.

FIG. 3 is a conceptual diagram of a permissioned blockchain in accordance with multiple embodiments of the invention.

FIG. 4 is a conceptual diagram of a permissionless blockchain in accordance with many embodiments of the invention.

FIGS. 5A-5B are diagrams of a dual blockchain in accordance with a number of embodiments of the invention.

FIG. 6 conceptually illustrates a process followed by a Proof of Work consensus mechanism in accordance with some embodiments of the invention.

FIG. 7 conceptually illustrates a process followed by a Proof of Space consensus mechanism in accordance with a number of embodiments of the invention.

FIG. 8 illustrates a dual proof consensus mechanism configuration in accordance with certain embodiments of the invention.

FIG. 9 illustrates a process followed by a trusted execution environment-based consensus mechanism in accordance with some embodiments of the invention

FIGS. 10-12 depict various devices that may be utilized alongside an NFT platform in accordance with various embodiments of the invention.

FIG. 13 depicts media wallet applications configured in accordance with several embodiments of the invention.

FIGS. 14A-14C depict user interfaces of various media wallet applications in accordance with a number of embodiments of the invention.

FIG. 15 illustrates an NFT ledger entry corresponding to an NFT identifier in accordance with certain embodiments of the invention.

FIGS. 16A-16B illustrate an NFT arrangement relationship with corresponding physical content in accordance with many embodiments of the invention.

FIG. 17 illustrates a process for establishing a relationship between an NFT and corresponding physical content in accordance with some embodiments of the invention.

FIGS. 18A-18B and FIG. 19 illustrate methods for trustee-evaluated requests enabled in accordance with various embodiments of the invention.

FIG. 20 conceptually illustrates a blockchain wallet configuration that may be deployed in accordance with numerous embodiments of the invention.

FIG. 21 conceptually illustrates an autonomous smart contract configured in accordance with multiple embodiments of the invention.

FIGS. 22-24 conceptually illustrate various architectures for a blockchain wallet configured, in accordance with various embodiments of the invention, with an associated authenticator.

FIG. 25 illustrates a collection of data structures implementing an NFT contract, configured in accordance with some embodiments of the invention, with individually controlled metadata URIs.

FIG. 26 conceptually illustrates the application of a collection of data structures in an NFT smart contract configured in accordance with miscellaneous embodiments of the invention.

FIGS. 27A-27B illustrates a smart contract, capable of being modified in accordance with some embodiments of the invention.

FIG. 28 illustrates a proposal acceptance performed in accordance with many embodiments of the invention.

FIG. 29 illustrates a process for performing alterations to an NFT smart contract parameter, performed in accordance with some embodiments of the invention.

FIG. 30 illustrates a device, configured in accordance with various embodiments of the invention, for implementing smart contracts and/or blockchain wallets in accordance with miscellaneous embodiments of the invention.

FIG. 31 illustrates deterministic generation of an account name performed in accordance with a number of embodiments of the invention.

FIG. 32 illustrates a hierarchical deterministic wallet with derivation paths for generating distinct subsets of keys, implemented in accordance with numerous embodiments of the invention.

FIG. 33 conceptually illustrates a transaction performed in accordance with several embodiments of the invention.

FIG. 34 illustrates a method for determining whether a transaction is permitted in accordance with certain embodiments of the invention.

FIG. 35 conceptually illustrates a Chaumian ecash approach for off-line transactions performed in accordance with various embodiments of the invention.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### DETAILED DESCRIPTION

Systems and methods for incorporating contract-directed and wallet-directed functionalities into non-fungible token (NFT) platforms, in accordance with many embodiments of the invention, are described herein. Such functionality may include, but is not limited to systems enabling smart contract modifications and/or (e.g., transactions implemented by) particular blockchain wallets to be verified.

Systems in accordance with various embodiments of the invention may be directed to authenticating wallets, changing wallets, and/or implementing wallet-initiated transactions. In accordance with some embodiments of the invention, transaction trustees may be selected (automated and/or human) entities enabled to evaluate transaction requests for the likelihood of fraud. In doing so, they may reject requests where the determined risk (e.g., measured through scores) suggests that the transaction is potentially malicious. Additionally or alternatively, blockchain wallets themselves may be authenticated through methods including but not limited to time-based one-time passwords, two-factor authentication (2FA), and/or blockchain wallet endorsements. Additionally or alternatively, systems may implement alternate wallet configurations, including but not limited to hierarchical deterministic wallets with derivation paths, allowing the wallets to generate subsets of keys with varying distinct sets of permissions.

Various embodiments of the invention may be directed to facilitate smart contract modifications. In accordance with miscellaneous embodiments of the invention, blockchain wallets may include but are not limited to smart contract templates and/or interfaces allowing users to select specific templates in an easy and intuitive manner. Additionally or alternatively, smart contracts configured in accordance with various embodiments of the invention may be able to execute functionality without requiring external action(s). Additionally or alternatively, smart contracts may implement functionality requiring two or more signatories to sign transactions to transfer assets the smart contract(s) hold, thereby facilitating arrangements including but not limited to joint ownership. Additionally or alternatively, smart contracts implemented in accordance with many embodiments of the invention may be changed using proposals (e.g., to change a base URI of the contract) that are then voted on. These proposals may be directed to contract-related actions including but not limited to deleting a specific token, minting more tokens, transferring a token, shutting down the token contract, etc.

While various techniques and systems are discussed above, wallet-directed mechanisms that may be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators may issue NFTs to users within the NFT platform. NFTs may be created around a large range of real-world media content and intellectual property. Movie studios may mint digital collectibles for their movies, characters, notable scenes and/or notable objects. Record labels may mint digital collectibles for artists, bands, albums and/or songs. Similarly, official digital trading cards may be made from likeness of celebrities, cartoon characters and/or gaming avatars.

NFTs minted using NFT platforms in accordance with various embodiments of the invention may have multifunctional programmable use cases including rewards, private access to premium content and experiences, as discounts toward the purchase of goods, among many other value-added use cases.

In many embodiments, each NFT may have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs may be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance may allow for incremental payment and ongoing asset protection. NFT storage may be additionally self-regulated through willing participants disclosing unsatisfactory NFT management in exchange for rewards.

In many embodiments, the NFT platform may include media wallet applications that enable users to securely store NFTs and/or other tokens on their devices. Furthermore, media wallets (also referred to as “digital wallets”) may enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users may download and install media wallet applications to store NFTs on the same computing devices used to consume streamed and/or downloaded content. Media wallet applications and NFTs may disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that may be utilized within NFT platforms in accordance with various embodiments of the invention are discussed further below.

### NFT Platforms

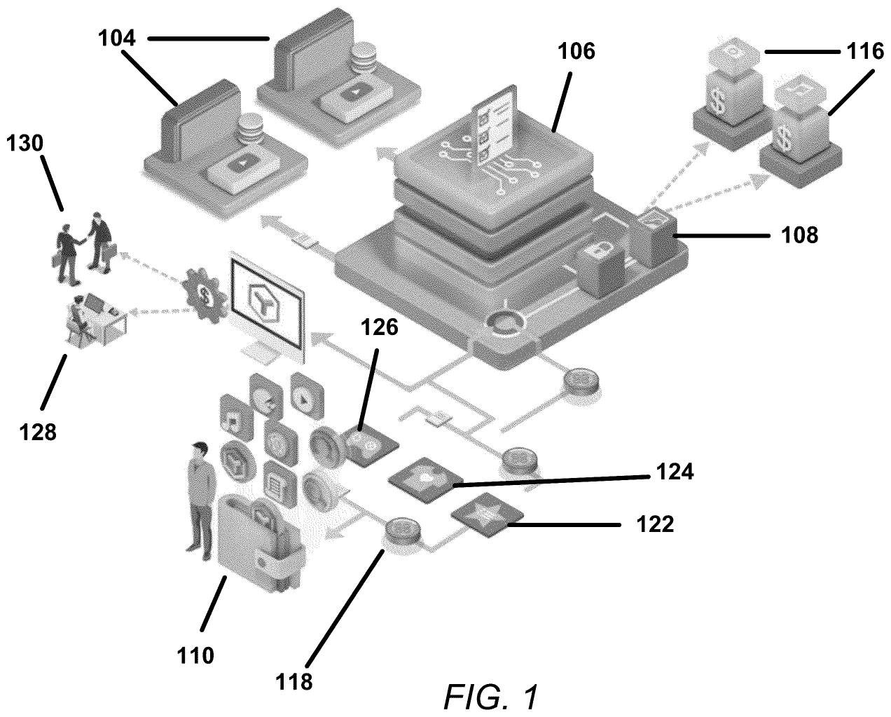

An NFT platform in accordance with an embodiments of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 may provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs may cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users may use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As may readily be appreciated, NFTs 106 that are implemented using smart contracts 108 having interfaces that comply with open standards are not limited to being stored within media wallets and may be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 may incentivize users to grant access to media consumption data using offers including (but not limited to) offers of fungible tokens 118 and/or NFTs 106. In this way, the ability of the content creators to mint NFTs enables consumers to engage directly with the content creators and may be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 may query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users may be content creators that are vetted by an administrator of networks that may be responsible for deploying and maintaining the NFT blockchain. Once the NFTs are minted, users may obtain and conduct transactions with the NFTs. In several embodiments, the NFTs may be redeemable for items or services in the real world such as (but not limited to) admission to movie screenings, concerts, and/or merchandise.

As illustrated in FIG. 1, users may install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens may be fully converted into fiat currency and/or other cryptocurrency. In several embodiments, the fungible tokens are implemented using split blockchain models in which the fungible tokens may be issued to multiple blockchains (e.g. Ethereum). As may readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application may automatically provide simplified views whereby fungible tokens and NFTs across multiple accounts and/or multiple blockchains may be rendered as single user profiles and/or wallets. In many embodiments, the single view may be achieved using deep-indexing of the relevant blockchains and API services that may rapidly provide information to media wallet applications in response to user interactions. In certain embodiments, the accounts across the multiple blockchains may be derived using BIP32 deterministic wallet key. In other embodiments, any of a variety of techniques may be utilized by the media wallet application to access one or more immutable ledgers as appropriate to the requirements of a given application.

NFTs may be purchased by way of exchanges 130 and/or from other users 128. In addition, content creators may directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and may be utilized in any NFT platform and/or with any media wallet application.

While the NFTs are shown as static in the illustrated embodiment, content creators may utilize users' ownership of NFTs to engage in additional interactions with the user. In this way, the relationship between users and particular pieces of content and/or particular content creators may evolve over time around interactions driven by NFTs. In a number of embodiments, collection of NFTs may be gamified to enable unlocking of additional NFTs. In addition, leaderboards may be established with respect to particular content and/or franchises based upon users' aggregation of NFTs. As is discussed further below, NFTs and/or fungible tokens may also be utilized by content creators to incentivize users to share data.

NFTs minted in accordance with several embodiments of the invention may incorporate a series of instances of digital content elements in order to represent the evolution of the digital content over time. Each one of these digital elements may have multiple numbered copies, just like a lithograph, and each such version may have a serial number associated with it, and/or digital signatures authenticating its validity. The digital signature may associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications may request authentication of the NFT directly based upon the public key of the content creator and/or indirectly based upon transaction records within the NFT blockchain. As discussed above, minted NFTs may be signed by content creators and administrators of the NFT blockchain. In addition, users may verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein may also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain may be in the form of distributed ledgers, while the blockchain may alternatively be centralized in a single entity.

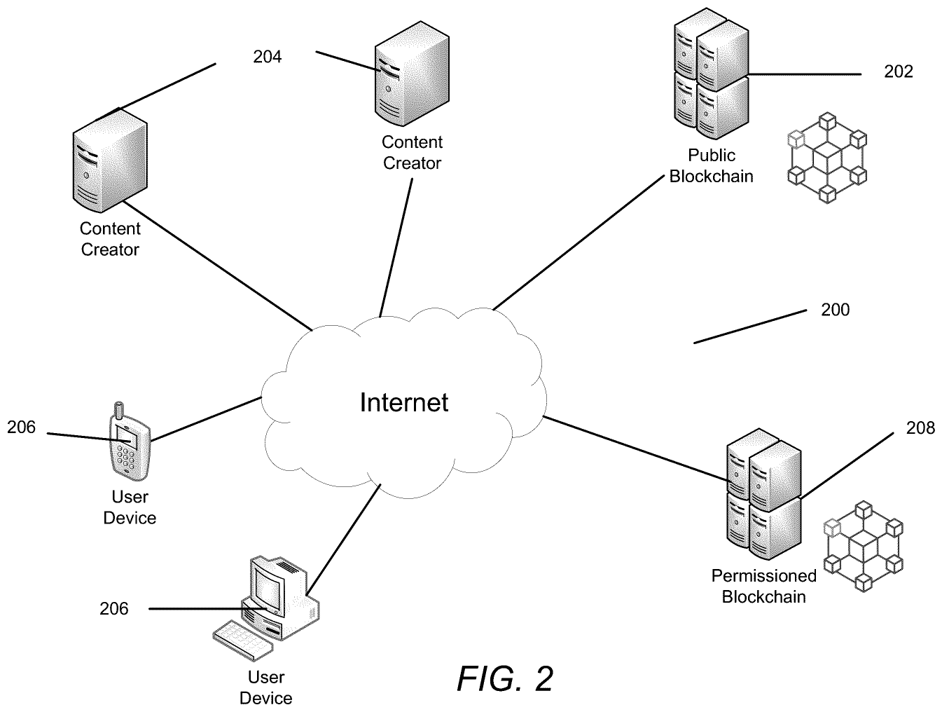

An example of network architecture that may be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 may support minting of standards based NFTs that may be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform may also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users may utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications may provide any of a variety of functionality that may be determined as appropriate to the requirements of a given application. In the illustrated embodiment, the user devices 206 are shown as mobile phones and personal computers. As may readily be appreciated user devices may be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data may be accessed by the media wallet application. In this way, users control access to entries in the permissioned blockchain 208 describing the user's NFT transaction. In several embodiments, users may authorize content creators 204 to access NFT transaction data recorded within the permissioned blockchain 208 using one of a number of appropriate mechanisms including (but not limited to) compound identities where the user is the owner of the data and the user may authorize other entities as guests that may also access the data. As may readily be appreciated, particular content creators' access to the data may be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they may make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users may utilize a media wallet application to modify permissions granted by way of the access control list. In many embodiments, the manner in which access permissions are defined enables different restrictions to be placed on particular pieces of information within a particular NFT transaction data record within the permissioned blockchain 208. As may readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists may enable users to grant permission to decrypt certain pieces of information or individual records within the permissioned blockchain. In several embodiments, the access to the data is determined by computer systems that implement permission-based data access services.

In many embodiments, the permissioned blockchain 208 may be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention may be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms may be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As may readily be appreciated, a variety of approaches may be taken to the writing of data to permissioned blockchains and the particular approach is largely determined by the requirements of particular applications. As such, computer systems in accordance with various embodiments of the invention may have the capacity to create verified NFT entries written to permissioned blockchains.

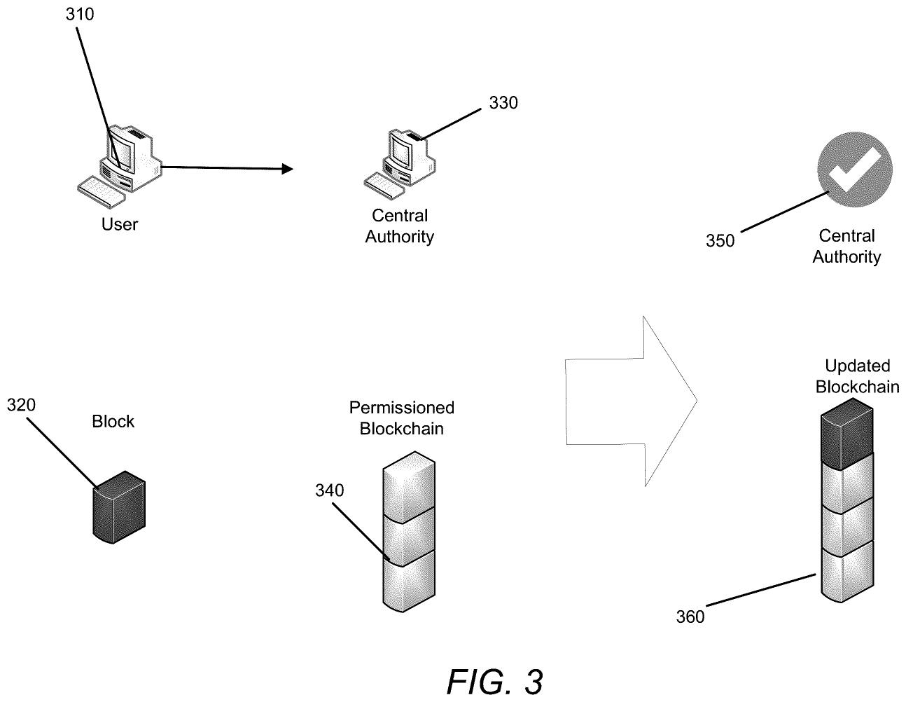

An implementation of permissioned (or private) blockchains in accordance with some embodiments of the invention is illustrated in FIG. 3. Permissioned blockchains 340 may typically function as closed computing systems in which each participant is well defined. In several embodiments, private blockchain networks may require invitations. In a number of embodiments, entries, or blocks 320, to private blockchains may be validated. In some embodiments, the validation may come from central authorities 330. Private blockchains may allow an organization or a consortium of organizations to efficiently exchange information and record transactions. Specifically, in a permissioned blockchain, a preapproved central authority 330 (which should be understood as potentially encompassing multiple distinct authorized authorities) may approve a change to the blockchain. In a number of embodiments, approval may come without the use of a consensus mechanism involving multiple authorities. As such, through a direct request from users 310 to the central authority 330, the determination of whether blocks 320 may be allowed access to the permissioned blockchain 340 may be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 may reflect the added block 320.

NFT platforms in accordance with many embodiments of the invention may also benefit from the anonymity and accessibility of a public blockchain. Therefore, NFT platforms in accordance with many embodiments of the invention may have the capacity to create verified NFT entries written to a permissioned blockchain.

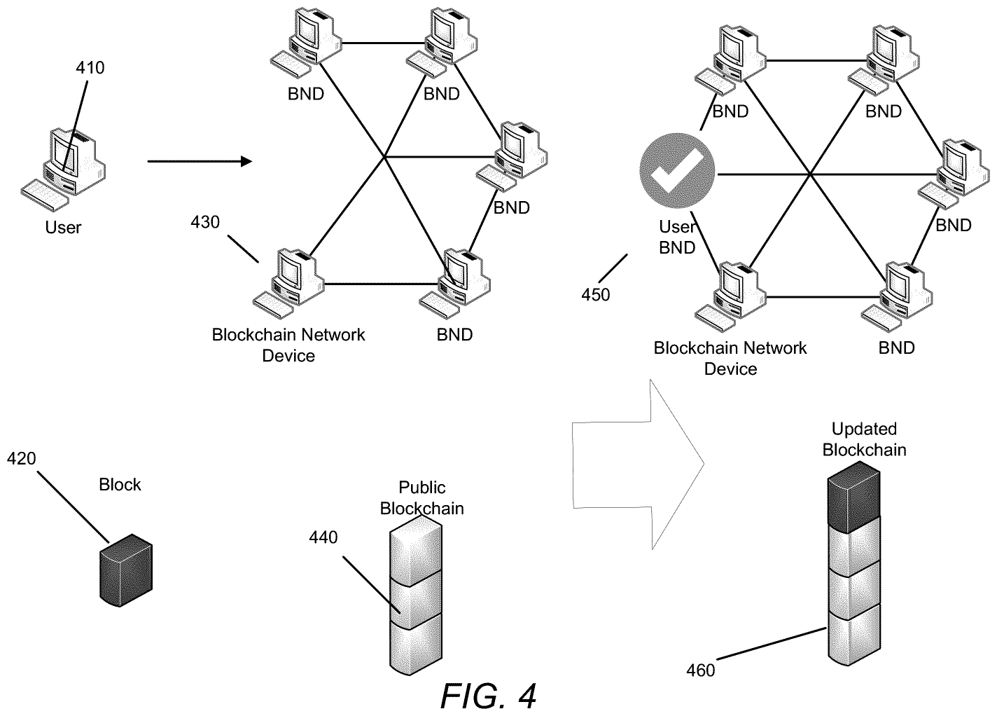

An implementation of a permissionless, decentralized, or public blockchain in accordance with an embodiments of the invention is illustrated in FIG. 4. In a permissionless blockchain, individual users 410 may directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even when anonymously made, making it immutable. In many decentralized blockchains, many blockchain network devices 430, in the decentralized system may have copies of the blockchain, allowing the ability to validate transactions. In many instances, the blockchain network device 430 may personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that may be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention may therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references may be stored by adding a ledger entry incorporating the reference enabling the entry to be timestamped. In doing so, the URL, which typically accounts for domain names, may be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

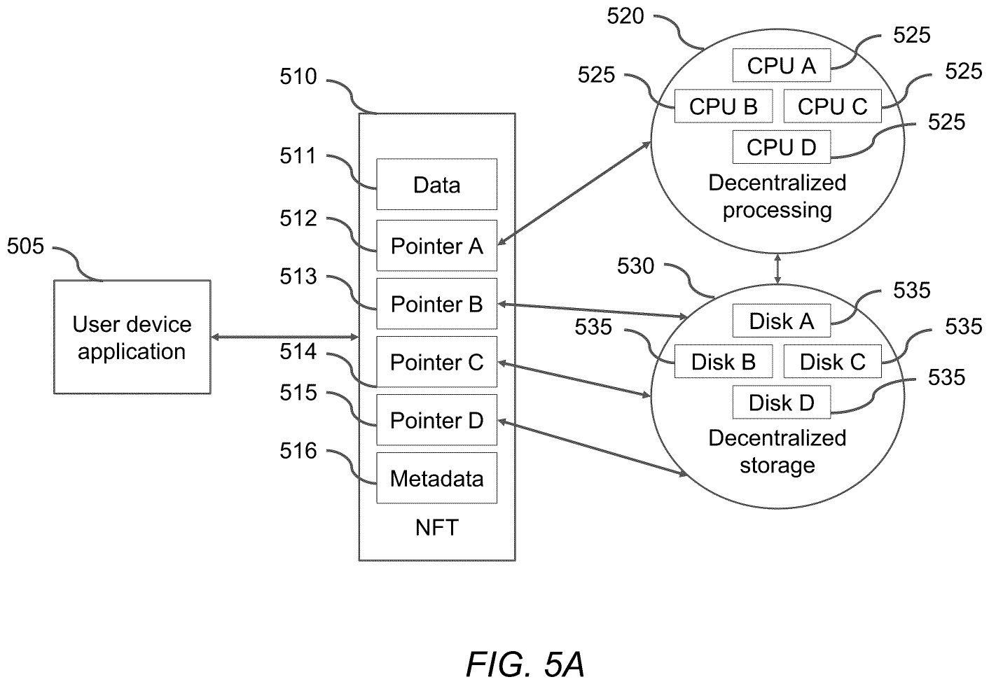

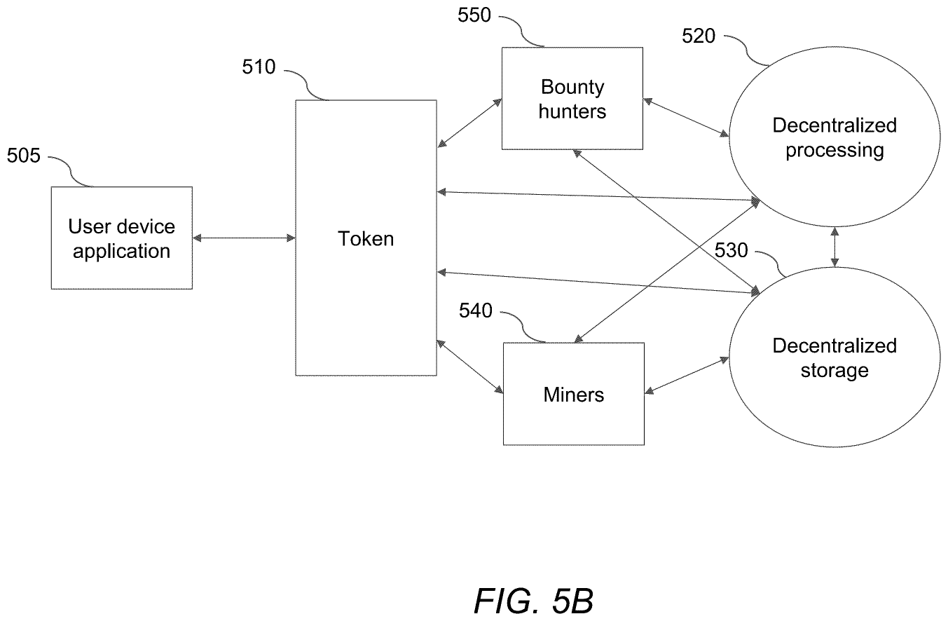

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 may direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiments of the invention. Bounty hunters 550 allow NFTs 510, which may point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 may have the capacity to perform all necessary minting processes or any process within the architecture that involves a consensus mechanism.

Bounty hunters 550 may also choose to verify each step of a computation, and when they find an error, submit evidence of this in return for some reward. This may have the effect of invalidating the incorrect ledger entry and, potentially based on policies, all subsequent ledger entries. Such evidence may be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. When the evidence in question has not been submitted before, this may automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein may also be implemented outside the context of an NFT platform network architecture unrelated to the storage of fungible tokens and/or NFTs. A variety of components, mechanisms, and blockchain configurations that may be utilized within NFT platforms are discussed further below. Moreover, any of the blockchain configurations described herein with reference to FIGS. 3-5B (including permissioned, permissionless, and/or hybrid mechanisms) may be utilized within any of the networks implemented within the NFT platforms described above.

### NFT Platform Consensus Mechanisms

NFT platforms in accordance with many embodiments of the invention may depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor may be memory rather than processing power. Specifically, Proof of Space mechanisms may perform this through network optimization challenges. In several embodiments, the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

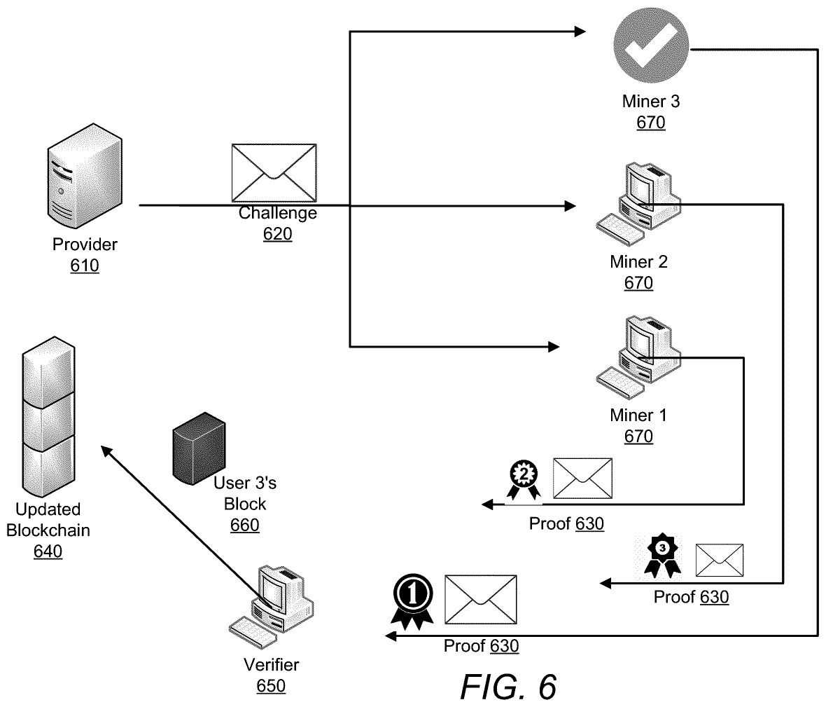

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network may verify the proof, something which typically requires much less processing power, to determine the first device that would have the right to add the winning block 650 to the blockchain 630. As such, under a Proof of Work consensus mechanism, each miner involved may have a success probability proportional to the computational effort expended.

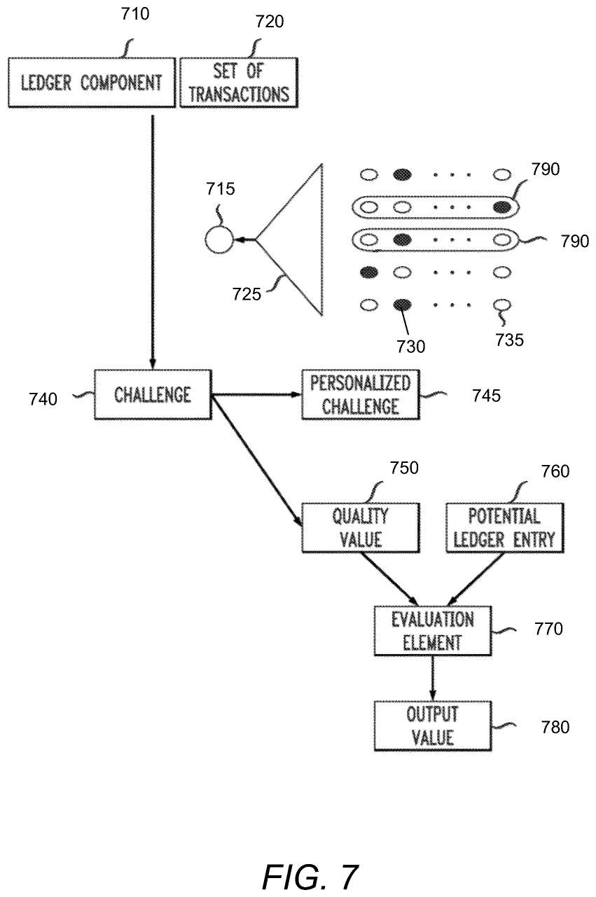

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments, the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and may be used to compute values at a setup time. This may be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 may be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 may indicate a selection of nodes 730, denoted in FIG. 7 by filled-in circles. In the FIG. 7 example specifically, the personalized challenge corresponds to one node per row. The collection of nodes selected as a result of computing the personalized challenge 745 may correspond to a valid potential ledger entry 760. However, here a quality value 750 (also referred to herein as a qualifying function value) may also be computed from the challenge 740, or from other public information that is preferably not under the control of any one miner.

A miner may perform matching evaluations 770 to determine whether the set of selected nodes 730 matches the quality value 750. This process may take into consideration what the memory constraints of the miner are, causing the evaluation 770 to succeed with a greater frequency for larger memory configurations than for smaller memory configurations. This may simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 may also correspond to public keys. The miner may submit valid ledger entries, corresponding to a challenge-response pair including one of these nodes. In that case, public key values may become associated with the obtained NFT. As such, miners may use a corresponding secret/private key to sign transaction requests, such as purchases. Additionally, any type of digital signature may be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems may also be implemented in accordance with many embodiments of the invention. In many embodiments, hybrid methods may be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures may be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments may utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

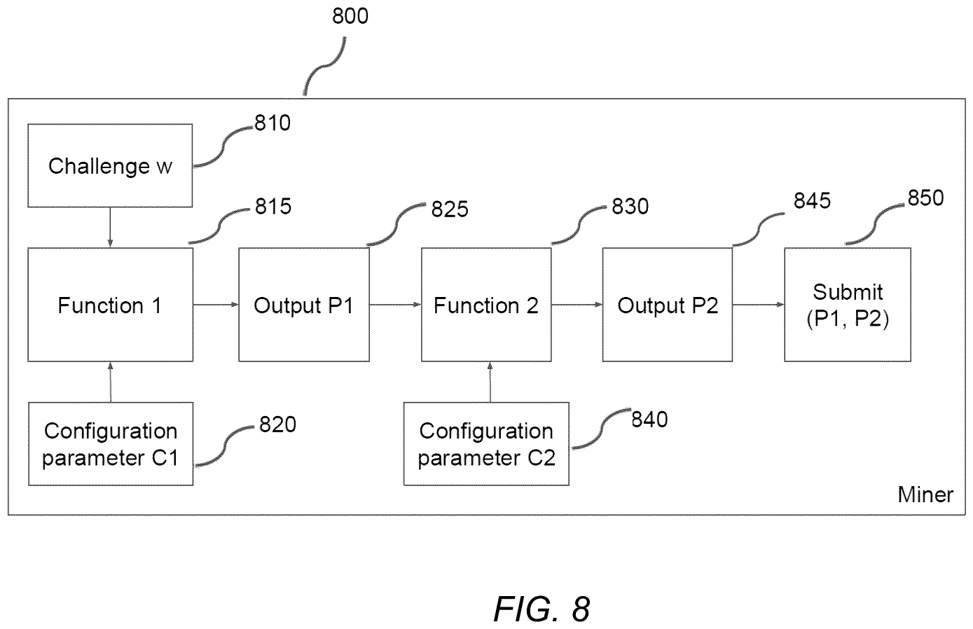

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof may be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention may constrain the search space for the mining effort. This may be done using a configuration parameter that controls the range of random or pseudo-random numbers that may be used in a proof. Upon challenge w 810 being issued to one or more miners 800, it may be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 may then submit the combination of proofs (P1, P2) 850 to a verifier, in order to validate a ledger associated with challenge w 810. In some embodiments, miner 800 may also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone(™) or Intel SGX(™) may provide assurances exist of integrity by virtue of incorporating private/isolated processing environments.

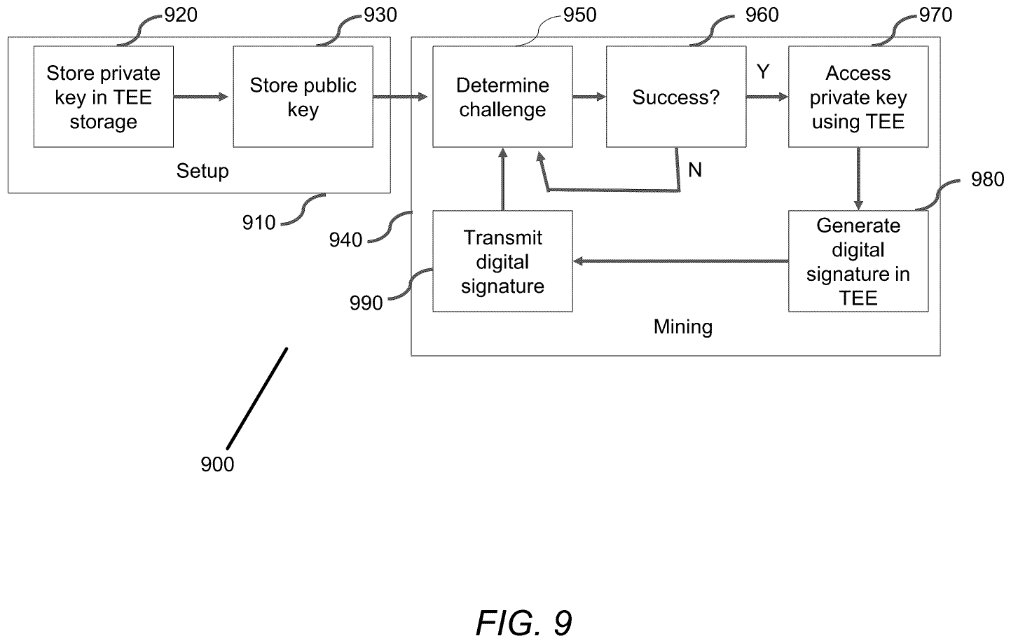

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it may be shielded from applications running outside the TEE. Additionally, processes may store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate may be stored with the public key.

In many embodiments of the invention, mining-directed steps may also be influenced by the TEE. In the illustrated embodiment, the process 900 may determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments, the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 may return to determine (950) a new challenge. In this context, process 900 may determine (950) a new challenge after the ledger contents have been updated and/or a time-based observation is performed. In several embodiments, the determination of a new challenge may come from any of a number of approaches appropriate to the requirements of specific applications, including, but not limited to, the observation of as a second elapsing since the last challenge. When the challenge corresponds to a success 960, then the processing may continue on to access (970) the private key using the TEE.

When the private key is accessed, process may generate (980) a digital signature using the TEE. The digital signature may be on a message that includes the challenge and/or which otherwise references the ledger entry being closed. Process 900 may also transmit (980) the digital signature to other participants implementing the consensus mechanism. In cases where multiple digital signatures are received and found to be valid, a tie-breaking mechanism may be used to evaluate the consensus. For example, one possible tie-breaking mechanism may be to select the winner as the party with the digital signature that represents the smallest numerical value when interpreted as a number. In several embodiments, the tie-breaking mechanism may be selected from any of a number of alternate tie-breaking mechanisms appropriate to the requirements of specific applications.

While specific consensus processes are described above, any of a variety of processes may be utilized as appropriate to the requirements of specific applications. In certain embodiments, steps may be executed and/or performed in any order or sequence not limited to the order and sequence shown and described. In a number of embodiments, some of the above steps may be executed or performed substantially simultaneously where appropriate and/or in parallel to reduce latency and processing times. In some embodiments, one or more of the above steps may be omitted.

Applications and methods in accordance with various embodiments of the invention are not limited to use within NFT platforms. Accordingly, it should be appreciated that consensus mechanisms described herein may also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) may be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that may be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As may readily be appreciated each of these computer systems may be implemented using one or more of any of a variety of classes of computing devices including (but not limited to) mobile phone handsets, tablet computers, laptop computers, personal computers, gaming consoles, televisions, set top boxes and/or other classes of computing device.

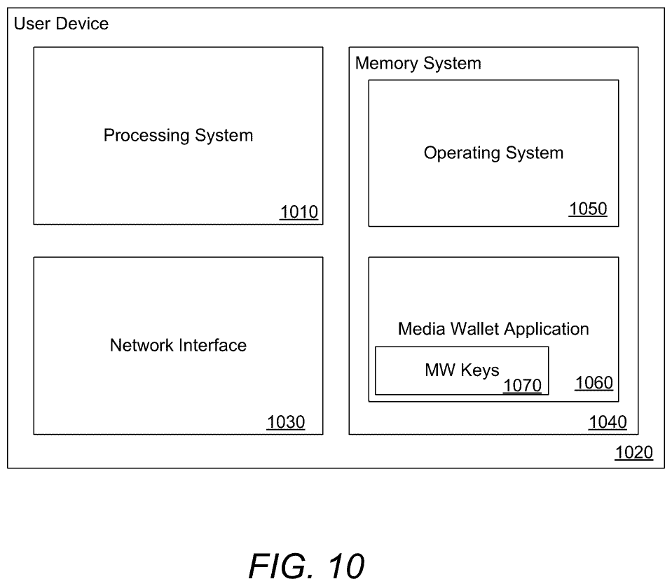

A user device capable of communicating with an NFT platform in accordance with an embodiments of the invention is illustrated in FIG. 10. The memory system 1040 of particular user devices may include an operating system 1050 and media wallet applications 1060. Media wallet applications may include sets of media wallet (MW) keys 1070 that may include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention. In accordance with many embodiments, user devices may include at least one processor, which may be configured to process input data according to instructions stored in memory. The memory may be a tangible, non-transitory, computer-readable medium configured to store instructions that are executable by the processor. For example, the memory may be data storage that can be loaded with software code that is executable by the processor to achieve certain functions.

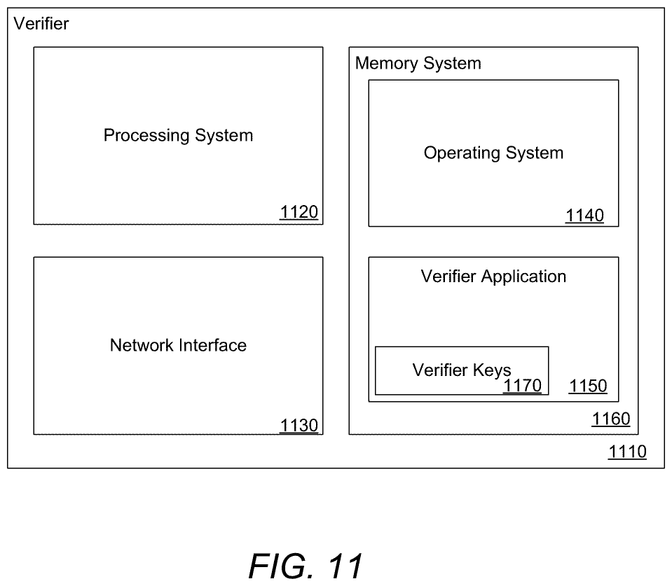

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries may be verified, the verifier application 1150 may transmit blocks to the corresponding blockchains. The verifier application 1150 may also implement some or all of the various functions described above with reference to verifiers as appropriate to the requirements of a given application in accordance with various embodiments of the invention.

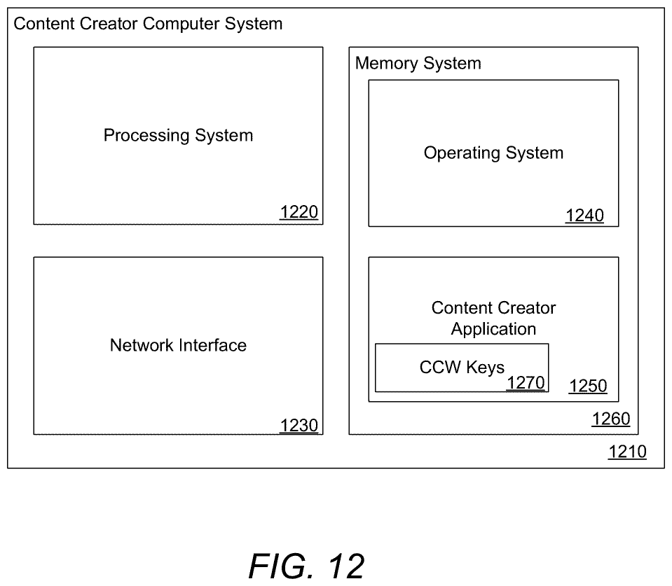

A content creator system 1210 capable of disseminating content in an NFT platform in accordance with an embodiments of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application may include sets of content creator wallet (CCW) keys 1270 that may include a public key/private key pairs. Content creator applications may use these keys to sign NFTs minted by the content creator application. The content creator application may also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions may be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party may indicate their relationship with the wallet; whether they may read summary data associated with the content; whether they have access to peruse the content; whether they may place bids to purchase the content; whether they may borrow the content, and/or whether they are biometrically authenticated.

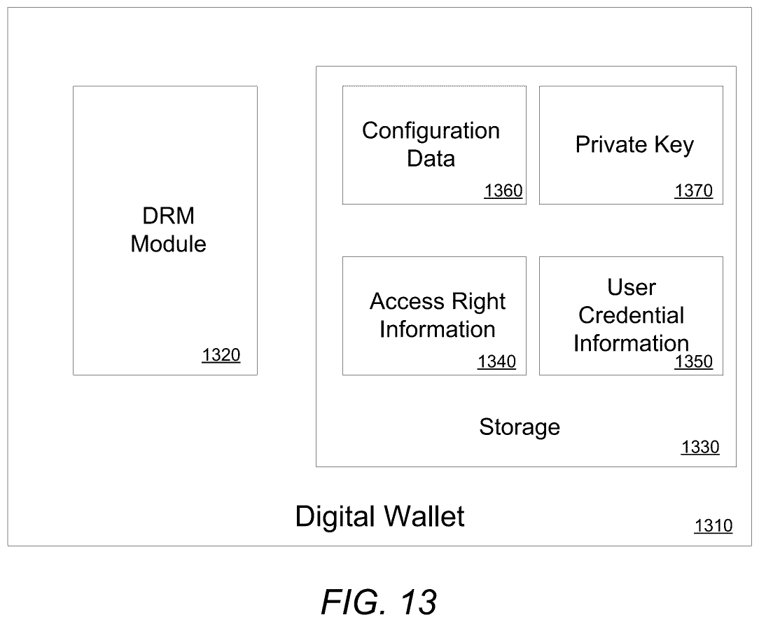

An example of a media wallet 1310 capable of storing rich media NFTs in accordance with an embodiments of the invention is illustrated in FIG. 13A. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally or alternatively, said systems may require one or more keys (typically a certificate containing a public key/private key pair) that may be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

Systems and methods in accordance with some embodiments may enable interaction between media wallets and various immersive experiences. For example, systems may be implemented by certain users and/or NFT collectors who visit theme parks and/or experience museums including but not limited to Disney(™) Theme Park, and/or Meow Wolf(™) experiences. The rides and/or immersive experiences may install systems to communicate with the users and/or audience wallets to personalize the UI of the immersive experience (e.g., in response to the users' acceptance, request, and/or approval). In such cases, as the users go through the experience, it may be personalized based on the experience's access to the media wallets and associated indicators, including but not limited to user gaze and attention. Potential applications of systems to immersive experiences are elaborated on below.

An additional example of a media wallets configured in accordance with multiple embodiments of the invention is illustrated in FIG. 13B. Such media wallets 1300 configurations may (in addition or alternative to the features disclosed in FIG. 13A) include but are not limited to a storage component 1330 and one or more algorithms for extracting features from stored files. The storage component 1330 may be used to store music files 1390 owned and/or licensed by users. Immersive environments (e.g., an immersive experience that has musical and/or visual elements) may connect with the media wallet(s) 1300 granting access to the stored files including but not limited to the music files 1390. This connection may be enabled using protocols authenticating and granting permission to connect (e.g., wireless protocols including but not limited to Wi-Fi and/or Bluetooth).

Media wallets 1300 configured in accordance with some embodiments may take music files 1390 and run signal processing on them using various algorithms. For example, the media wallets may utilize time domain 1385 and/or frequency domain algorithms 1380 for feature extraction. These (extracted) features may be combined to create representational sets of music notation 1395. The music notation 1395 may contain onset (time) and/or pitch data kept in the storage component 1330. In accordance with several embodiments of the invention, the music notation 1395 may be stored as Open Sound Control and/or MIDI messages inside the media wallets 1300 (e.g., until used to interact with the immersive installation).

Systems in accordance with several embodiments may utilize installations of digital and/or mechatronic musical instruments which may gain access to the digital wallets and evaluate the music files in the wallets. The installations may personalize and mimic the musical material in the wallets using various digital signal processing techniques to determine features including but not limited to onsets, instruments, and form (e.g., using modern AI music techniques). The systems may go through digital wallets, perform music extraction techniques on some or all of the music files to extract information (such as rhythm onsets and pitch) from the original audio files, and/or convert that transcribed data into elements that may interact with installations (e.g., MIDI and/or Open Sound Control-based). In accordance with some embodiments, installations may be triggered by music data and/or time-based onset triggers.

In accordance with multiple embodiments of the invention, the availability of the option to render content on external display entities, including but not limited to screens and/or loudspeakers, may be conveyed to user devices including but not limited to phones and/or wearable devices. Conveyance may include but is not limited to the use of push notifications to the devices and/or by the devices periodically identifying options for rendering and conveying content to users. Users may indicate to render content on a selected display entity for one particular use, e.g., to render a particular content element. Users may, additionally or alternatively, indicate never to show a given external display entity as an option, and/or to always indicate it as a favored option. Users may select an external display entity from a list of pre-approved entities, where such pre-approval may be provided by the users and/or agents including but not limited to an ombudsman, an employer, a guardian, etc. The users may, additionally or alternatively, select to render items on any external display entity in the list of available external display entities. This may already have been curated to remove options that are considered undesirable and/or risky using risk assessment entities that may be part of the wallets, and/or which may be external entities that provide feedback on external displays. The assessment may be based on rules and policies associated with the users and/or their wallets, and/or by security rules obtained from external sources. Additionally or alternatively, assessments may be based on the certificates associated with the available external display entities that are detected.

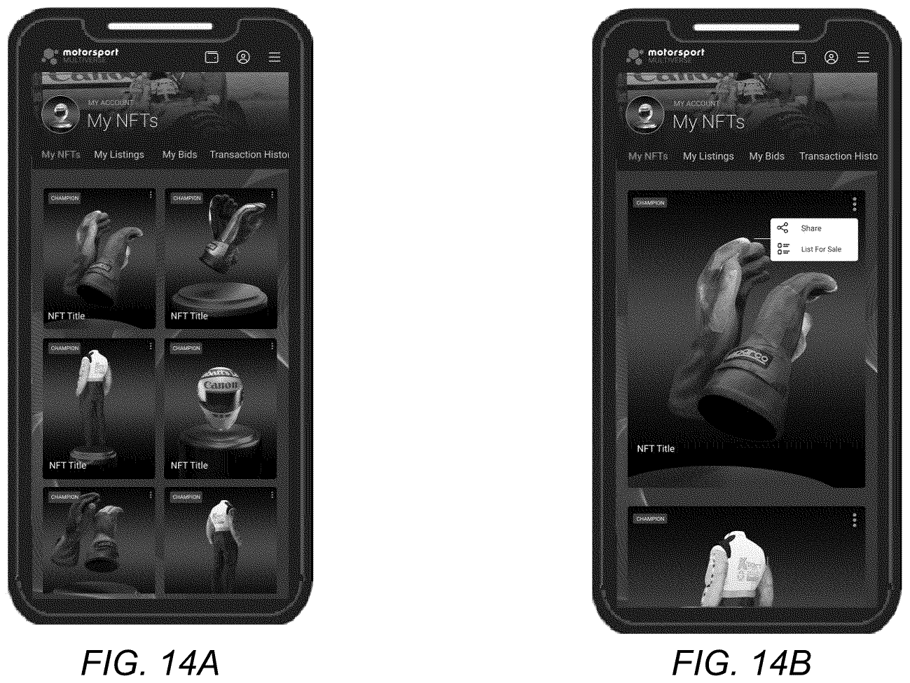

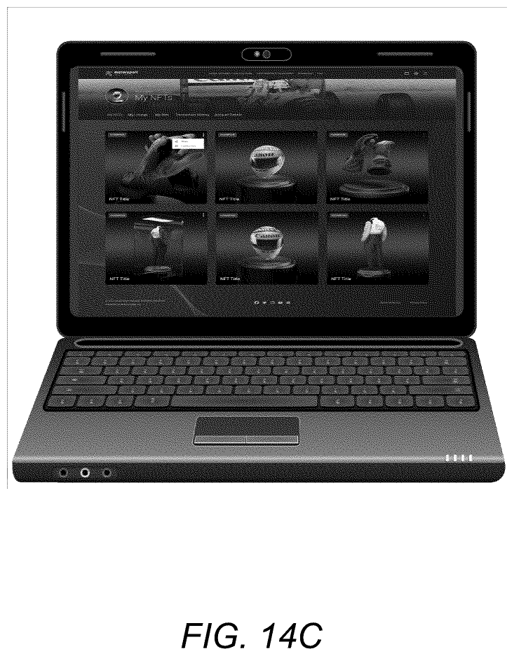

Operation of additional media wallet applications implemented in accordance with some embodiments of the invention is conceptually illustrated by way of the user interfaces shown in FIGS. 14A-14C. In many embodiments, media wallet applications may refer to applications that are installed upon user devices such as (but not limited to) mobile phones and tablet computers running the iOS, Android and/or similar operating systems. Launching media wallet applications may provide a number of user interface contexts. In many embodiments, transitions between these user interface contexts may be initiated in response to gestures including (but not limited to) swipe gestures received via a touch user interface. As may readily be appreciated, the specific manner in which user interfaces operate through media wallet applications is largely dependent upon the user input capabilities of the underlying user device. In several embodiments, a first user interface context is a dashboard (see, FIGS. 14A, 14C) that may include a gallery view of NFTs owned by the user. In several embodiments, the NFT listings may be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT may be main-staged in said display with its status and relevant information shown. Users may swipe through each collectible and interacting with the user interface may launch a collectible user interface enabling greater interaction with a particular collectible in a manner that may be determined based upon the smart contract underlying the NFT.

A participant of an NFT platform may use a digital wallet to classify wallet content, including NFTs, fungible tokens, content that is not expressed as tokens such as content that has not yet been minted but for which the wallet may initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that may be seen by anybody, the second partition corresponds to content that may be seen by members of a first group, and/or the third partition corresponds to content that may be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility may correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items may be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked when additional content that are also in-game capabilities should be automatically placed in the same partition as they are acquired and associated with the wallet. When “yes” is selected, then this placement may be automated in the future. When “yes, but confirm for each NFT” is selected, then users may be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view may correspond to the classifications described above, which indicates the actions and interactions others may perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users may search the contents of their wallet by using search terms that result in potential matches.

Alternatively, the collection of content may be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein may also be implemented outside the context of an NFT platform network architecture unrelated to the storage of fungible tokens and/or NFTs. Moreover, any of the computer systems described herein with reference to FIGS. 10-14C may be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” may be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

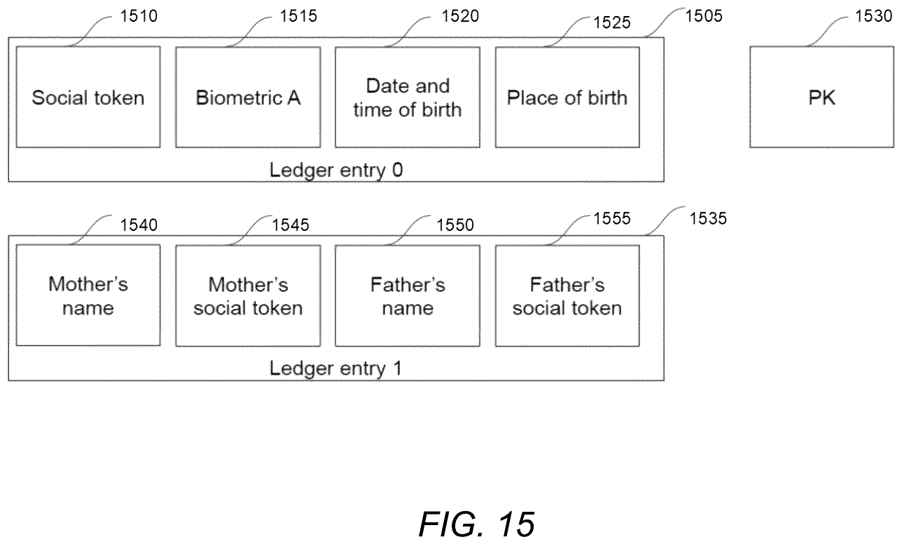

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race, gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds when abuse may be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements may be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one may be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 when a horse does not win. Payment may occur under the condition that the first promise NFT is matched with a second promise NFT that causes a transfer of funds to a public key specified with the first promise NFT when horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input may take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that when the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. When the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties may enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to Wi-Fi networks. When computers are replaced with newer models, users may want to maintain all old relationships, for the new computer. For example, users may want to retain Wi-Fi hotspots. For this to be facilitated, a new computer may be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs may be used to selectively transfer rights associated with one NFT to one or more NFTs, where such NFTs may correspond to users, devices, and/or other entities, when such assignments of rights are applicable. Inheritance NFTs may also be used to transfer property. One way to implement the transfer of property may be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, when the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers may generate parts of the content, allowing for large-scale content collaboration.

Features of other NFTs may be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements may also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers may identify how to make their content more desirable to intended target groups.

The generation of evaluations may be supported by methods including, but not limited to machine learning (ML) methods, artificial intelligence (AI) methods, and/or statistical methods. Anomaly detection methods developed to identify fraud may be repurposed to identify outliers. This may be done to flag abuse risks or to improve the evaluation effort.

Multiple competing evaluation units may make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

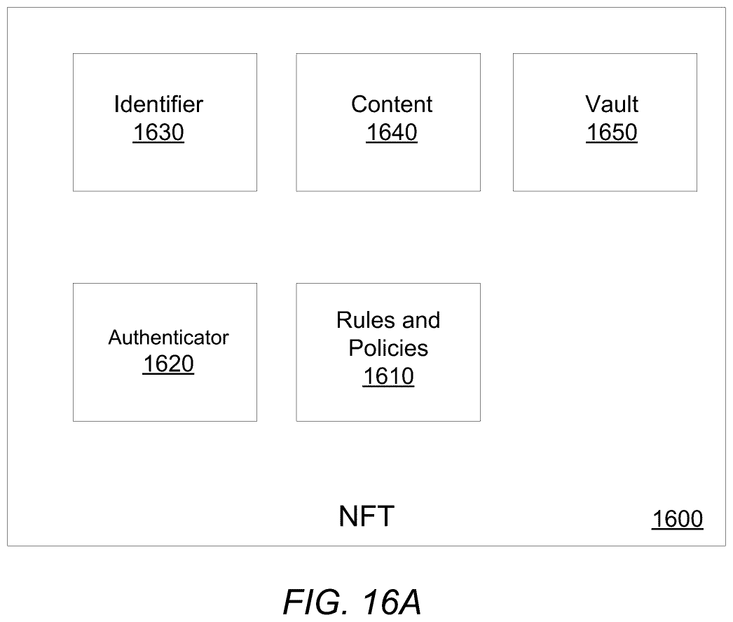

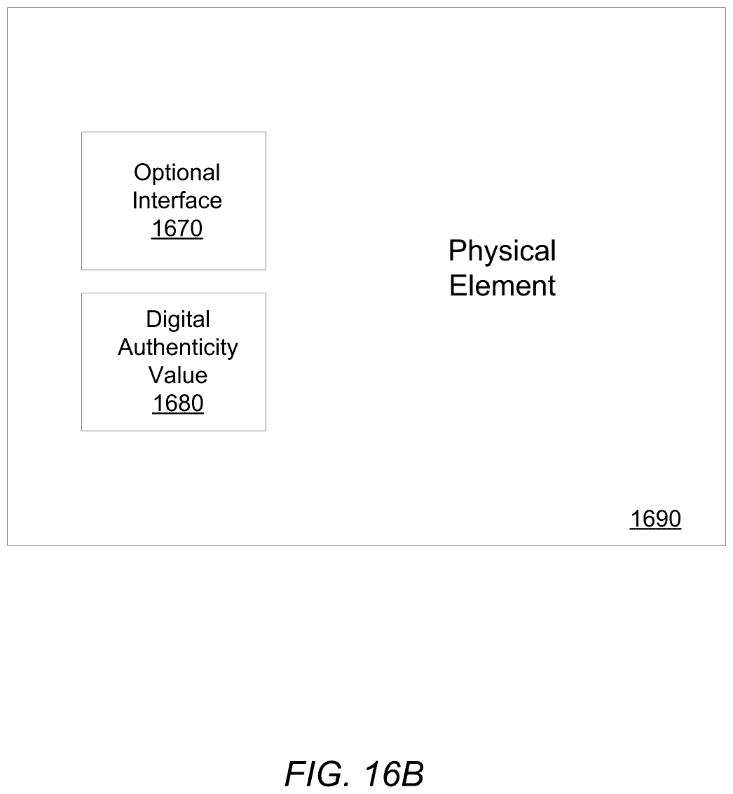

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 may incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content may correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership may be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, may be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments, the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 may be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, when a DAV 1680 is used to express authenticity of two or more physical items, the authenticity database may detect and block a new entry during the registration of the second of the two physical items. For example, when a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item may be associated with a control that prevents forgeries to be registered as legitimate, and therefore, makes them not valid. In the context of a content creator receiving a physical element from an owner, the content creator may deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

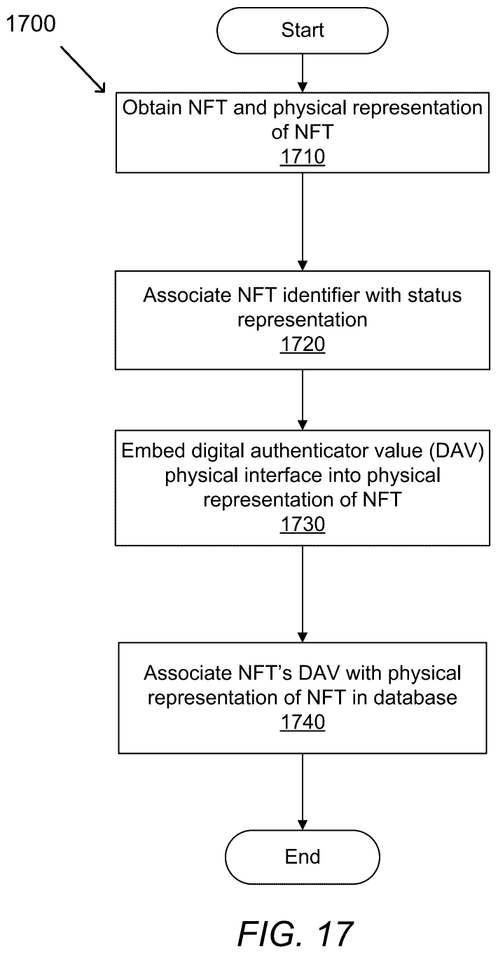

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 may associate (1740) the NFT's DAV with the physical representation of the NFT in a database. In some embodiments, the association may be performed through making note of the transaction and clarifying that it encapsulates both the mouse painting and the mouse NFT.

While specific association processes are described above, any of a variety of processes may be utilized as appropriate to the requirements of specific applications. In certain embodiments, steps may be executed and/or performed in any order or sequence not limited to the order and sequence shown and described. In some embodiments, some of the above steps may be executed or performed substantially simultaneously where appropriate and/or in parallel to reduce latency and processing times. In some embodiments, one or more of the above steps may be omitted.

While specific processes are described above with reference to FIGS. 15-17, NFTs may be implemented in any of a number of different ways to enable as appropriate to the requirements of specific applications in accordance with various embodiments of the invention. Additionally, the specific manner in which NFTs may be utilized within NFT platforms in accordance with various embodiments of the invention is largely dependent upon the requirements of a given application.

### Monitored Wallet Transactions

### A. Transaction Trustees

Systems and methods in accordance with various embodiments of the invention may implement one or more trustee entities (“trustees”) to facilitate transaction security by verifying any proposed transactions. Systems may use trustees as safeguards to protect blockchain wallets, NFT marketplaces, and various token-storage entities from abuse methods including but not limited to malware, rogue contracts, social engineering, and device theft. In doing so, systems may be used to address security problems directed to entities including but not limited to custodial and non-custodial (digital) wallets, while offering a high degree of flexibility for (protected) end users. In practice, trustees may include but are not limited to automated agents and/or user interfaces operated by individuals. These individuals may correspond to people/organizations with determined permissions including but not limited to spouses, relatives, friends, agents of financial institutions, agents of wealth management companies, agents of security companies, etc.

In some embodiments, trustees may protect transaction security in the form of collectives, groups, and/or sets of trustees. In some embodiments, when sets of trustees are utilized, they may have differing obligations and/or permissions. Some trustees may be used to determine whether potential transactions are (un)safe (e.g., does not correspond to deceptive and/or abusive situations). Some trustees may be used to determine whether prices associated with the proposed transactions are reasonable. Some trustees may be used to determine whether the proposed transactions are desirable for the initially proposing users (e.g., morally acceptable; good use of time and/or funds; suitable for use with already accessible tools, tokens, services and applications).

Transactions and/or transaction requests configured in accordance with several embodiments of the invention may incorporate various components. Transactions may include, but are not limited to one or more recipients, and in some embodiments, the recipient(s) may be specified through recipient identifiers. Recipient identifiers may include but are not limited to public keys and/or blockchain addresses derived from public keys. In numerous embodiments, the transactions may, additionally or alternatively, include valuations of the transaction(s). Valuations may include but are not limited to amounts of cryptocurrencies and/or tokens, identifiers for NFTs, etc. In multiple embodiments, transactions may not include valuations. For example, for a transaction transferring ownership of a smart contract to the recipient, and/or a transaction adding the recipient to a banlist or allowlist, a valuation of the transaction may not be required, as no quantifiable value is transferred by the transaction in such cases.

The transactions/requests may, additionally or alternatively, include authentication values. Potential authentication values, incorporated into transactions and/or transaction requests configured in accordance with various embodiments of the invention, may include but are not limited to digital signature(s) using private keys of the requesting parties (such as the wallet(s) and/or user (devices) associated with the wallet(s)); message authentication codes (MACs) (e.g., using keys shared between the wallets and the third party approvers, and/or using hash-based message authentication codes (MACs)); one-time codes (for example, values from hash chains); passwords; personal identification numbers; values representing verifications of users (and/or user identities) to third parties, generated by and/or on behalf of the wallets of the users; pre-images to hash digests (e.g., that were previously presented as part of a challenge/response process), etc.

Sets of trustees implemented in accordance with certain embodiments may be modified over time (e.g., with trustee permissions having pre-set durations). Potential modifications may allow for trustees to be added, trustees to be removed, and/or permissions (including but not limited to the authority, scope, and/or acceptable actions) for individual trustees to be changed. Additions, removals, and changes in permissions may occur automatically and/or manually. In the former case, modifications may be based on information including but not limited to prior behavior, (degree of) involvement in prior transactions, external reviews, and/or assessments (e.g., based on transactions conducted for other parties).

Systems in accordance with miscellaneous embodiments of the invention may transmit requests to perform transactions through means including but not limited to email, SMS, (e.g., digital) wallets, and/or webpages. Systems may include user interfaces to allow users to initiate transactions. In accordance with some embodiments, initiation of transactions may be enabled in response to actions including but not limited to reading advertisements, viewing services, viewing (e.g., non-fungible) tokens, viewing content described on webpages, clicking on a link and/or button, responding to an email, downloading applications, and/or running applications.

In accordance with certain embodiments of the invention, user interfaces may allow users to communicate their intent to perform transactions. For example, users may be able to request to perform transactions by scanning QR codes using smartphones and having their smartphones make the requests to external resources indicated by the QR codes. User interfaces may, additionally or alternatively, allow users to select items (for example specified types and quantities of crypto funds and/or non-fungible tokens (NFT)) using browsers. Additionally or alternatively, user interfaces may allow users to respond to offers presented to them, including but not limited to via the ways described above. For example, users may be able to indicate the intent to perform certain transactions using wallets. Such wallets may be implemented using software (e.g., a traditional app), hardware (i.e., a hardware wallet), and/or hardware-protected software entities (including but not limited to apps that are—at least in part—protected by trusted computing platforms, such as TrustZone).

When user devices and/or accounts are successfully attacked, then an attacker may initiate a request, posing as the associated user, and may attempt to transfer resources (e.g., funds and/or NFTs) to an address and/or account associated with the attacker. In some cases, transactions may be initiated through actions not immediately linked to the transaction, including but not limited to, purchasing an item, viewing one or more media files and/or streams, playing a game and achieving a goal, reaching a location within the game, participating in the game for a predetermined time period, and/or undertaking actions in the real world, for example, entering a building, visiting a location and/or sequence of locations, waiting in a given location for a specified period of time, traveling above a certain speed and/or reaching a specified altitude.

To protect users in cases like the above, when requests may be initiated from user devices and/or user accounts, systems configured in accordance with some embodiments of the invention may send data indicating the request to associated trustees. Upon receipt, trustees may verify that the requests are well-formed (e.g., properly authenticated). Additionally or alternatively, requests may include one or more policies that are evaluated by the trustees during verification.

Example policies may be implemented for purposes including but not limited to classifying requests based on corresponding amounts and/or values, determining whether intended recipient(s) are trustworthy/accurate (e.g., via assessing trust scores and/or reputation scores), assessing whether users have previously performed transfers to the indicated recipient(s), determining whether the user(s) involved (and/or any system users) have filed complaints related to the indicated recipient(s), evaluating whether there are other pending and/or recent requests for transfers from accounts associated with the involved user(s) (and/or what their cumulative value is), and assessing whether the request is determined to be anomalous. In accordance with various embodiments of the invention, these determinations may be made manually (e.g., by trustees) and/or automatically (e.g., via artificial intelligence/AI).

In accordance with several embodiments of the invention, policies may be implemented in various ways. For example, policies may be selected by the users (via user functionality configured in accordance with multiple embodiments) during setup phases. Additionally or alternatively, policies may be determined by the trustees through means including but not limited to observing transaction requests (e.g., transaction requests from the underlying users) and building (e.g., machine learning) models to classify later requests.

For systems operating in accordance with many embodiments, executing the one or more policies may be used to generate one or more classifications. Classifications may be associated with one or more actions, where example actions include but are not limited to automatically allowing the transaction, allowing the transaction after a verification has been performed (and succeeded), and/or allowing the transaction after one or more conditions are satisfied. In relation to the latter, example conditions may relate (but are not limited) to the type of transaction, whether the transaction has a (e.g., predetermined) maximum associated value, whether the transaction has a degree of risk below a threshold value, etc. Example verifications may include but are not limited to automated second-factor authentications (2FA) (e.g., Google Authenticator(™)); automated phone calls to registered numbers; biometric verifications (e.g., of the voice of the person picking up the automated phone call); and/or direct manual calls to verify users' intentions, preferences and/or identity (e.g., determining whether a user knows his or her passphrase, password and/or PIN; determining whether the user's voice matches a voice biometric of the user).

In some cases, classifications may be configured to automatically (dis)allow requests. For example, in cases where the value of the transaction is below a threshold value (e.g., $1.00 USD), systems in accordance with some embodiments may automatically allow them (i.e., due to the potential damage from fraud being especially low). Additionally or alternatively, systems may require verifications and/or determinations that certain conditions hold before allowing requests. In some cases, requests may be denied in circumstances like being associated with disallowed transaction types, the value exceeding specific thresholds, and/or risk indicators exceeding specific thresholds. Risk scores calculated in accordance with multiple embodiments may be implemented on scales; for example, degrees of risk may be measured on a scale of 0 to 100, where 0 means a transaction request is trustworthy and/or from a known source, 100 means the underlying transaction request is confirmed to be malicious, and/or 75 corresponds to a very high probability of abusive behavior being associated with the request. Additionally or alternatively, requests may be denied when performed verifications fail, and/or when substantially similar transactions have been previously/recently denied already. When multiple requests are pending at the same time, trustees implemented in accordance with a number of embodiments may combine verifications (i.e., make one verification decision dependent on another) and/or may determine each one independently. In some instances, when two or more transactions are selected for verification, then combined verifications may be performed and/or multiple independent verifications may be performed.

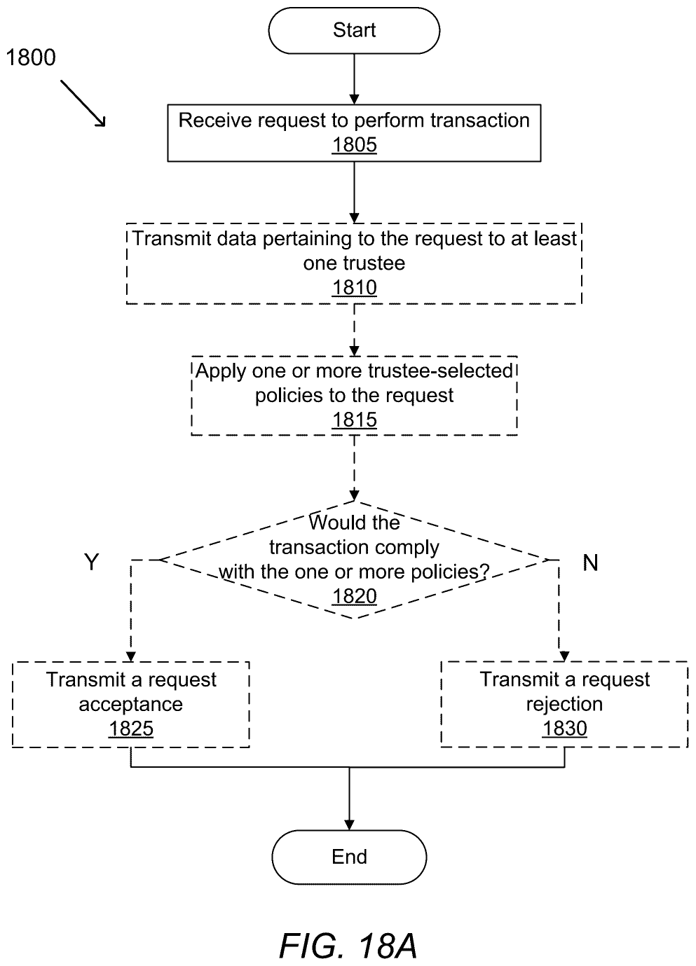

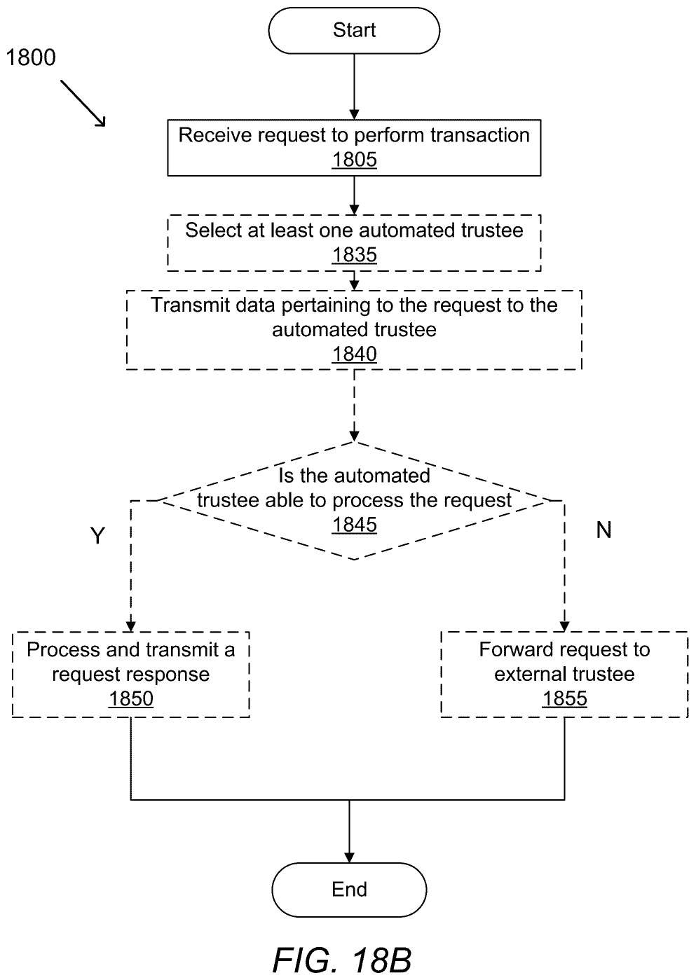

A process for verifying transactions through trustees implemented in accordance with several embodiments of the invention is illustrated in FIG. 18A. Process 1800 may be performed by entities including but not limited to blockchain wallets, digital wallets, and/or user devices. Process 1800 receives (1805) a request to perform a transaction from a user. In accordance with certain embodiments, transactions may be initiated by interacting with web3 websites. In such cases, the web3 websites may, on receiving data (related to the request) from the blockchain wallet, construct a proposed transaction including the data received and/or transmit the proposed transaction to the blockchain wallet(s). In accordance with some embodiments, process 1800 may provide users with functionality to facilitate the requests.

Process 1800 may transmit (1810) data pertaining to the request to (at least one) trustee. The data may include, but is not limited to one or more of: the transactions themselves, valuations of the transactions, time limits for the transactions, (identifiers of) recipients of assets to be transferred by the transactions, authentication values of the users initiating the transactions, transaction nonces, metadata files (that may include further information pertaining to the transaction), and request headers. In accordance with certain embodiments of the invention, process 1800 may, on receiving the request(s), present the users with interface components to transmit the request to the (at least one) trustee. In some embodiments, the interface component may include a list of approved trustees to select to seek approval from.

Process 1800 may apply (1815) one or more trustee-selected policies to the request. In accordance with some embodiments of the invention, policies may be applied on the trustee's end. Additionally or alternatively, policies may be selected by trustees, then applied on the user end. In some cases, process 1800 may receive preliminary assessments of compliance with the policies. Policies may include security aspects that the transaction must meet, for example, but not limited to: recipients (and/or initiators) specified in the transactions not being on associated banlists, recipients specified in the transactions being on associated allowlists, values corresponding to the transaction being below certain thresholds, aggregated values (of transactions over predetermined periods of time, possibly including the value of the present transaction(s)) being below certain thresholds, the requests coming from known internet protocol addresses, the requests being transmitted within certain time periods (for example at or around certain times of day).

Process 1800 may determine (1820) whether the transaction (and/or request) complies with the one or more policies. When the determination is that the transaction (and/or request) does not comply with the one or more policies, process 1800 transmits (1830) a request rejection. When the determination is that the transaction (and/or request) does comply with the one or more policies, process 1800 transmits (1825) a request acceptance. In numerous embodiments, the request acceptances and/or request rejections may be transmitted from the trustees to (e.g., the blockchain wallets of) the users.

In accordance with various embodiments of the invention, trustees may be (e.g., automated) agents that execute in secure environments, including but not limited to blockchain wallets and/or cloud-hosted environments. The trustees may be implemented using one or more machine learning models, AI, expert systems (e.g., including rules and policies), etc. This may be used to enable great portions of requests to be automatically addressed and responded to, with relatively small portions forwarded to external trustees for resolution.

External trustees may include one or more automated processing steps and allow for (optional) classifications by human operators (e.g., using interfaces that allow user input). In some instances, the selection of what cases to present to the human operators may depend on factors including but not limited to the assessed severity of the problem(s) (that can't be addressed in an automated manner), the likelihood that they will reoccur (i.e., for another user and/or the same user), and other indications generated by the initial (e.g., automated) agents. As human-generated classification is received, the classifications may be used to create rules, policies, and/or training materials for AI and/or ML models. Additionally or alternatively, updates to such policies and guidelines may be propagated to end-point agents to enable automated processing of related threats in the future. The human-generated input may thereby be used both to address the pending case and to train systems, operating in accordance with various embodiments, to improve future responses to similar situations.

Another implementation of the process, used for verifying transactions through automated trustees configured in accordance with multiple embodiments of the invention, is illustrated in FIG. 18B. As above, process 1800 may be performed by entities including but not limited to blockchain wallets, digital wallets, and/or user devices. Process 1800 receives (1805) a request to perform a transaction from a user. In accordance with certain embodiments, transactions may be initiated by interacting with web3 websites. In such cases, the web3 websites may, on receiving data (related to the request) from the blockchain wallet, construct a proposed transaction including the data received and/or transmit the proposed transaction to the blockchain wallet(s). In accordance with some embodiments, process 1800 may provide users with functionality to facilitate the requests.

Process 1800 may (e.g., automatically) select (1835) at least one automated trustee to verify the transaction. As in FIG. 18A, process 1800 may select the at least one automated trustee from a list of approved trustees and/or may send notification(s) of the selection. In accordance with some embodiments, selections may be made according to determined sets of criteria including but not limited to the reputation of the appropriate trustee(s); history of response speed of the appropriate trustee(s), qualities of the transaction(s) requested (which may include value of the transaction(s), speed of processing requirement(s) of the transaction(s), recipient(s) of assets to be transferred by the transaction, etc.), and/or number of times the appropriate trustee(s) has been selected before. Systems in accordance with several embodiments of the invention may invoke determinations of agents in a manner that maximizes the degree of automation. In some embodiments, some of the trustees may be automated, some may be human, and some may include hybrid systems of automation and human actions.

Process 1800 may transmit (1840) data pertaining to the request to the (at least one) automated trustee. The data may include, but is not limited to one or more of: the transactions themselves, valuations of the transactions, time limits for the transactions, (identifiers of) recipients of assets to be transferred by the transactions, authentication values of the users initiating the transactions, transaction nonces, metadata files (that may include further information pertaining to the transaction), and request headers. In accordance with certain embodiments of the invention, process 1800 may, on receiving the request(s), present the users with interface components to transmit the request to the (at least one) automated trustee. Process 1800 may determine (1845) whether the (at least one) automated trustee is able to process the request. In accordance with miscellaneous embodiments, the determination (1845) may be made by automated trustee preliminary feedback. Additionally or alternatively, the determination (1845) may be made as part of the selection process detailed above in step (1835).

When process 1800 determines (1845) that the (at least one) automated trustee is unable to process the request, the request may be forwarded to an external trustee. In some embodiments, potential external trustees may include but are not limited to other automated trustees, default pre-selected trustee options, various individuals with trustee permissions, and/or “partially automated trustees.” In accordance with some embodiments, partially automated trustees may refer to automated tools operated by (chosen) individuals.

When process 1800 determines (1845) that the (at least one) automated trustee may process the request, process 1800 may process (1850) the request and transmit a request response accordingly. In such case, process 1800 may follow the steps described in FIG. 18A, (e.g., steps (1820), (1825), and/or (1830))

While specific processes for transaction verification are described above, any of a variety of processes may be utilized to respond to requests as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

When trustees approve requests, the received user requests may be processed, and the resulting completed transaction requests may be output. In accordance with numerous embodiments, completed transaction requests may be posted to the blockchain. In systems implemented in accordance with several embodiments of the invention, requests received by trustees from users (and/or attackers posing as users) may be configured into formats that prevent transactions from automatically being completed when posted to the blockchain. For example, they may take forms including but not limited to being encrypted, missing authentication information, being locked and requiring second transactions for the (initial) transactions to be completed, and/or being authorized using only portions of private keys (as opposed to the complete private keys). The trustees, upon approving transaction requests, may transform at least portions of the received requests to completed transaction requests when submitted to the blockchain. In cases where second transactions are required, the trustees may generate the second transaction, enabling the (initial) transactions to be completed (when submitted).

When the received user requests are converted, in accordance with some embodiments of the invention, they may be posted to the blockchain by the trustees (on behalf of the user(s)). Additionally or alternatively, they may be returned by the trustees to the users that initially made them (e.g., via their browser and/or wallets), for them to personally complete the posting of the transactions. In either event, the completed transaction request may be transmitted to parties responsible for the processing of the completed transaction request, including but not limited to miners that may integrate the associated data into blockchain ledger entries; and/or to blockchain node providers, for the completed transactions to be submitted to the blockchain mempool.

When trustees deny requests, they may initiate one or more actions, including but not limited to: notifying the users (e.g., via the users' browsers and/or wallets) that the request was denied; sending the users explanations and/or error codes that may correspond to the one or more classifications made based on the one or more policies; notify the users of being under attack; modifying one or more thresholds associated with the users (and/or associated organizations); modifying models associated with the users, and/or with collections of (e.g., related) users, thereby improving the recognition of abuse onwards; identifying patterns of denied transactions (e.g., transactions requested by the same users, requested by collections of related users, and/or requested by any users within specified windows of time) to enable the creation of better anomaly detection models; and/or setting time period wherein different sets of policies are activated for the users (e.g., setting a timer to 24 h to allow heightened scrutiny of all requests after given anomalous requests are detected).

Additionally or alternatively, similar actions may be taken based on the approval of requests, including but not limited to conveying successful processing to the user, modifying thresholds and/or models, etc.

Systems in accordance with several embodiments of the invention may be configured to compare transaction requests to requests that were previously processed and/or are currently being processed. As one or more requests are identified as being potentially risky, e.g., having risk scores that exceed certain thresholds threshold, requests may be compared in order to identify similarities. Example points of similarity may include but are not limited to being associated with particular user(s) and/or organization(s) (e.g., as identified by sender/recipient identifiers, as identified by user input information, as identified by request-associated links and/or URLs); using particular smart contracts; being part of suites of associated requests (e.g., requests of particular sizes and/or with particular timing).

In accordance with certain embodiments, similarities may be determined using AI and/or machine learning algorithms (ML). The creation of AI and/or ML models may be configured to use information including but not limited to risk scores as input. As such, models built in accordance with many embodiments of the invention may be used to score future requests. In such cases, models may associate individual users with one or more thresholds identifying the users' risk tolerance. Additionally or alternatively, these thresholds may be learned by models/systems configured in accordance with several embodiments of the invention. User thresholds may be determined by factors including but not limited to the transactions the users initiate, complete, complain about, etc. Models and/or user thresholds may be used by entities including but not limited to digital and/or blockchain wallets to score requests (initiated by the wallet users and/or external parties). Additionally or alternatively, scoring capabilities may be used by trustees and/or trustee-associated agents.

In multiple embodiments, trust and risk assessments may involve significant effort on the part of trustees, so trustees may be enabled to share information collected with each other (reducing duplication of effort in the process). In facilitating this, trustees may accrue trust (or trustee) scores, corresponding to the trustworthiness of their verifications/determinations. In accordance with a number of embodiments of the inventions, trust scores may be global, absolute, and/or relative within subsets of users (e.g., users from specific demographics and/or users with specific relationships). Trustees, on receiving transaction requests may be able to transmit part or all of the requests to other trustees for assessment. In accordance with certain embodiments, these (additional) trustees may receive redacted, modified, and/or transformed data derived from the transaction requests. As a result, trustees implemented in accordance with numerous embodiments of the invention may base final assessments of requests on responses/feedback received from the other trustees. The final assessments may include composites of responses received. Additionally or alternatively, individual responses/pieces of feedback received may be adjusted based on existing trust scores (e.g., according to a weighting factor).

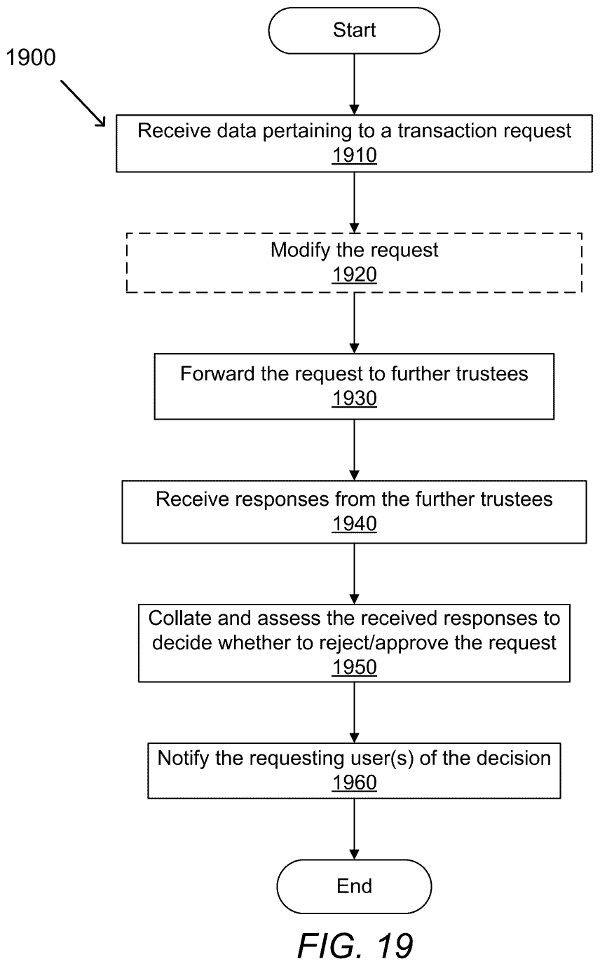

A process for evaluating received requests, performed by trustees operating in accordance with several embodiments of the invention, is illustrated in FIG. 19. Process 1900 may be performed through devices corresponding to appointed and/or automated trustees.

Process 1900 receives (1910), data pertaining to a transaction request. The data may include, but is not limited to one or more of: the transactions themselves, valuations of the transactions, time limits for the transactions, (identifiers of) recipients of assets to be transferred by the transactions, authentication values of the users initiating the transactions, transaction nonces, metadata files (that may include further information pertaining to the transaction), and request headers.

Process 1900 forwards (1930) the request (and/or associated data) to one or more additional trustees. In some embodiments, the trustees chosen to be forwarded the data may be determined automatically and/or manually. The selection may be made using one or more criteria including but not limited to trustee reputation, trustee speed of response, frequency of selection, and/or aspects of the transaction(s) requested. Trustees may be chosen based on transaction aspects including but not limited to transaction value, speed of processing requirement of the transaction(s), and/or the intended recipient(s) of the assets to be transferred). Before forwarding (1930) the request, process 1900 may modify (1920) the request and/or associated data (i.e., transform and/or redact information from the request) to hide personal information corresponding to the underlying users and/or their assets. Process 1900 receives (1940) one or more responses from the further trustees. In accordance with numerous embodiments, time limits for responses to be considered may be applied.

Process 1900 collates and/or assesses (1950) the one or more responses to decide whether to reject/approve the request. As indicated above, in certain embodiments, different responses from different trustees may be given different weights, based on trust scores. The eventual decision may be made based on methods including but not limited to determining averages (e.g., average risk scores) for the responses, treating each (e.g., Y/N binary) response as a vote, etc. Process 1900 notifies (1960) the requesting user of the decision.

While specific processes for transaction assessment are described above, any of a variety of processes may be utilized to respond to requests as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

In accordance with numerous embodiments of the invention, trustees may be associated with protective entities including but not limited to insurance companies and/or financial institutions. These protective entities may implement offers to take on the liability for transactions that they fail to protect. The liability may correspond to false negatives (i.e., the losses associated with transactions that turned out to be fraudulent and which the trustee(s) failed to block) and/or false positives (i.e., the losses associated with transactions that were legitimate, where the opportunity was lost due to trustees rejection, such as in cases where offers are time sensitive). Insurance companies may compensate losses in full or in part based on the type of insurance policies established between the users and their trustees (and/or associated insurers). Security companies may also provide such assurances and protection through means including but not limited to collaboration with external insurers and/or accepting direct liability. Security companies may, additionally or alternatively, purchase insurance to cover their own losses, should they have to pay for the claim. Their policies may be priced based on factors including but not limited to the security measures they put in place, the results of internal testing and audits, and their history of (un)successful provision of service to subscribing end users. Further, in accordance with many embodiments of the invention, insurance methods may be implemented in centralized and/or decentralized contexts.

In several embodiments of the invention, when implementing insurance methods in decentralized manners, smart contracts may receive, hold, and transfer assets on behalf of owners. As such, smart contracts may require transfer requests from owners and/or approvals from trustees before transfer requests are enacted.

Smart contracts implemented in accordance with some embodiments of the invention may be configured to make regular insurance premium payments to trustees. Additionally or alternatively, proportions of the insurance premium payments may be held in escrow for claim payouts as escrow funds. In the event of approval of fraudulent and/or scam transactions by trustees, owners may make claim requests to smart contracts holding the escrow funds for compensation. In some embodiments, the compensation may be paid out after independent third-party review of the fraudulent and/or scam transactions confirms to the smart contracts holding the escrow funds that the trustee(s) are responsible for paying compensation.

In accordance with some embodiments, when implementing insurance methods in centralized manners, (e.g., blockchain) wallets may provide interfaces to servers maintaining public and/or private keys. The public and/or private keys may be used to derive blockchain addresses, which may be used for receiving, holding, and/or transferring assets on behalf of users of the wallets. The blockchain wallets may be used by the users to request approvals for transfer requests from trustees before the transfer requests are enacted (e.g., transmitting transactions to the blockchain).

Systems configured in accordance with numerous embodiments may make regular insurance premium payments to the trustees in return for guarantees that the trustees will only approve transactions that are not damaging to users (and their assets). As described above, proportions of the insurance premium payments may be held in escrow for claim payouts as escrow funds. In the event of approval of fraudulent and/or scam transactions by trustees and/or servers, owners may make claim requests to smart contracts holding the escrow funds for compensation. In some embodiments, the compensation may be paid out after independent third-party review of the fraudulent and/or scam transactions confirms to the trustees (and/or other parties) holding the escrow funds that the trustee(s) are responsible for paying compensation.

In accordance with multiple embodiments, different brands of (e.g., blockchain, digital) wallets may cause different insurance coverage and/or different costs of insurance and/or deductibles when there are claims. Additionally or alternatively, wallets whose software components are not kept updated may affect coverage and/or costs.

In accordance with numerous embodiments of the invention, insurers and/or the trustees may audit wallets to determine whether they match certain (e.g., predetermined sets of) requirements. Based on this, insurers and/or trustees may determine the policies that apply and/or assurances provided to certain wallets and/or users. The auditing may include but is not limited to software-based attestation, verifying that proper and updated client software is installed (e.g., anti-virus software), and/or verifying that no malicious apps are installed. The auditing may require that the wallets are configured according to the sets of requirements, including but not limited to requirements for correct information about the address, jurisdiction, and identity of the user(s) associated with the wallets. Additionally or alternatively, auditing may require that associated configurations (including but not limited to tax reporting configurations, based on the jurisdiction) are properly set.

When wallets are not in compliance, the trustees/insurers may refuse to provide services and/or protection (e.g., assurances related to liability) and/or may reduce the services and protection provided. This may thereby encourage users to properly configure their wallets or face the possibility of not having their transactions protected.

One form of auditing may include (but is not limited to) performing computations on components (such as those described below) that are stored in trusted execution environments (also described below). Additionally or alternatively, this auditing may be performed by entities (e.g., trustees) that may implement escrow authority.

### B. Smart Contract Implementations

Generally, wallets connecting to smart contract-enabled blockchains may be used to construct and sign transactions to be submitted to blockchains. This may be used for direct transfers of native cryptocurrency, and/or interacting with functions of smart contracts (e.g., to transfer tokens, exchange tokens, and/or initiate other smart contract interactions). Thus undertaking complex smart contract activity may require decentralized application providers to design, deploy and/or configure required functionality on behalf of wallet users. Further, deploying smart contracts may require compilers and deployment toolchains. For example, while Ethereum current choices include Hardhat, Foundry, Truffle, and/or the web-based system called Remix, systems in accordance with multiple embodiments of the invention may provide practical choices for average blockchain users, (who may be familiar with simple transactions and signing processes using blockchain wallets, but have no programming experience and/or toolchain experience).

In accordance with miscellaneous embodiments of the invention, blockchain wallets may include smart contract templates and/or interfaces allowing users to select and deploy instances of the templates. In some embodiments, users/user devices may or may not be configured to receive notifications of actions taken on the basis of their interactions with the blockchain wallet including but not limited to smart contract assembling, compilation, and deployment. Templates may include but are not limited to complete smart contract code, and/or routines and/or functions that may be commonly used within smart contracts. Additionally or alternatively, blockchain wallets may store and track details concerning one or more smart contracts deployed by the wallets including but not limited to smart contract addresses, events initiated by smart contracts, state changes within data structures of smart contracts, transactions submitted by the blockchain wallets and/or by third parties that interacted with smart contracts.

In accordance with some embodiments of the invention, blockchain wallets may include and/or access multi-signature smart contract templates. The multi-signature smart contract templates may include but are not limited to functionality for receiving digital assets and/or tokens (that may include but is not limited to fungible tokens, non-fungible tokens, liquidity provider tokens, share tokens, utility tokens, etc.).

Systems in accordance with certain embodiments may allow wallet owners to transfer assets to second parties, (for example, their child) such that they may not spend said assets without approval from the wallet owners. In the background, the blockchain wallet(s) may deploy smart contracts implementing functionality requiring two signatories to sign transactions to transfer assets the smart contract(s) hold. Additionally or alternatively, the blockchain wallet(s) may set the signatories to be the blockchain wallet owner(s) and the at least one second party. The blockchain wallet(s) may then transfer the assets to the smart contract(s). In accordance with numerous embodiments, the blockchain wallet(s) may send messages to the (e.g., blockchain, digital) wallets of the second parties to provide confirmation that the smart contract(s) have been deployed.

The wallets of second parties that are given this “provisional ownership” may display ownership of the assets to the second party. However, they (additionally or alternatively) may indicate that transacting with the assets further requires wallet owner signature(s). As an example, when a second party informs their wallet that some or all of the assets should be (e.g., transferred), the wallet of the second party may contact the blockchain wallet of the wallet owner to request a second signature to authorize the transaction.

In accordance with several embodiments, blockchain wallets may include but are not limited to NFT wrapping smart contract templates that may be used to govern functionality for transacting NFTs, and/or issuing amounts of fungible tokens corresponding to fractional ownership of the NFTs. In an example situation, an owner of a particular blockchain wallet may possess NFTs, holding them using a blockchain wallet. When the owner decides to fractionalize their NFTs (for example, into 100 fractions) they may use user interface components of their blockchain wallet to do so. In the background, the blockchain wallet may deploy a smart contract using the NFT wrapping smart contract template, and then transfer the NFT to the smart contract, receiving (e.g., 100) fraction tokens in return. The owner of the wallet may then transfer some and/or all of the 100 fraction tokens to other accounts on the blockchain.

In accordance with several embodiments of the invention, blockchain wallets may include ERC721 smart contract templates for instantiating NFTs. In another example, the owner of the blockchain wallet may wish to mint an NFT using, for example, a picture taken with smart phone on which the blockchain wallet software is running. The owner may interact with the blockchain wallet through the interface to indicate the NFT is to be minted using the picture and providing further metadata concerning the picture. In the background, the blockchain wallet may deploy a smart contract using the ERC721 smart contract template and may subsequently mint the NFT using the smart contract, providing the picture (and further metadata) to the smart contract. The NFT may then be displayed in the blockchain wallet.

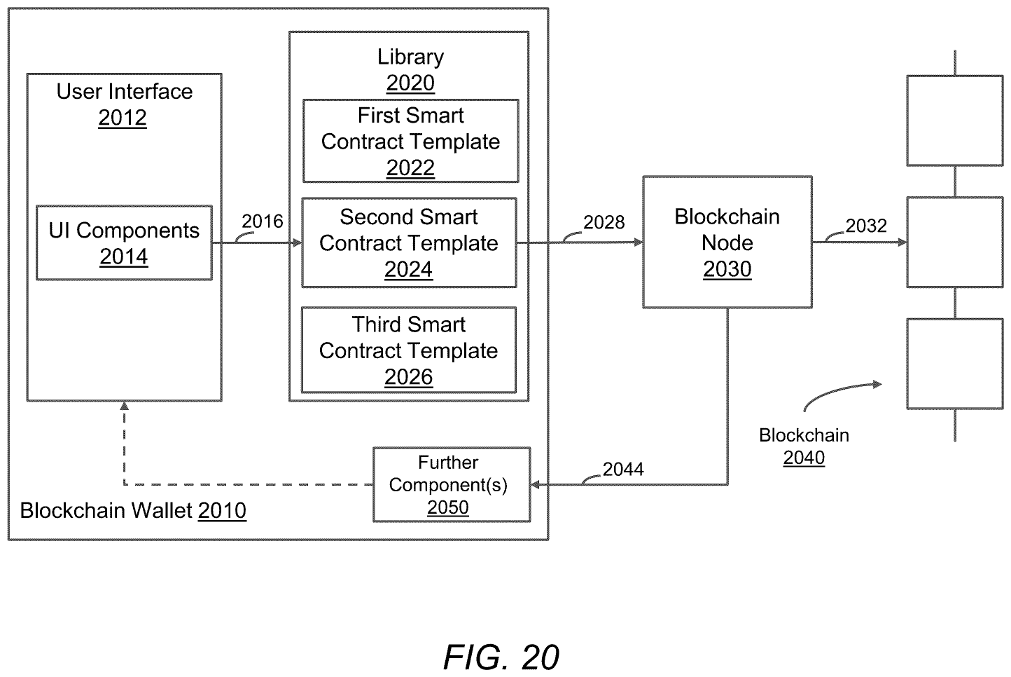

An example of a blockchain wallet configured, in accordance with several embodiments of the invention, to deploy smart contracts is illustrated in FIG. 20. Blockchain wallets 2010 may include but are not limited to a user interface 2012 and a library 2020 of smart contract templates.

The libraries 2020 implemented in blockchain wallets 2010 configured in accordance with numerous embodiments of the invention may be individually populated by one or more smart contract templates. In FIG. 20, presented for illustrative purposes only and not meant to be limiting in any way, a first smart contract template 2022, second smart contract template 2024, and third smart contract template 2026 are presented.

In various embodiments, sets of smart contract templates (e.g., stored in libraries 2020) may include but are not limited to one or more of: complete smart contracts, pluralities of smart contracts, (one or more) smart contract functions, (one or more) data structures, (one or more) error structures, (one or more) event definitions, (one or more) variables, and/or (one or more) mappings. Libraries 2020 may (at least partially) include implementations of Ethereum Request for Comment standards, for example but not limited to, ERC20 for fungible tokens, ERC721 for non-fungible tokens, ERC1155 for mixed fungible and non-fungible types, ERC-4626 for token vaults, ERC-4337 for paymasters, etc.

User interfaces 2012 implemented in accordance with multiple embodiments of the invention may incorporate (one or more) user interface components 2014 including but not limited to components allowing users to automatically and/or manually modify smart contracts (e.g., buttons and text input fields).

When users interact with user interface components 2014 (for example by clicking a button) various actions 2016 may be used to implement these modifications, such as the action 2016 of FIG. 20, used to deploy 2028 the second smart contract 2024. Additionally or alternatively, selected actions may be interpreted as requests by blockchain wallets configured in accordance with numerous embodiments of the invention. In such cases, it may be left to the (e.g., policies of) the blockchain wallets 2010 to determine whether requested actions 2016 may and/or should be followed. The requested actions 2016 input into the user interface 2012 may (additionally or alternatively) allow users to select one or more elements of (one or more) smart contracts to be combined, modified, and/or deployed.

When smart contract deployment 2028 is selected, blockchain wallets 2010 configured in accordance with many embodiments of the invention may respond by constructing smart contract deployment transactions including the selected (and/or modified) smart contracts. Additionally or alternatively, the blockchain wallets 2010 may be configured to pass smart contract code to components for constructing smart contract deployment transactions. Additionally or alternatively, the blockchain wallets 2010 may be configured to transmit 2028 the constructed smart contract deployment transactions to blockchain nodes 2030.

Upon receiving smart contract deployment transactions, blockchain nodes 2030 configured in accordance with several embodiments of the invention may themselves deploy 2032 the smart contracts to blockchain 2040.

When smart contracts are deployed successfully, and/or when there are problems with deploying the smart contracts, blockchain nodes 2030 configured in accordance with some embodiments of the invention may return 2044 deployment information to one or more further component(s) 2050 (e.g., data storage structures) of the blockchain wallets 2010.

In accordance with various embodiments of the invention, further component(s) of the blockchain wallet(s) may be used to store relevant information to the attempted deployment. Information received may be used to construct possible interface components for users to interact with including but not limited to correcting failed deployment, accessing the (i.e., deployed) smart contract(s), and/or interacting with the other smart contract templates 2022, 2026.

With successful deployment, the further component(s) 2050 may store information received concerning the smart contracts, which may include but are not limited to one or more of: the smart contract addresses, the block height(s) at which the smart contracts were deployed, costs associated with smart contract deployment, corresponding date and timestamps, configuration parameters for the smart contracts, list of callable functions of the smart contracts, credentials required to interact with the smart contracts, and other information of interest. Information received may subsequently be retrieved by the blockchain wallets 2010 from the further component(s) 2050 for displaying to the user in the user interfaces 2012.

With failed deployment, the further component(s) 2050 may store information received concerning reasons for failure. Said reasons may similarly be retrieved by the blockchain wallet 2010 from the further component 2050 for displaying to the users in the user interface 2012.

Smart contracts configured in accordance with various embodiments of the invention may be able to execute functionality without requiring external action (e.g., external scripts and/or people using an associated blockchain wallet). In doing so, systems may mitigate dependency on externally owned accounts, people, and/or scripts to perform (e.g., repeated) actions. In numerous embodiments, components including but not limited to blockchain protocol, node software, and/or smart contract programming languages may include the capacity to execute functions of smart contracts on a regular stated basis. This application may refer to such smart contracts as autonomous smart contracts. Many of the methods disclosed in relation to autonomous smart contracts may (additionally or alternatively) apply to smart contracts that are not autonomous, and/or that are only partially autonomous. Smart contracts may be made autonomous, partially autonomous, intermittently autonomous, conditionally autonomous, and/or temporally autonomous using the methods disclosed herein.

In accordance with several embodiments, execution may occur in manners similar to Linux cron job and/or Microsoft Windows scheduled tasks, although such functionality is not possible with today's blockchain technology, which is not compatible with Linux cron jobs, Microsoft Windows scheduled tasks, and/or similar technologies. Furthermore, even when it was possible to execute smart contracts externally using a system including external hardware and software, failure in said system would result in potentially highly costly failure to execute the function and/or functions of the smart contract. On the other hand, blockchain protocol including functionality to execute function and/or functions would result in reliable execution provided at least one node of the blockchain is functional. When no nodes are functional, the entire blockchain is non-functional, and the question of reliable smart contract execution becomes moot. The present disclosure therefore provides the most reliable implementation of automated smart contract execution, enhancing smart contract-enabled blockchains with superior autonomous functionality compared to currently available methods.

In accordance with a number of embodiments of the invention, nodes validating and extending a blockchain may include components responsible for storing registries of autonomous smart contracts that are run on a regular basis (and the periodicity of execution for each). Some autonomous smart contracts, when executed, may cause other smart contracts to be executed, where the selection of what smart contract to execute may be a function of the input to the autonomous smart contract that causes the execution. Additionally or alternatively, smart contracts configured in accordance with many embodiments of the invention may set and/or change the periodicity and/or the triggering conditions for causing another smart contract to execute. Some autonomous smart contracts may be associated with instructions and/or configurations that specify ranges of frequencies and/or types of contracts that may cause them to execute. Numerous wallets may cause one or more autonomous smart contracts to be activated (e.g., by starting execution), and may provide such autonomous smart contracts with inputs used in their execution. Additionally or alternatively, autonomous smart contracts may use inputs that are environmental and/or correspond to data stored on the blockchain. Autonomous smart contract execution may involve but is not limited to, being proxied, chained, and/or cascaded.

In accordance with multiple embodiments of the invention, smart contract programming languages may include but are not limited to function modifiers. These function modifiers may be implemented such that blockchain nodes are signaled to run functions marked with the function modifier on a regular basis (thus making the resulting smart contracts autonomous). Execution of the function may consume gas for each execution; as such, in accordance with miscellaneous embodiments of the invention, smart contracts may be required to own a sufficient amount of native cryptocurrency to cover gas costs for execution. When autonomous smart contracts do not own and/or have privileges enabling access to enough native cryptocurrency to cover gas costs and other potential costs, nodes may decline to execute the function. Funds needed to cover gas fees and other costs may also be provided by entities that activate the autonomous smart contracts, including but not limited to other smart contracts, wallets, and/or through account abstraction and paymasters such as that provided on Ethereum through ERC-4337/EIP-4337, “Account Abstraction Using Alt Mempool” (reference: https://eips.ethereum.org/EIPS/eip-4337), incorporated herein by reference in its entirety.

In accordance with many embodiments, function modifiers may be run repeatedly over periods of time specified according to (but not limited to) the number of blocks on a blockchain, Unix timestamps, times directly set under UTC, and/or times directly set in standard time units such as seconds.

In accordance with certain embodiments of the invention, the functions used for autonomous smart contracts may govern specific (e.g., financial) payouts. In an example presented for illustrative purposes only and not meant to be limiting in any way, an autonomous smart contract deployed on the Ethereum blockchain may implement a pocket money payout system. The autonomous smart contract may include a payout function modified with a function modifier indicating that the payout function should be run at a regular interval (e.g., every 604800 seconds, or one week). In such cases, the payout function may thereby transfer (e.g., NFTs, fungible) tokens to a particular recipient blockchain address (e.g., fungible tokens being sent to a child as pocket money). Blockchain nodes configured in accordance with many embodiments may register the autonomous smart contracts and/or may execute the (e.g., payout) functions automatically. As described above, this may be subject to the autonomous smart contract owning enough ether to cover gas costs and/or through other payment methods as disclosed above.

Functionalities configured in accordance with multiple embodiments of the invention, henceforth referred to as autonomous smart contract triggers, may be implemented (e.g., via blockchain protocol, node software, and/or smart contract programming languages) to automatically execute function(s) of smart contract(s) in response to observable occurrences including but not limited to changes in state of the blockchain. In some embodiments, nodes validating and extending the blockchains may include components responsible for storing registries of smart contracts. These components may include but are not limited to smart contract triggers for functionality to be executed under specific conditions and/or details of the specific conditions triggering function execution.

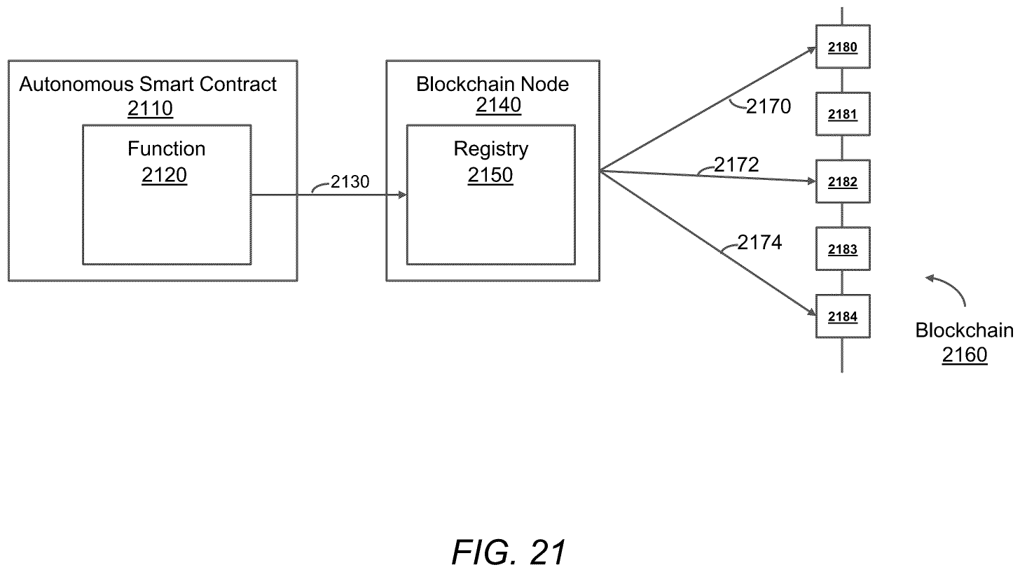

An example of systems used for automatically executing smart contract functions in accordance with certain embodiments of the invention is illustrated in FIG. 21. A block diagram is presented, for illustrative purposes only and not meant to be limiting in any way, describing a system for executing the function(s) 2120 of autonomous smart contract(s) 2110. These executions may be implemented in various ways, including but not limited to automatic execution, execution on a regular basis, individual execution, and/or manual execution. In accordance with miscellaneous embodiments, details of the functions 2120 may be recorded by blockchain nodes 2140. In some embodiments of the invention, these details may be listed on registries 2150 corresponding to the individual blockchain nodes 2140. In some embodiments, the blockchain node 2140 may not directly store the registry 2150. Additionally or alternatively, registries 2150 may be stored in one or more of: blockchain blocks, cloud servers, external storage devices, databases, and/or files.

The details of individual functions 2120 may include but are not limited to information governing operation of the functions 2120. This may include but is not limited to notifications of how frequently the function 2120 is to be run. In the present example, for illustrative purposes, the details of the function 2120 presented instructions that the function 2120 should be run on every other block generated on a blockchain 2160. It will be appreciated that there are many different running triggers and/or configurations for how functions 2120 may be operated in accordance with many embodiments of the invention.

Once the function(s) 2120 of autonomous smart contracts 2110 are registered in one or more registries 2150, the associated blockchain nodes 2180, 2181, 2182, 2183, 2184 operating in accordance with several embodiments of the invention may run the function(s) 2120 as prescribed. For example, in the present embodiment of FIG. 21, the function 2120 is prescribed to run every other block, as shown in FIG. 21 by a first action 2170 running the function 2120 in block 2180, by a second action 2172 running the function 2120 in block 2182, and by a third action 2174 running the function 2120 in block 2184. In this case, as the function 2120 is prescribed to run every other block, the blockchain node 2140 does not run the function 2120 in block 2181 and/or block 2183.

Functions 2120 may be run by blockchain nodes 2140 through the generation of transactions for each function run. The transactions may include (but are not limited to) transaction sender addresses of the autonomous smart contracts, and fees for running each function run may be taken from the balances held by the autonomous smart contracts.

A plurality of blockchain nodes 2140 maintaining and extending blockchains 2160 may each add individual entries to their own registries. These entries may be constructed when parsing blocks in which the autonomous smart contracts 2110 were deployed. Through this, each of a plurality of nodes 2140 may construct identical registries. In a number of embodiments, different nodes from the set of the plurality of blockchain nodes 2140 may be running different blockchain node software implementing the blockchain protocol using different code bases and/or programming language(s). Additionally or alternatively, the registry of each blockchain node 2140 may not necessarily be syntactically and/or structurally identical but may be semantically identical.

Smart contracts deployed, in accordance with multiple embodiments of the invention, may belong to one or more categories, corresponding to the characteristics including but not limited to functionalities of the smart contracts, the creators of the smart contracts, reputation ranges of the smart contracts, certification types of the smart contracts, assurances associated with the smart contracts; one or more jurisdictions associated with the smart contracts; and/or information about the originators of the smart contracts. In some embodiments, there may be many smart contracts in specific categories. In such cases, individual smart contracts may be associated with scores indicating their past performance, where this may correspond to attributes including but not limited to recommendation value, fit, the number of times they have been activated, etc. In accordance with some embodiments, these scores may be relative to other smart contracts in the same category. Each smart contract in individual categories may, additionally or alternatively, be associated with fees, corresponding to the costs that calling (other) contracts, wallets, and/or other entities have to pay to activate the contracts. This may enable a marketplace of routines that may be used as subroutines in other smart contracts. An example of such a routine may be an AI that takes provided input and generates a result, such as a local minimum associated with search space. The fee may depend on the performance, including but not limited to whether the called smart contracts (and/or other routine) produce a response that satisfies some criteria.

Autonomous smart contracts (which may include functions configured to execute periodically, and/or in response to predefined events) may be implemented (in accordance with various embodiments) to belong to one or more categories. These categories may specifically be used to collectively affect the automatic execution of their underlying autonomous smart contracts. For instance, automatic execution may be affected by changes in factors including but not limited to the reputation of the autonomous smart contracts, the reputation of the creators of the autonomous smart contracts, the reputation of the deployers of the autonomous smart contracts, certifications of the autonomous smart contracts, assurances associated with the smart contracts, and/or jurisdictions that the autonomous smart contracts are registered in. As such, categories may be implemented for each, with automatic execution of certain autonomous smart contracts being collectively modified based on whether they fall into a category. Automatic execution of autonomous smart contracts may, for instance, be affected by changes in reputation to other smart contracts (e.g., smart contracts used as libraries by the autonomous smart contract). The affected changes may include but are not limited to restrictions on the execution of one or more of the autonomous smart contract functions, relaxation of restrictions on the execution of one or more of the autonomous smart contract functions, limitation on the amount of cryptocurrency and/or tokens that may be minted, burned and/or transferred by the autonomous smart contracts, and/or alteration to allowlists/banlists associated with the autonomous smart contracts.

### C. Trusted Execution Environment Variations

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

In accordance with numerous embodiments of the invention, trusted execution environments may be established on computing entities (that may include but are not limited to hardware entities and/or cloud-based logical entities). Potential computing entities used in accordance with several embodiments of the invention may include but are not limited to consumer devices, such as mobile phones, laptops, and/or nodes in Internet of Things (IoT) networks. Computing entities may, additionally or alternatively, be logical and/or physical cloud entities, such as virtual machines (VMs), VM monitors (VMMs), and/or collections thereof.

The computing entities may correspond to public keys, and certificates by trusted entities on the public keys. Additionally or alternatively, the corresponding certificates may relate to classifications, including but not limited to the trust levels associated with the entities, and/or the conditions under which the entities may be considered to meet given specified trust level. Such conditions may include but are not limited to the location of (the entities') use, other computing entities associated with it, assurances associated with users of the computing entities, and/or software (e.g., anti-virus) that has been installed in the computing entities. The computing entities may store private keys corresponding to the public keys described above.

The computing entities may transmit the public keys and certificates to service providers. These service providers may perform preliminary services including but not limited to verifying the certificates; evaluating any associated classification(s) to confirm compliance with policies; and/or evaluating any associated condition(s) to confirm compliance with policies. Based on the above determinations, the service providers may (additionally or alternatively) determine whether to enable services to be executed on the computing entities. When the determinations are positive, data encrypted with the public keys of the computing entities may be transmitted to the computing entities. The computing entities may receive the encrypted data and load it in secure execution environments from which the private keys are accessible. The secure execution environments may decrypt the encrypted data and store the resulting data. This data may include but is not limited to sensitive personal data such as health data and biometric templates; sensitive configuration data such as cryptographic seeds, cryptographic keys (including symmetric keys, private keys and public keys) and/or passwords, cookies and other authentication data.

Examples of data that may be distributed in this manner include but are not limited to seeds and private keys associated with tokens (e.g., crypto funds and/or non-fungible tokens). The data may, additionally or alternatively, include proprietary data; this may be data belonging to users of the computing entities and/or to third parties that have granted access rights of the proprietary data to the users. Examples of such data may include but are not limited to digital rights management keys used to decrypt encrypted media files, code and/or data associated with non-fungible tokens (NFTs), and/or references to such data. In typical instantiation, the data that is delivered from the service providers to the computing entities may be transferred to: access enclosures associated with the data, one or more indicated applications, the service providers (and the applications and processes they allow to have access to the data), and/or other service providers that are allowed access to the data by the service providers and/or the users of the computing entities.

Computing entities may incorporate multiple access enclosures, which may be used to store content that includes but is not limited to data and executable code. Processes associated with different enclosures may exchange data with each other. These exchanges may be conditional on approval from one or more of the associated service providers, external trust management entities selected by the users (and/or the service providers), the users, admins/agents associated with the users, etc. One or more policies may govern what data may be exchanged between enclosures, and the conditions under which this is allowed. Use of these enclosures may be used to instantiate and deliver digital rights management environments, applications, and data to be used in such environments.

The classification of smart contracts implemented in accordance with various embodiments, may be used to make determinations including but not limited to whether smart contracts are/may be executed in trusted execution environments; what privileges the smart contract may be granted; and what filtering of the output should be applied, if any. The classifications may, additionally or alternatively, be used to identify one or more required and/or allowed trustee actions. Similar to how smart contracts may be associated with classifications, other code such as applications may have such classifications, and the classifications of different executable elements may determine not only their access rights and required security actions, as described above, but, additionally or alternatively, the manners in which they may exchange data with each other, store data in public repositories, and/or read/write data from storage areas of trusted execution environments.

Multiple access enclosures may, additionally or alternatively be used to clone services (including one or more such enclosures and their code, data, policies and other configurations) from one device to another. In this case, cloning may be conditional on approval by entities including but not limited to the user(s), admins of the user(s), service providers, and/or external trust management entities.

The above entities may have privileges to grant some or all (additional/alternative) actions including but not limited to the installation of data (including conditions, policies, applications, etc.); copying of such data; the creation of clones; and/or the erasures of such data. These actions may be applied to some or all of the relevant data, e.g., determined by the requests and the permissions of the entities making the requests.

The data stored by multiple access enclosures may (additionally or alternatively) include AI-related content, including but not limited to the AI code itself, models used by the AI; and data used to train the AI.

Just as external entities may write data to computation entities, as described above, external entities (with sufficient permissions and/or by the approval of entities with sufficient permissions) may facilitate the reading of data. In such cases, the data read may be limited by policies stored on and/or referenced by the computational entities.

In accordance with some embodiments, consumer devices may be cloned, at least in part, to be represented on one or more trusted execution environments residing on cloud computing networks. This may be done in response to requests to clone. Following this, the cloud embodiments created may perform at least some of the computational tasks that could otherwise have been performed by the original computational entities. This may increase availability, enable handovers between computational devices (such as phones and vehicles), be used to reduce power consumption, and/or minimize redundancy. This configuration may, additionally or alternatively, be used to move contents, access rights and personal information from primary wallets to replacement secondary wallets. Some access rights and/or content may be moved and/or copied from user devices to trustees, who may safekeep the access rights and/or content.

In accordance with multiple embodiments, copied material may be protected, e.g., encrypted, through distributing access rights such that a first entity (e.g., trustee) cannot access the material without collaborating with a second entity (e.g., trustee). This may be used such that the first trustee safe keeps encrypted data and the second trustee enables the access to the encrypted data by having access to decryption keys. The first and second trustees may collaborate to transfer content to a third party that is authorized to access data. In accordance with certain embodiments, this may be done by the first trustee sending the encrypted data to the third party and the second trustee sending the decryption key. Additionally or alternatively, a second trustee may break the decryption key into two component keys, where the second trustee decrypts the encrypted data using a first component key, resulting in partially decrypted data, and then transmits the second component key to the third party, along with the partially decrypted data, enabling the third party to use the second component key to decrypt the partially decrypted data, resulting in the cleartext data, i.e., the copied material.

The first and second trustee may, additionally or alternatively, process selections of the encrypted data, by making selections of packets of the encrypted data to process, including but not limited to processing only some of the packets received. This enables particular selections of data to be decrypted, which may be beneficial in contexts such as where the (first and second) trustees operate as escrow authorities (including but not limited to protecting the privacy of data unless a legal request to reveal some data is received). To do this, systems in accordance with some embodiments may individually encrypt each packet, where each packet contains a serial number indicating its location in an element (e.g., a stream, a file), along with information including but not limited to the names and/or type of elements, the creator of these, the date of creation, and other information indicating the meaning of, origin of and/or actions applied to one or more elements.

In accordance with several embodiments of the invention, elements may correspond to data files that may, include but are not limited to media content, cryptographic keys and/or identifiers, seeds, tokens, access rights, purchase records, identifiers of transactions, etc. Files may correspond to multiple packets that are individually accessible by means of decryption, where one such packet may include a media file and another may include one or more values that indicate risk and/or reputation, as disclosed above. This may enable first and second entities (e.g., trustees) to identify individual encrypted components that satisfy specific criteria, such as having a risk value exceeding a threshold, and/or selectively perform actions to components that satisfy a policy (taking as input the risk value and the threshold, and/or the result of their comparison).

Components configured in accordance with various embodiments of the invention may, additionally or alternatively, include indicators of smart contracts associated with the data of the component. That may enable the trustees, and/or other entities storing the data, to identify what components correspond to what smart contracts, which in turn enables the processing of components by smart contract.

In some embodiments, some packets corresponding to components may be encrypted, whereas others are not. Storing and/or transmitting data of components (in a manner wherein some packets are in plaintext) may enable low-cost filtering of data streams by the plaintext packets, including but not limited to without the need for any processing by entities with access to decryption keys. Potential components may be individual elements including but not limited to keys, tokens, and/or media files (e.g., that are part of tokens). However, components may, additionally or alternatively, include collections of such elements, e.g., a folder including other components, where some of these constituent elements may, additionally or alternatively, be folders. Components may, additionally or alternatively, be pointers to elements and/or keys useful to access and/or decrypt elements.

While specific tokens, smart contracts, and transaction trustee system configurations are described above with reference to FIGS. 18A-21, they may incorporate various attributes as appropriate to the requirements of specific applications in accordance with many embodiments of the invention. Additionally, the specific manner in which NFT transactions may be facilitated within NFT platforms in accordance with various embodiments of the invention is largely dependent upon the requirements of a given application.

Blockchain Wallets with Authentication Codes

Blockchain wallets are typically protected using a password, and in some cases a hardware wallet device that must be unlocked with a pin code to sign transactions. A problem with password protection is that users frequently choose simple passwords that may be revealed through brute force attacks, and/or write passwords down and do not store them securely. A problem with hardware wallets is that they can be difficult to use due to small buttons and a small monochrome gray and white display and may frequently not be to hand. A need therefore exists for an improved method of authentication for blockchain wallets.

In one embodiment the blockchain wallet includes a means for generating time-based one-time passwords (TOTP) for two-factor authentication (2FA), using an authenticator function that takes a seed, and returns a value that is updated over a regular period of time. In a first implementation of the present embodiment of the present invention, the regular period of time may be the average block generation time for the blockchain, and in a second implementation it may include the average propagation time and/or maximum expected propagation time for transactions across a peer-to-peer network instantiating the blockchain. In yet another example implementation, it may be 30 seconds, where time is determined by access to a time-keeping oracle, and/or be the duration between two defined events being observed.

In an alternate version of the present embodiment the authenticator may be on a separate device, such as a phone and/or separate hardware device. An authenticator is typically a deterministic pseudo-random number generator, typically producing a 6-digit random number, that takes as its seed a hidden value and a current timestamp in, for example, Unix time rounded down to a nearest multiple of a regular period of time.

In the present embodiment, every time a user submits a transaction, they may be required to enter a current value produced and displayed by the authenticator in an analogous manner to the use of authenticators in, for example, two-factor authentication for conventional websites.

The blockchain wallet may then generate a transaction including the current value and a timestamp indicating the time at which the current value was generated, and then submit the transaction to the peer-to-peer network.

What then remains as to how other parties, such as blockchain nodes, relay nodes, miners and/or validators may determine that the transaction is valid, that is, how to determine that the authenticator value incorporated in the transaction is the correct one.

In a first embodiment using watchful bridges as disclosed in PCT Patent Application No. PCT/US2023/062851, titled “Systems and Methods for Abuse Safeguards in NFT-Directed Environments,” filed on Feb. 17, 2023 (disclosed herein by reference in its entirety), a watchful bridge may: previously receive a copy of the seed value for the authenticator from the blockchain wallet, which in some embodiments may be signed by the blockchain wallet to provide evidence of its veracity, and/or the watchful bridge may generate and provide the blockchain wallet with a seed value that the blockchain wallet may subsequently use to generate a first time-dependent one-time password and then may return with a digital signature to the watchful bridge.

Transactions including a validator value may subsequently require endorsement in the form of a digital signature from a watchful bridge before they become valid. That is, miners and/or block validators may refuse to include a transaction in a block candidate for which there is no corresponding endorsement, either through a separate transaction originating from the watchful bridge, and/or attached to the transaction. The watchful bridge may monitor the memory pool of transactions for transactions requiring validation, and on detecting a transaction including a 2FA value, may look up the seed for the authenticator as stored against the blockchain address for the transaction, determine a valid value based on the seed and a current time, and may compare the 2FA value against the valid value, then endorsing the transaction when the 2FA value and the valid value match.

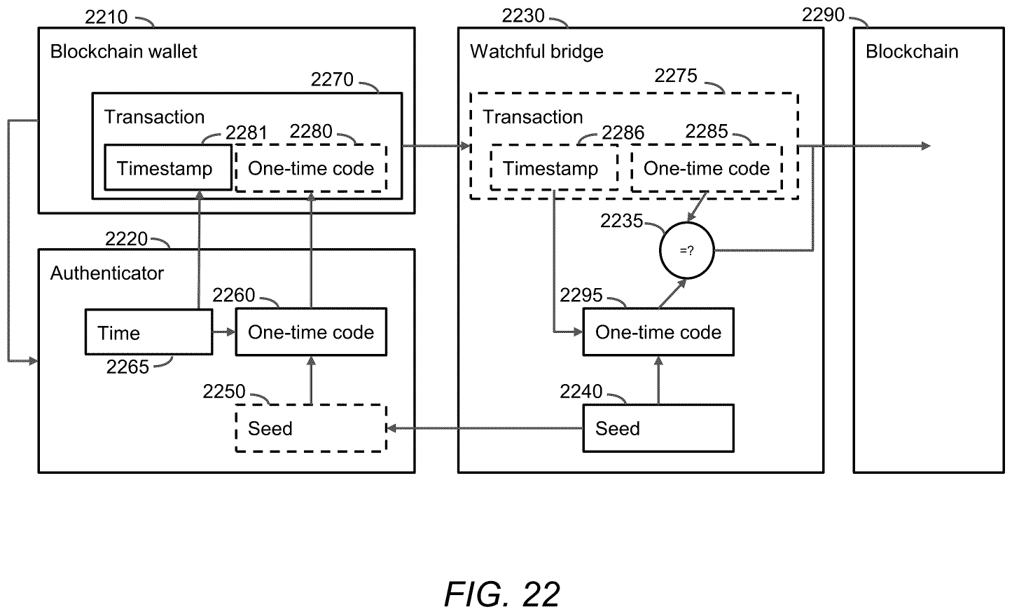

The first embodiment is illustrated in FIG. 22. A watchful bridge 2230 may generate an authenticator seed 2240, for example, on request from an authenticator 2220 associated with a blockchain wallet 2210. The watchful bridge 2230 may transfer a copy of the seed 2250 to the authenticator 2220. Thus at any given time the authenticator 2220 and the watchful bridge 2230 may generate the same one-time code.

Actions may proceed by a user initiating a construction of a transaction 2270 with the blockchain wallet 2210. The blockchain wallet 2210 may then trigger a one-time code generation request with the authenticator 2220. The authenticator may then use the current time 2265 and the copy of the seed 2250 to generate a one-time code 2260 and may transfer the one-time code 2260 and the time 2265 to the blockchain wallet 2210 on approval from the user.

The blockchain wallet 2210 may then incorporate a timestamp 2281 derived from the time 2265 and a copy of the one-time code 2280 in the transaction 2270. The blockchain wallet 2210 may subsequently transfer the transaction 2270 to the watchful bridge 2230, resulting in a copy of the transaction 2275 including a copy of the timestamp 2286 and a copy of the copy of the one-time code 2285 within the watchful bridge 2230.

The watchful bridge 2230 may then extract the copy of the timestamp 2286 from the copy of the transaction 2275 and use it together with the seed 2240 to generate a second one-time code 2295.

The watchful bridge 2230 may then compare the second one-time code 2295 with the copy of the copy of the one-time code 2285 using a comparison function 2235. If the second one-time code 2295 and the copy of the copy of the one-time code 2285 are equal, the watchful bridge may consider the copy of the transaction 2275 valid and may forward it to a blockchain 2290.

In yet another embodiment the functionality described above may be implemented using a hash-based message authentication code one-time passwords (HTOP) by replacing the timestamp with a counter.

In another embodiment, a blockchain wallet may generate a seed value and subsequently generate a one-time password hash pad by repeatedly hashing the seed. See also U.S. patent application Ser. No. 18/299,546, titled “Systems and Methods for Instant NFTs and Protection Structure, Detection of Malicious Code within Blockchain Smart Contracts, Tokens with Transfer Limitations, Mirror Tokens and Parallel Addresses, Smart Contract Risk Scoring Method, and Cross-Device Digital Rights Management,” filed Apr. 12, 2023, incorporated by reference in its entirety.

In the embodiment, a smart contract may be initialized for an address by a mapping from the address to a password from an end of the one-time password hash pad. Subsequently a transaction with the smart contract from the address may require a preimage password from the one-time password hash pad for the smart contract to execute the transaction, and the smart contract may overwrite the mapping with the pre-image. A subsequent transaction may thus require a pre-pre-image to authorize execution of the transaction. Those skilled in the art will appreciate that each transaction requires a prior entry from the one-time password hash pad to be authorized for execution.

A smart contract typically requires an expenditure of an underlying native cryptocurrency with commercial value, and the contents may be public, thus storing a full one-time password hash pad on chain would be both expensive and ineffective as any party can read the next password. The present embodiment overcomes both of these issues by reducing the storage requirement to one data element, for example a 256-bit hash output, and does not reveal any information that could be used to authorize an unauthorized transaction.

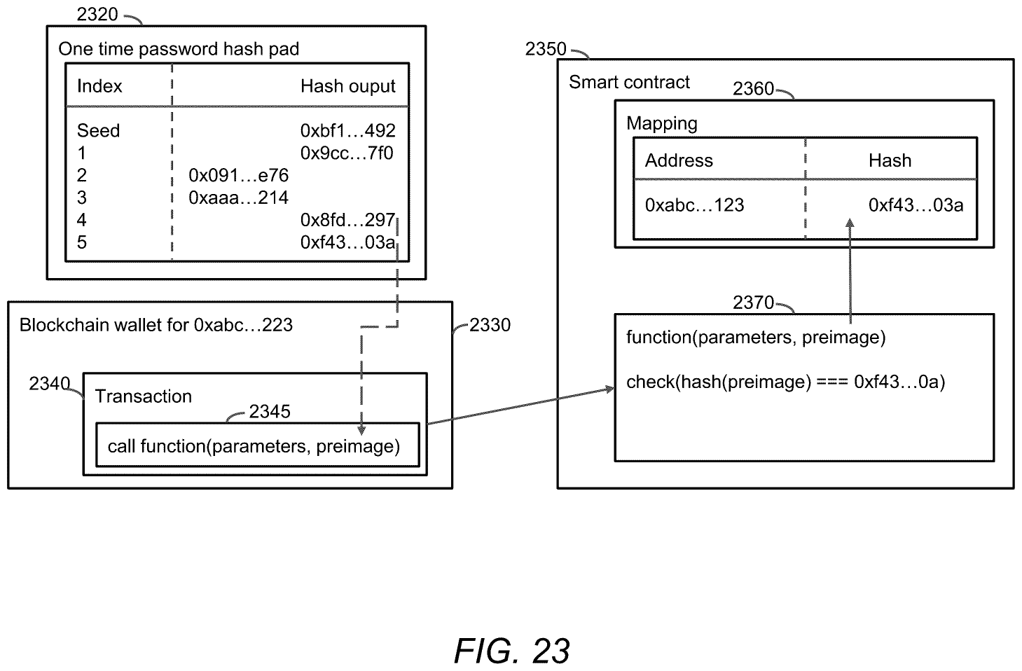

An illustration of the present embodiment may be found in FIG. 23. A one-time password hash pad 2320 may be generated from a seed by repeatedly hashing the seed with a cryptographic hash function to generate an indexed list of hash outputs. For example and not meant to be limiting in any way, a Keccak-256 cryptographic hash function K( ) may be applied to a seed S, produced by a random number generator, to produce K(S) at index 1, K(K(S)) at index 2, and so on, generalizing to Kⁿ(S) for the one time password pad entry at index n. Thus each entry is the preimage of the subsequent entry, but due to the nature of cryptographic hash functions a third party cannot determine the entry at index k given only the entries at k+1 and later. However, given an entry k, the veracity of said entry may be determined by hashing the entry k and verifying that it is equal to known entry k+1.

A blockchain wallet for an address 2330, in this example address 0xabc . . . 123, may be associated with the one-time password hash pad. For example, the one-time password hash pad may be stored in a mobile phone of a user in an authenticator app, and the blockchain wallet may be running on a computer of the user.

The user may initiate the construction of a transaction 2340 for calling a function 2370 in a smart contract 2350 on a blockchain, the transaction 2340 including a call to the function 2345 including parameters and an entry from the one-time password hash pad labeled a preimage in the present exemplary embodiment. In the present example, the preimage selected is at index 4, and is selected because a most recently revealed entry from the one-time password hash pad is at index 5.

In the embodiment, a transaction from the address may replace the one-time password hash pad for a new one-time password hash pad through a transaction providing a new password from the new one-time password hash pad and the currently valid one-time password from the one-time password hash pad. Through this a compromised one-time password hash pad and/or an expiring one-time password hash pad may be replaced.

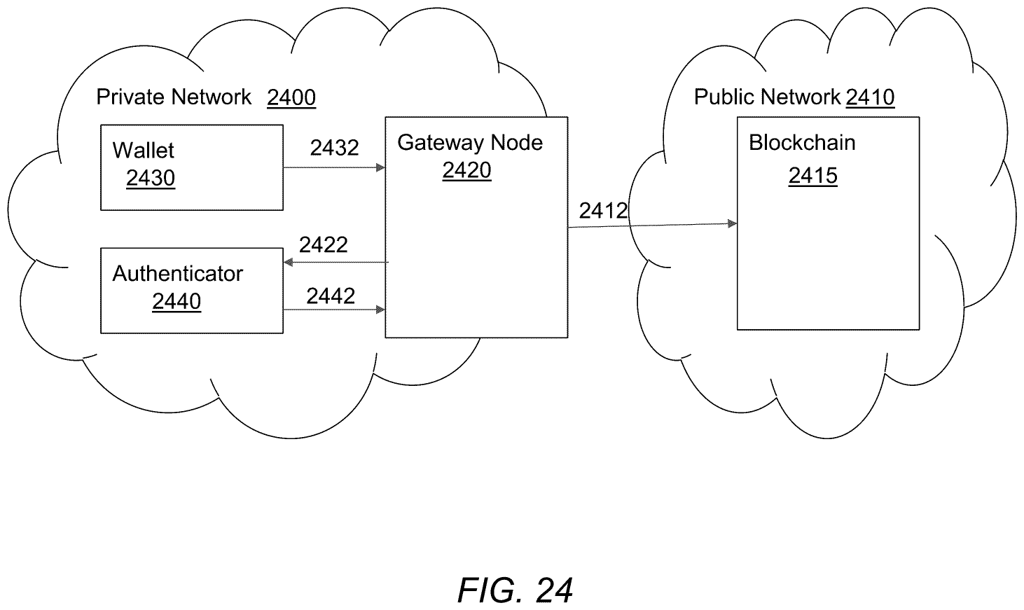

In another embodiment of the present disclosure, authentication may be conducted in a virtual private network and/or other closed ecosystem prior to an inclusion of transactions on a blockchain, as illustrated in FIG. 24.

In FIG. 24, a blockchain 2415 may be running on a public network 2410. A blockchain wallet 2430 may connect to a gateway node 2420 over a private network 2400, for example a virtual private network (VPN). The gateway node 2420 may include an only outbound route for transactions from the wallet 2430.

The wallet 2430 may transmit a transaction 2432 to the gateway node 2420 over the private network 2400. In some embodiments, the transaction 2432 may include a reference to an authenticator 2440.

Subsequently the gateway node 2420 may submit an authentication request 2422 to the authenticator 2440 also running on the private network 2400, and/or optionally on the public network 2410 with the authentication request 2422 made over a secure connection.

The authenticator 2440 may respond with an authentication response 2442.

When the authentication response 2442 is verified as valid by the gateway node 2420, the gateway node 2420 may submit a second transaction 2412 including the transaction 2432, which in some embodiments may have the reference to the authenticator 2440 removed, to the blockchain 2415.

While specific blockchain-directed configurations are described above with reference to FIGS. 22-24, they may incorporate various attributes as appropriate to the requirements of specific applications in accordance with numerous embodiments of the invention. Additionally, the specific manner in which authentications within NFT platforms in accordance with some embodiments of the invention is largely dependent upon the requirements of a given application.

### Voting System and Method for Non-Fungible Token Metadata and Assets Storage

The present disclosure provides systems and methods for allowing the level of decentralization of a non-fungible token contract to be adjusted through deterministic methods and voting.

A non-fungible token typically contains a pointer to digital assets such as metadata and/or other files, either on-chain or off-chain. Whereas ownership of the token is maintained on the chain by mapping a blockchain address or account to a token, or a token to a blockchain address or account, fundamental control of pointers stored in the token is typically maintained in the contract and either set permanently during deployment of a smart contract instantiating the token, or is alterable by a limited set of accounts which usually includes the smart contract deployer.

In one embodiment, the pointer for the token is instead placed under the control of the current owner of the token, that is, the address mapped to by the token is the only address that may alter the location pointed to by the token. Tokens may initially be instantiated with no pointer, or with a default pointer provided by the contract deployer or within the source code of the smart contract, but subsequently only the current owner of an individual token may alter the pointer of the token. A record of current and previous metadata pointers is therefore available on the blockchain, and any subsequent owner of the token may elect to revert the token metadata pointer to a prior one, or to submit a new one, for example, to a server that they manage or an IPFS file that they have uploaded.

In one embodiment, the token includes a reference to or indication of one or more parties that have the right to modify metadata pointers related to token content, e.g., based on one or more policies stated in or referenced by the token or otherwise associated with the one or more parties. These one or more parties may be designated fiduciaries, centralized or distributed. They may also correspond to a quorum of entities making up a consensus mechanism. The one or more parties may take as input data or request received from the content creator, the current token owner on record, and other designated parties, wherein the input data or requests may be used to initiate computation to determine whether to take an action related to the token. One example action is to revert ownership of the token. Another example action is to update the hosting of content related to the token.

Current NFT contracts frequently use a “base URI” for metadata, as the cost for the deployer of storing an individual URI for each token quickly becomes prohibitive as the number of tokens increases. Through this mechanism the cost of an individual token URI is borne by the token owner, who may elect to keep the generic URI, or supply their own URI at their own cost.

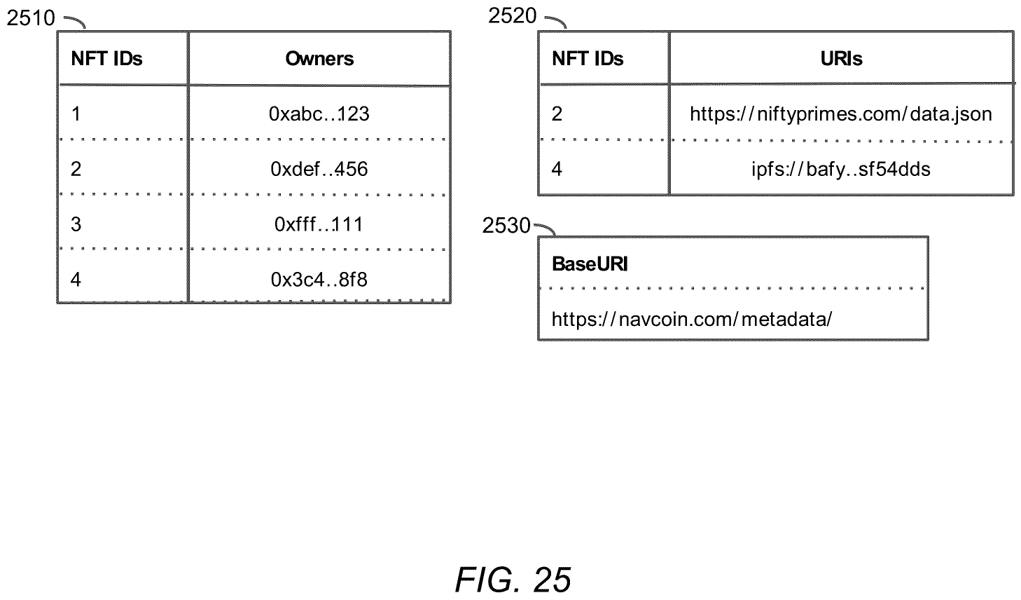

A collection of data structures implementing an NFT contract, configured in accordance with multiple embodiments of the invention, with individually controlled metadata URIs, is presented in FIG. 25. A first data mapping 2510 may provide a mapping from NFT IDs to Owners. For example, NFT 1 may be owned by a wallet including address 0xabc . . . 123.

A second data mapping 2520 may provide a mapping from NFT IDs to URI, for those NFTs that include a personalized metadata URI. For example, NFT ID 2 may map to a personal web server, https://niftyprimes.com/data.json, whereas NFT ID 1 may not have a personal mapping.

A string variable 2530 with variable name BaseURI may provide a string including a base URI, which in this example includes “https://navcoin.com/metadata/”.

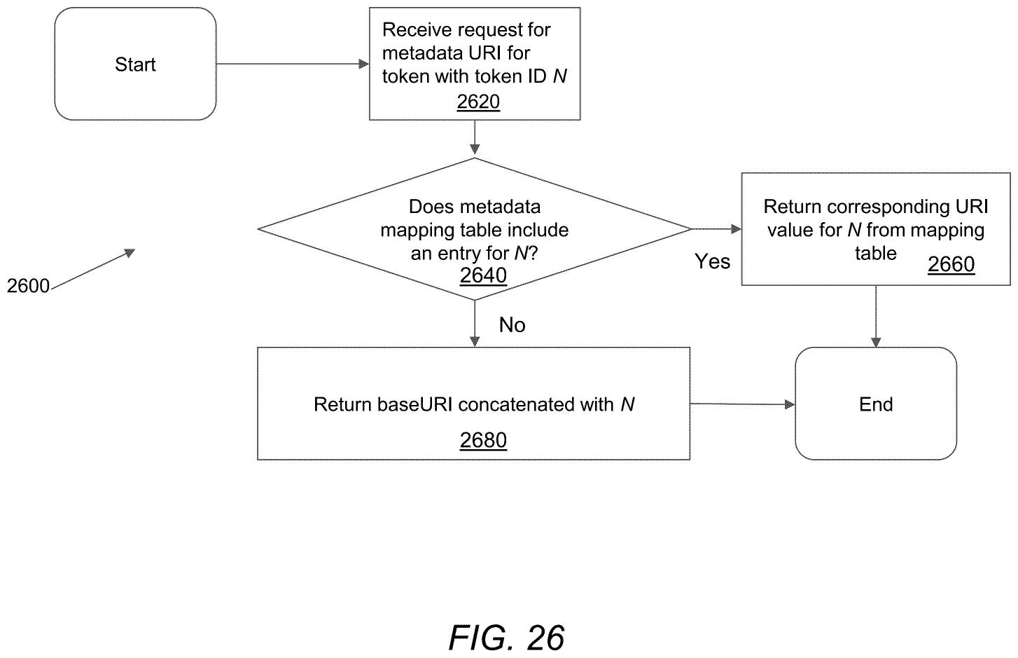

A process disclosing the application of a collection of data structures (e.g., those presented in FIG. 25) in an NFT smart contract configured in accordance with various embodiments of the invention, is illustrated in FIG. 26. Process 2600 receives (2620) a request by the NFT smart contract for a metadata URI for a token with ID N.

Process 2600 determines (2640) (e.g., through the NFT smart contract) whether the metadata mapping table includes an entry for the token with ID N. When the metadata mapping table includes the entry for the token with ID N, process 2600 may proceed to step 2660, otherwise actions may proceed to step 2680.

In step 2660, process 2600 (e.g., through the NFT smart contract) returns (2660) a corresponding URI value for the token with ID N, retrieved from the mapping table.

In step 2680, process 2600 (e.g., through the NFT smart contract) returns (2680) a baseURI variable concatenated with the numerical value N converted to a string, and in some embodiments, a “.json” postfix.

In an alternative embodiment, when the metadata mapping table does not include an entry for the token with ID N, only an owner of the token with ID N may submit a URI for the token with ID N. The NFT smart contract may require the URI to point to a resource stored on a decentralized file system.

While specific processes for retrieving metadata are described above, any of a variety of processes may be utilized to respond to requests as appropriate to the requirements of specific applications. In many embodiments, steps may be executed or performed in any order or sequence not limited to the order and sequence shown and described. In numerous, some of the above steps may be executed or performed substantially simultaneously where appropriate or in parallel to reduce latency and processing times. In several embodiments, one or more of the above steps may be omitted.

In a second embodiment, the non-fungible token contract may include a decentralized autonomous organization (DAO) or other smart contract structure enabling voting on proposals, in which certain functions of the contract that alter fundamental data affecting all tokens, such as the base uniform resource identifier (URI) of the token, can only be called successfully after a vote to do so passes, and wherein voting rights are accorded to the current owners of the NFTs. Different entities, such as users, may be associated with different weights, where the weight determines the importance of the vote, e.g., by incorporating into the tally a value corresponding to the weight for the option voted for. The weight may be determined based on the resources the entity has staked, based on the reputation of the entity, etc. The entity may represent a user, may be operated by a user or may be automated and cast the vote that is determined based on the evaluation of one or more rules or policies, which may be expressed using machine learning (ML) techniques, artificial intelligence (AI) or using processing of inputs using statistical methods, heuristic rules, and/or rules configured by human users and/or admins. The participants of a consensus mechanism may be granted the right to cast votes based on their historical involvement with the operations of the consensus mechanism.

For example, each NFT owner may have one vote, and in order to change the base URI a proposal to change the base URI may be submitted, and a predetermined portion of the NFT owners may be required to vote in favor of the proposal for the change to go through. Examples of NFT owners include but are not limited to: human users represented by wallets or other computational entities, such as browsers, allowing access to resources; tokens such as NFTs that are assigned as owners of resources by means to assigning said resources to an identifier identifying an owner NFT, where a public key associated with an NFT is an example of such an identifier; DAOs or other distributed entities, such as consensus mechanisms, with the capability to be assigned ownership; a bridge that temporarily assigns ownership of a resource to an address controlled by the bridge; and more.

Different voting systems may be implemented. For example, voting may have a time limit, measured in seconds or in the number of blocks added to the blockchain since a voting proposal was made. The proportion of votes required to pass or fail the voting proposal may be predetermined and fixed, or it may be dynamically altered based on the number of active votes cast in previous voting events. Votes may be based on “one NFT, one vote” or may be proportional to characteristics of the individual NFTs, with some special NFTs having two or more votes in a manner analogous to different classes of company shares, and other NFTs having no vote. In other implementations an NFT may have a number of votes which deplete as votes are cast, and in further implementations votes may accrue over time.

Those skilled in the art will appreciate in light of the above disclosures that the DAO may be implemented as a separate smart contract from the NFT smart contract, for example, or as a library of functions with associated data structures.

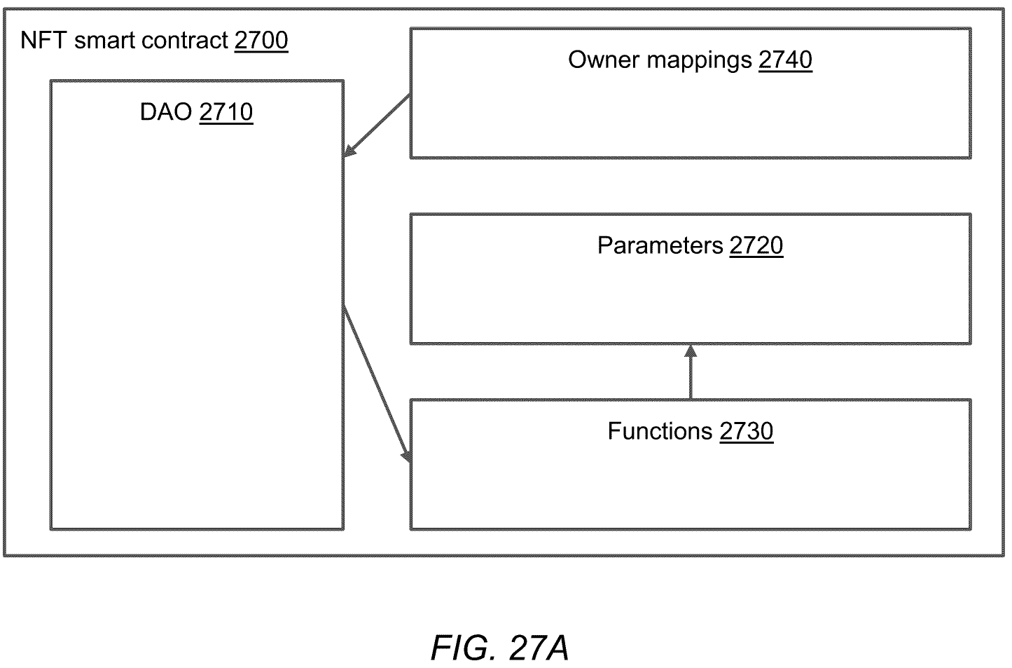

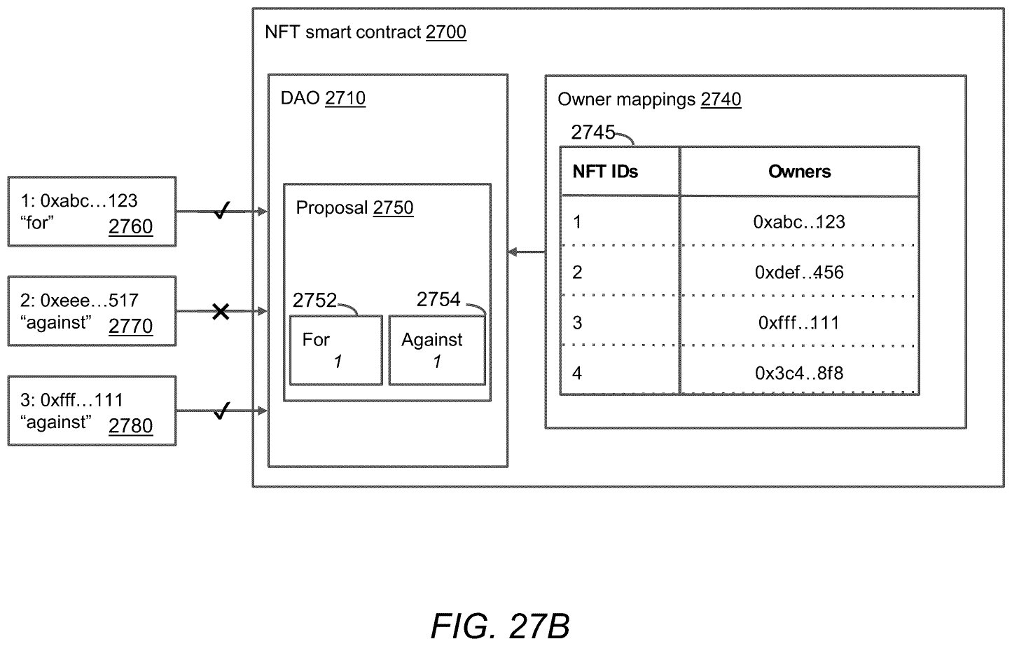

A smart contract, capable of being modified in accordance with various embodiments of the invention, is conceptually illustrated in FIGS. 27A-27B. FIG. 27A presents a block diagram, presented for illustrative purposes only and not meant to be limiting in any way, said block diagram illustrating a possible embodiment of an architecture for an NFT smart contract 2700 in which a DAO provides access to functions and an ability to alter parameters of the NFT smart contract. In the possible embodiment, the NFT smart contract includes a DAO 2710, a data structure representing owner mappings 2740, functions 2730 and parameters 2720.

FIG. 27B presents a block diagram illustrating a possible embodiment of underlying DAO functionality in relation to the owner mappings. The NFT smart contract 2700 again includes the DAO 2710 and the data structure representing owner mappings 2740. An example of possible data 2745 within the data structure representing an owner mapping 2740 is provided for illustrative purposes only and is not meant to be limiting in any way.

In the example the NFT smart contract 2700 includes four NFTs with IDs 1, 2, 3 and 4, owned by 0xabc . . . 123, 0xdef . . . 456, 0xfff . . . 111 and 0x3c4 . . . 8f8, respectively.

A proposal 2750 may have been previously put to the DAO 2710, and parties may submit transactions to the NFT smart contract 2700 voting against or for the proposal 2750.

A first voting transaction 2760 may originate from an address, 0xabc . . . 123, that owns an NFT—in this example NFT with ID 1. The first voting transaction 2760 may be “for” the proposal 2750. The first voting transaction 2760 may be accepted by the DAO 2710 as indicated in FIG. 4 by a checkmark (✓), as the first voting transaction 2760 is submitted by an address that owns an NFT, as verified by the DAO 2710 from the owner mappings 2740.

A second voting transaction 2770 may originate from an address, 0xeee . . . 5i7, that does not own an NFT even though it may claim to—in this example an NFT it may claim to own is an NFT with ID 1. The second voting transaction 2770 may be “against” the proposal 2750. The second voting transaction 2770 may be rejected by the DAO 2710 as indicated in FIG. 4 by a cross mark (X), as the second voting transaction 2770 is submitted by an address that does not own an NFT, as verified by the DAO 2710 from the owner mappings 2740.

A third voting transaction 2780 may originate from an address, 0xfff . . . 111, that owns an NFT—in this example NFT with ID 3. The third voting transaction 2780 may be “against” the proposal 2750. The third voting transaction 2780 may be accepted by the DAO 2710 as indicated in FIG. 4 by a checkmark (✓), as the first voting transaction 2780 is submitted by an address that owns an NFT, as verified by the DAO 2710 from the owner mappings 2740.

Accordingly, the DAO 2710 may tally a total number of votes for the proposal 2752 as one, and a total number of votes against the proposal 2754 as one.

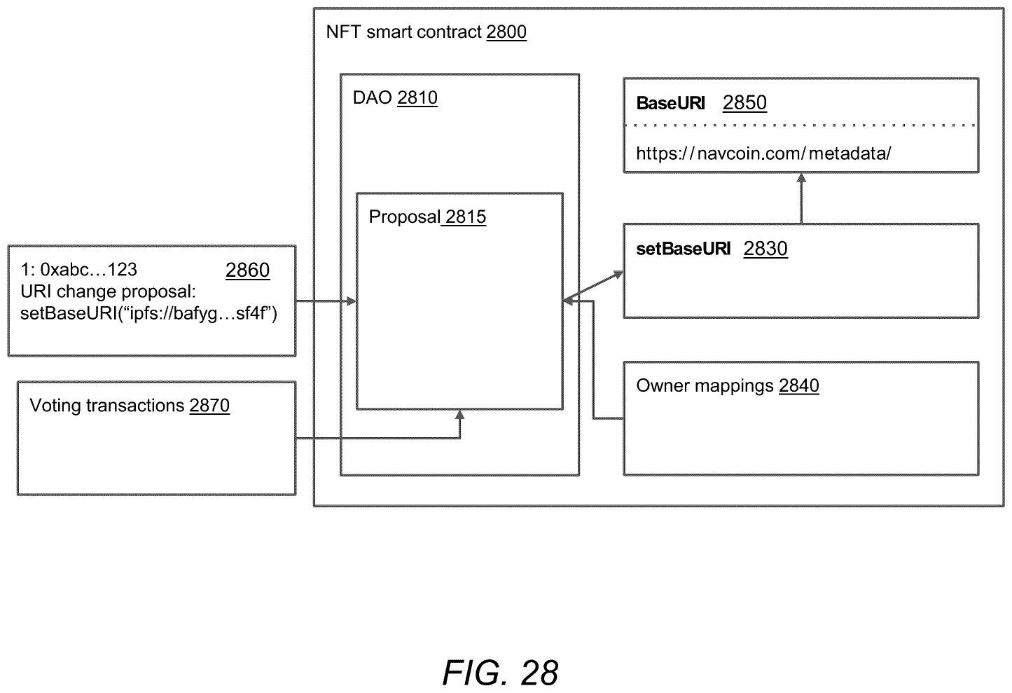

A process conceptually illustrating a proposal acceptance performed in accordance with certain embodiments of the invention is illustrated in FIG. 28. In FIG. 28 a block diagram presenting an example of an acceptance of a proposal is depicted, presented for illustrative purposes only and not meant to be limiting in any way. Those skilled in the art will appreciate the specifics of the example may be replaced with generalities, for example, the proposal may concern any parameter or smart contract function.

In the block diagram, an NFT smart contract 2800 includes a DAO 2810 capable of receiving proposals, and votes for or against proposals, from holders of NFTs instantiated by the NFT smart contract. The NFT smart contract 2800 may include a (e.g., data structure corresponding to a) parameter variable for a BaseURI 2850 and a setter function 2830 for said parameter variable. The NFT smart contract may also include a data structure mapping NFTs to owners—an owner mapping 2840.

An owner of an NFT may submit a proposal transaction 2860 to the DAO 2810, and the DAO 2810 may accept the proposal 2815 for voting, after verifying using the owner mapping 2840 that the owner of the NFT does own an NFT enabling the submission of proposals.

In this specific example, the proposal transaction includes a URI change proposal to change a base URI of the NFT contract, stored in the BaseURI variable 2850 from “https://navcoin.com/metadata” to “ipfs://bafyg . . . sf4f”. Those skilled in the art will appreciate in the light of this disclosure that a proposal may include one or more of many different possibilities, for example but not limited to: deleting a specific NFT, minting more NFTs, transferring an NFT from a current owner to a new owner, shutting down the NFT contract, removing voting rights from one or more NFTs, altering a number of votes an NFT or set of NFTs has, and so on. A proposal may also suggest altering parameters of the DAO 2810, for example but not limited to: increasing or decreasing a proportion of votes required for a proposal to pass, changing a size of a quorum, increasing or reducing a time frame within which voting must take place, and so on.

Voting on the proposal 2815 may then take place, as indicated by voting transactions 2870. When the voting transactions 2870 vote in favor of exacting the proposal 2815 the DAO 2810 may proceed to call a function within the NFT smart contract 2800, which in this specific example is the setBaseURI function 2830. The setBaseURI function 2830 may then alter the BaseURI 2850 data structure to include a new base URI, which in this example is “ipfs://bafyg . . . sf4f”.

Subsequently, when someone queries the NFT smart contract 2800 for a metadata URI associated with an NFT, the new base URI is returned.

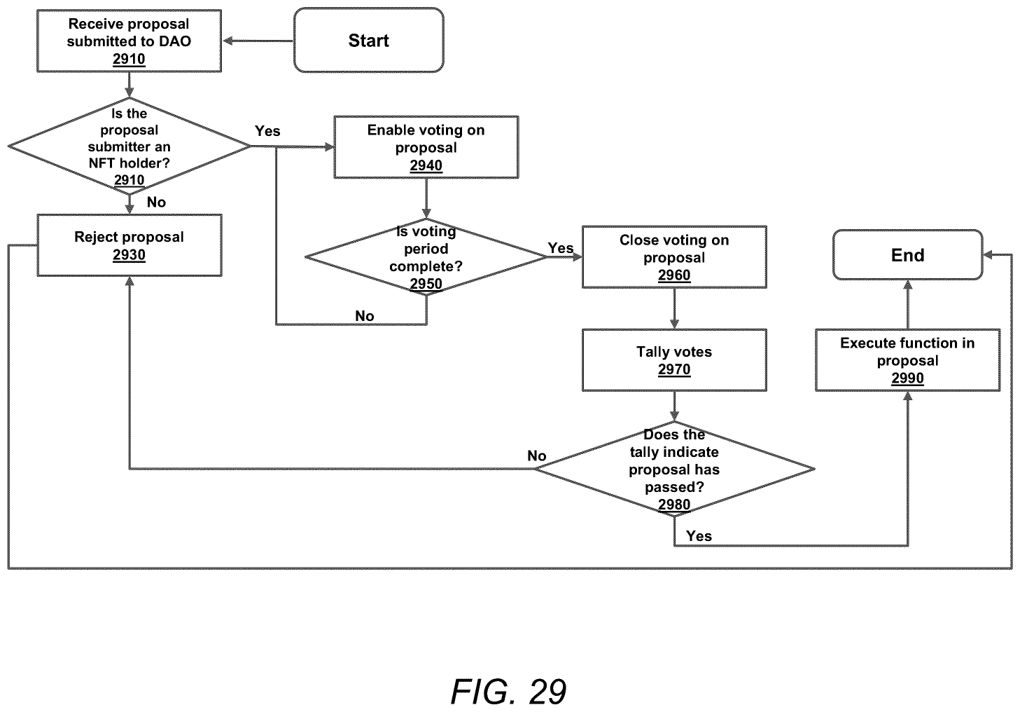

A process for proposing, voting on, and subsequently acting on an alteration to an NFT smart contract parameter, performed in accordance with certain embodiments of the invention is presented in FIG. 29. Process 2900 may be performed by a DAO in accordance with several embodiments of the invention. Process 2900 may commence by receiving (2910) a submission of a proposal to a DAO.

Process 2900 determines (2920) whether the proposal was submitted by a holder of an NFT. When the proposal was not submitted by the holder, process 2900 rejects (2930) the proposal. Otherwise, process 2900 enables (2940) voting on the proposal.

Process 2900 monitors (2950) the voting until the end of the (e.g., predetermined) voting period. When the voting period is not complete, process 2900 may return to step 2940 and voting on the proposal may remain enabled. Process 2900 closes (2960) at the end of the voting period.

Process 2900 tallies (2970) votes cast for and against the proposal.

Process 2900 determines (2980) whether the tally indicates whether the proposal has passed or not. When the proposal has failed to attract enough positive votes, process 2900 rejects (2930) the proposal. When the proposal has attracted enough positive votes, process 2900 executes (2990) a function in an NFT smart contract as specified in the proposal.

While specific processes for modifying parameters are described above, any of a variety of processes may be utilized to respond to requests as appropriate to the requirements of specific applications. In particular embodiments, steps may be executed or performed in any order or sequence not limited to the order and sequence shown and described. In some embodiments, some of the above steps may be executed or performed substantially simultaneously where appropriate or in parallel to reduce latency and processing times. In multiple embodiments, one or more of the above steps may be omitted.

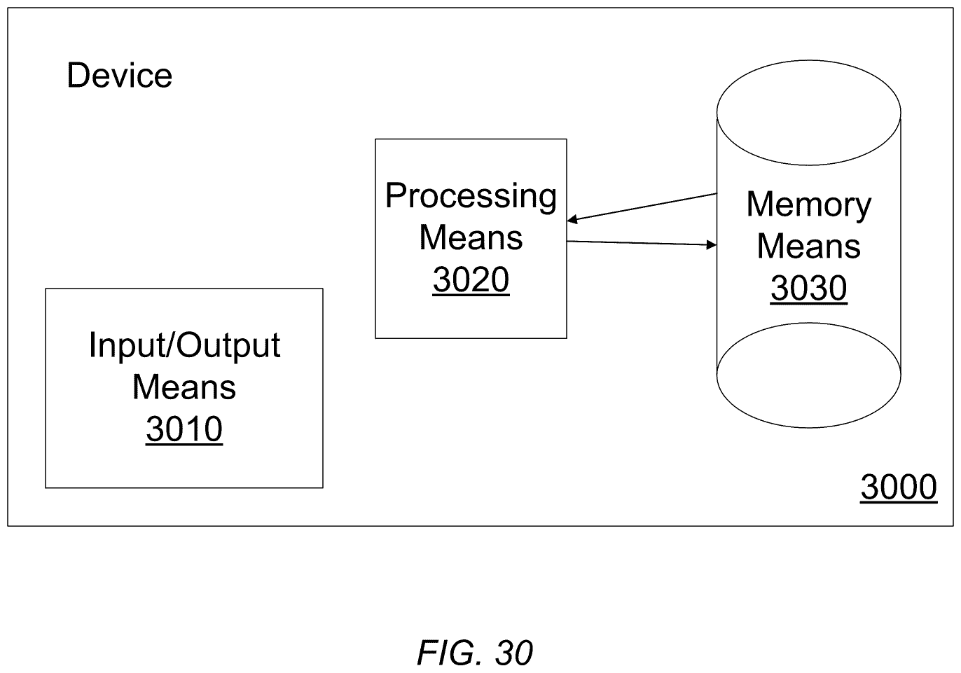

A physical model of a device, configured in accordance with various embodiments of the invention, for initiating decentralized modifications of smart contracts and/or enabling blockchain wallets with associated authenticators is illustrated in FIG. 30. The device 3000 includes memory means 3030, input/output means 3010, and processing means 3020 configured for facilitating voting processes.

Memory means 3030 may include but are not limited to instructions, which when executed by the processing means 3020 can allow the device 3000 to perform various methods configured in accordance with several embodiments of the invention. Additionally or alternatively, the device 3000 methods may be implemented through mediums including but not limited to servers, computers, smartphones, cloud servers and/or any entity/arrangement with processing means.

The device 3000 includes input/output means 3010 that can enable communication for the device 3000. Devices 3000 may utilize input/output means 3010 to receive, transmit and/or provide information to other units, devices and/or entities.

Applications and methods in accordance with many embodiments of the invention are not limited to use within NFT platforms. Accordingly, it should be appreciated that the voting configurations described herein may also be implemented outside the context of an NFT platform network architecture unrelated to the storage of fungible tokens and/or NFTs. Moreover, any of the DAO-directed systems and processes described herein with reference to FIGS. 25-30 (including decentralized modification processes) may be utilized within any of the systems implemented within the NFT platforms described above.

### Additional Improvements to Blockchain Wallet Technology

In the present disclosure we present systems and methods for simplifying and improving the user experience for users of a blockchain wallet, and expanding functionality, security and flexibility of related technologies.

Blockchain wallets show the user the blockchain addresses for their accounts. For example, for Bitcoin example addresses include 1JpE6P53Jo6aTW5R1 cCvUYJRAA1 FmL3Yfq (legacy addresses), 35WGRH3fFLtTP1vzrNhdYMyJqRjwv5Xt5m (multi-sig addresses), and/or bc1q69I5mm5983d8qj7fzqkv3juu9sc2kmw8txrkatfmch8rxpsq2pqsktaqnr (bech32 addresses), and for Ethereum example addresses include 0x68b3465833fb72A70ecDF485E0e4C7bD8665Fc45 (20-byte hex addresses). Typically, the majority of the characters and/or symbols including an address are hidden in wallet interfaces. For example, the Ethereum address 0x68b3465833fb72A70ecDF485E0e4C7bD8665Fc45 may be displayed as 0x68b34 . . . Fc45.

In a first embodiment of the present disclosure, a blockchain wallet may hide and/or conceal blockchain addresses from the user, thereby simplifying the interface, while providing further backend functionality and improved account handling to the blockchain wallet to compensate for the loss of immediate yet potentially confusing information provided to the user by the standard approach of presenting blockchain addresses. We proceed in this disclosure to present said methods and systems for improved account handling and data presentation to the user.

In a blockchain wallet in which blockchain addresses are hidden from the user, a need may arise to label individual accounts within the wallet with different names to assist in identifying them. A problem then arises due to the fact that when a seed phrase and/or mnemonic code as, for example, defined by BIP39, is used to configure a hierarchical deterministic wallet as, for example, specified in BIP32, the seed phrase and/or mnemonic code only provides means to generate the addresses for the accounts. This problem is seen in current wallets such as MetaMask, where it is possible to manually label an account, but this label is not subsequently transferred to future installations of MetaMask, for example, on other devices and/or in other browsers on the same device.

In a second embodiment of the present disclosure, a label for an account may be deterministically derived using one or more of a seed phrase, an index of the account, a private key of the account, a public key of the account, and/or a blockchain address of the account, henceforth referenced as an account name derivation schema.

The account name may be generated from a dictionary, which may include an indexed list of adjectives, verbs, and/or nouns. The account name derivation schema may provide indexes for a set of elements to select from the dictionary to deterministically construct a name for the account.

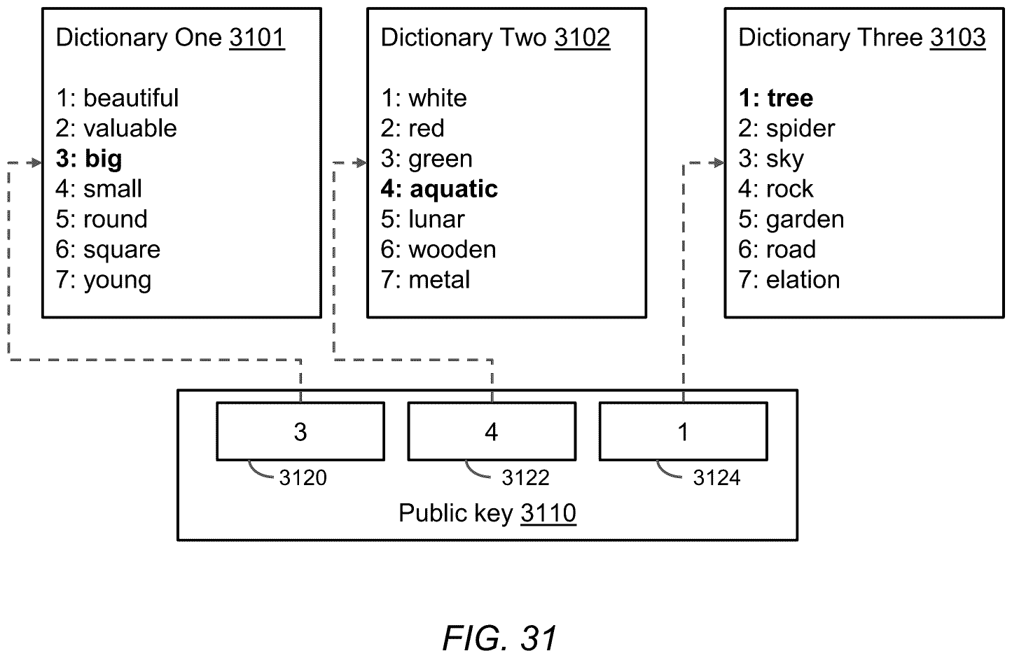

A block diagram depicting a deterministic generation of an account name for an account, performed in accordance with a number of embodiments of the invention, using a collection of dictionaries indexed from parts of a public key of the account, is illustrated in FIG. 31. For illustrative purposes, and not meant to be limiting in any way, a possible implementation of the second embodiment may include generating three index values from the public key 3110 of the account is presented in FIG. 31, where a first index value 3120 includes the first and second bytes of the public key, a second index value 3122 includes the third and fourth bytes of the public key, and a third index value 3124 includes the fifth and sixth bytes of the public key.

A first dictionary 3101 may include an indexed list of opinion, size, and shape and/or age-related adjectives, for example, “beautiful, valuable, big, small, round, square, young.” A second dictionary 3102 may include an indexed list of color, origin, and material adjectives, for example, “white, red, green, aquatic, lunar, wooden, metal”. A third dictionary 3103 may include an indexed list of nouns, for example “tree, spider, sky, rock, garden, road, elation”.

In some embodiments the user may set language settings prior to generating the account name, enabling the generation of an account name in a selected language.

Subsequently, in the possible implementation of the second embodiment, an account name may be generated by selecting a member of each of the first dictionary, the second dictionary, and the third dictionary using the corresponding first index, second index, and third index, optionally modulo a length of each dictionary. For example, when the first index is 3, the second index is 4 and the third index is 1, in the present possible implementation, a name of the account would be “big aquatic tree”.

Those skilled in the art will, in light of the above disclosure, appreciate that there exist many different strategies for generating dictionaries to be used, criteria for selecting words for the dictionaries, lengths of the dictionaries, and methods for mapping an account to a subset of words from the dictionaries exist based on the same principle. Similarly, more bytes and/or a different selection of bytes from the private key, public key, and/or blockchain address may be used as an input for generating the account name, and cryptographic hash functions may be applied to each of the fragments of the input. In the example presented in FIG. 31, three dictionaries were used, but more, and/or less dictionaries may be implemented and used in the generation of the account name. Dictionaries may be longer in some embodiments.

An advantage of the second embodiment of the present disclosure is that network connectivity and/or an internet connection are not required, and no cloud server and/or file server is needed to reconstitute a list of account names for the blockchain wallet. Thus a user may enter a seed phrase for an offline hardware wallet and may subsequently view account names with no internet and/or network connectivity required.

In a variant of the second embodiment, when a user requests a generation of a new account, the blockchain wallet may generate a plurality of account numbers, for example, using BIP44, and may subsequently generate a plurality of account names, each account name corresponding to an account number. The user may then select an account name from the plurality of account names that they find preferable, for example more aesthetically appealing and/or memorable.

In some embodiments, the blockchain wallet may subsequently register details of the new account on the blockchain, either through a transaction including the account name, and/or through a call to a smart contract that records the account name and optionally the blockchain address and/or public key it corresponds to.

In a third embodiment of the present disclosure, labels for accounts of a blockchain wallet may be generated by the user, encrypted using an encryption key for a symmetric and/or asymmetric key cryptography algorithm, and then stored on a file server and/or in the cloud. The encryption key may be derived from a seed phrase for the blockchain wallet, and/or from a subsequently derived encryption key.

Seed phrases are described in BIP39, and a standard dictionary is provided for generating a seed phrase from an initial random number, typically 256 bits in length.

It may, however, be desirable to provide initial random numbers of a different length, and utilize dictionaries of different lengths. In one embodiment, a plurality of dictionaries may be used to generate a seed phrase that forms a meaningful sentence. For example, a meaningful phrase may commence with <opinion adjective> <size adjective> <noun> <verb> <adverb> <preposition> <shape adjective> <age adjective> <noun> <verb> <adverb>, with the plurality of dictionaries thus including an opinion adjective dictionary, a size adjective dictionary, a noun dictionary, a verb dictionary, an adverb dictionary, a shape adjective dictionary, an age adjective dictionary, and so on. A seed could be used as an input to a natural language sentence generator, enabling two-way mapping.

Thus the seed phrase may form a meaningful memory sentence, which in some embodiments may include an addition of non-dictionary words such as “the” and “a” and other such words to produce a more grammatically correct sentence. Thus, in an exemplary case provided for illustration only and not meant to be limiting in any way, a seed phrase may start with “the angry slow fox jumps rapidly over the round old dog sleeping fitfully.”

The length of the seed phrase may be computed by the system based on the number of entries in the selected dictionary, to create a sufficiently long phrase to encode the random and/or pseudo-random string that is the seed. A seed may be represented by a multiplicity of seed phrases in a multiplicity of languages. Here, a language does not need to be a natural language, but could be icon-based, for example. In some embodiments, there may be error correction and/or error detection methods applied to the seed before the resulting value is represented as a seed phrase. In such situations, there will be some error correcting and/or error detecting capabilities, enabling a slightly mis-typed and/or otherwise incorrectly entered seed phrase to be processed by the system. In cases where there is error detection but not error correction, the system may indicate an error message to the user when the seed phrase entered is almost correct, but not quite. When error correction is used, minor errors can be automatically corrected by the system. However, larger errors cannot, thereby protecting the system against brute-force attacks.

As noted in the background to the present disclosure, the BIP44 standard and associated wallet standards BIP43, BIP39, and BIP32, as well as numerous derived standards for other blockchains, such as Stellar's SEP-0005 standard.

In the co-pending application U.S. patent application Ser. No. 18/176,920, titled “Partitioned Address Spaces in Blockchain Wallets,” filed Mar. 1, 2023, which is incorporated in its entirety by reference, we introduce a partitioning of wallets wherein the set of addresses corresponding to accounts in the wallet are partitioned into subsets, which in some embodiments are disjoint, and wherein each subset includes limitations and/or extended capabilities in comparison to other subsets in relation to the transactions that addresses in each subset are permitted and/or prohibited to conduct.

In an embodiment of the present disclosure, an account derivation function, a master seed, and path schema may be used to generate blockchain addresses, and furthermore, the path schema may be used to indicate to either the wallet, the blockchain, and/or both, what limitations and/or extended capabilities may be enforced on addresses derived from the path instantiated under the path schema, based on elements of the path.

In an example presented for illustrative purposes only and not meant to be limiting in any way, an element of the path may be used to indicate which subset includes an address derived from the path, and the blockchain protocol and/or the wallet generating the address may enforce limitations and/or permissions on the address including, but not limited to: restricting transfers to addresses within other subsets, restricting and/or permitting transfers based on value being transferred, restricting and/or permitting transfers based on time, location, and/or some other temporal and/or spatial aspect, restricting and/or permitting transfers to specific tagged and/or marked addresses, restricting and/or permitting transfers to smart contracts, some other restriction and/or permission, and conditionally permitting and/or restricting actions, transactions, and/or actions of addresses based on the subset including the address in combination with a policy, prior action, and/or event occurring on-chain and/or off-chain and relayed on-chain through a digitally signed notification and/or through an oracle, protocol upgrade and/or alteration, through a notification call to a smart contract, and/or some other means of communication.

In other embodiments, more account types may be specified with further indexes, such as 3, 4, and 5. For example, index 3 may be used to specify accounts with transfer amount limitations, index 4 may be used to specify accounts with a limited number of transactions over a given period of time, and so on.

In a first specific embodiment of the example, an Ethereum wallet may include a four-level derivation path of the form/purpose′/coin_type′/0′/account_type′/address_index, where the value of account_type′ may be selected as follows:
0′: hot accounts
1′: warm accounts
4′: cold accounts
8′: two-factor authentication accounts
16′: accounts requiring secondary authorization
32′: time limited accounts
64′: value limited accounts

In light of the above disclosure, a person of skill in the art will recognize that other classifications are also possible and can be used to introduce further granularity and/or descriptive capabilities. In some embodiments, purposes, permissions, and limitations to accounts may be defined as follows:
a hot account may be used for any purpose without restriction,
a warm account may only transfer assets to accounts in a contact list and/or collection of known accounts and/or accounts that a hot account has previously transacted with, and in some further embodiments the contact list may include further restrictions and/or permissions either added manually, automatically, and/or by an approved third party,
a cold account may be restricted to permit only transfers of assets to hot and/or warm accounts, thus, in some embodiments, acting as a secure vault for assets,
a two-factor authentication account may require an additional input of a one-time password (OTP) from an algorithm, for example, a hash-based message authentication code one-time password (HTOP) algorithm, a time-based one-time password (TOTP) algorithm, a one-time password pad, and/or a one-time password hash pad (OTPHP) algorithm, as disclosed above,
an account requiring secondary authorization, which in some embodiments may require one or more authorizing signatures and/or signed transactions from another party and/or parties before a transaction is processed by the blockchain,
a time limited account may, in some embodiments, be subject to time-based limitations on actions permitted, for example but not limited to: a maximum number of transactions being permitted within a predefined period of time, and/or in which a transaction is held for a predetermined period of time before being transmitted and/or processed,
a value limited account may be restricted to a maximum number of asset transfers and/or a maximum known and/or estimated value of assets being permitted to be transferred.

In some embodiments, classes of accounts may include combinations of account types, with bits within the account_type′ property representing each property and/or type of account. For example, using the above definitions, a time limited account subject to a two-factor authentication requirement and a value limitation may be represented by 8 (2FA account type)+32 (time limited account type)+64 (value limited account type)=104, and thus the account_type′ would equal 104, and/or 0b0001011 in binary.

The wallet may then impose limitations on transfers out of the warm accounts and cold accounts, as disclosed in U.S. patent application Ser. No. 18/176,920, titled “Partitioned Address Spaces in Blockchain Wallets,” filed Mar. 1, 2023, incorporated by reference in its entirety.

In the first specific embodiment of the example, the Ethereum wallet is able to determine which derivation path has been used for which account, and may thus impose the limitations, restrictions, and/or permissions accordingly.

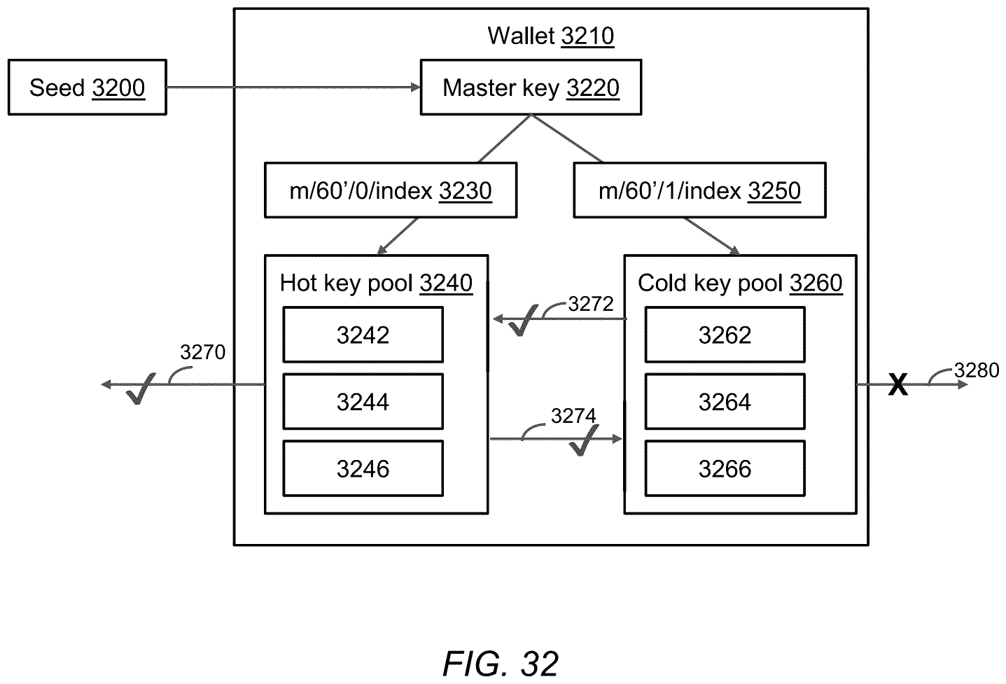

A block diagram depicting a hierarchical deterministic wallet, configured in accordance with some embodiments of the invention, with derivation paths for generating distinct subsets of keys, wherein different permissions and/or restrictions apply to sets of addresses generated from each subset of keys, is illustrated in FIG. 32. What follows is an exemplary embodiment, presented for illustrative purposes only, and not meant to be limiting in any way. In the exemplary embodiment of FIG. 32, a wallet 3210 may be initialized through a provision of a master seed 3200, either through a generation of a random number, and/or entry of a mnemonic phrase, generating a master key 3220. Subsequently a first derivation path 3230 may be used with the master key 3220 to generate a hot key pool 3240 including addresses qualified as hot addresses 3242, 3244, 3246, and a second derivation path 3250 may be used with the master key 3220 to generate a cold key pool 3260 including addresses qualified as cold addresses (3262, 3264, 3266).

Transactions from addresses in the hot key pool 3240 may be permitted, regardless of destination. For example, an outbound transaction 3270 to an address outside the wallet 3210 may be permitted, as well as an internal transaction 3274 from a hot key pool address to any other address within the wallet.

Transactions from addresses in the cold key pool 3260 may be restricted to internal transactions only, for example, with an internal transaction 3272 from an address in the cold key pool 3260 to an address in the hot key pool 3240 being permitted, but with an outbound transaction 3280 from an address in the cold key pool 3260 to an address outside the wallet 3210 being prohibited.

Outside the wallet it is not immediately possible to determine whether an account is derived from an account_type 0, 1, 2 and/or some other account type to which restrictions apply, and hence impose said restrictions. Nevertheless, with a public seed and/or public node, it is possible to allow a third-party to derive all public keys without knowing and/or compromising the corresponding private keys. In a possible embodiment of the present disclosure, therefore, a transaction may include one or more accompanying derivation paths for a public key extracted from a digital signature generated with a corresponding private key, a receiving address, and/or other public keys and/or blockchain addresses present in the transaction. A third party may thus independently derive the public key and determine which account type the public key falls under, and thus determine whether the transaction is permitted.

Thus in a second embodiment the permissions and/or restrictions may be imposed either through a watchful bridge, as disclosed in co-pending PCT Patent Application No. PCT/US23/62851, titled “Systems and Methods for Abuse Safeguards in NFT-Directed Environments,” filed on Feb. 17, 2023, which is incorporated in its entirety by reference, through a smart contract on a blockchain, and/or at a base protocol level of the blockchain.

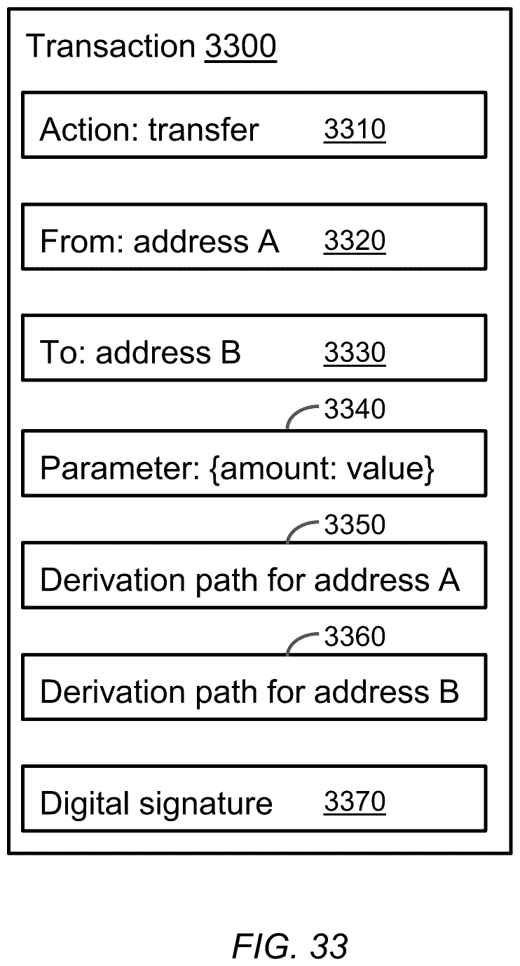

A block diagram depicting a transaction, performed in accordance with certain embodiments of the invention with derivation paths for the sender address and receiver address, is illustrated in FIG. 33. A possible embodiment of the second embodiment, presented for illustrative purposes only and not meant to be limiting in any way, is presented in FIG. 33 as a block diagram representing a transaction including: an action 3310, which in the present example is a transfer, a from address 3320, a to address 3330, a parameter 3340 specifying an amount to transfer, a derivation path for the from address 3350, a derivation path for the to address 3360, and a digital signature 3370 of the transaction.

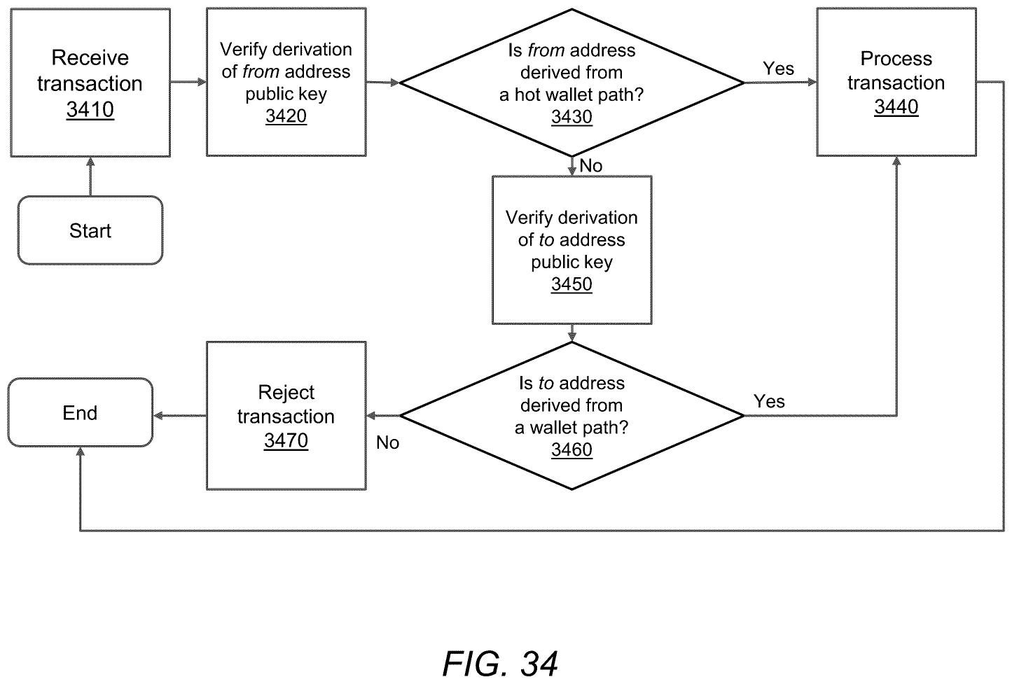

On receiving the transaction, a blockchain node and/or watchful bridge may inspect the transaction to determine whether it is a valid transaction, as illustrated in a flowchart in FIG. 34.

A process for determining transaction permissions in accordance with some embodiments of the invention (based on the addresses of the transaction) is illustrated in FIG. 34. Process 3400 receives (3410) a transaction. Process 3400 may be performed by but is not limited to one or more blockchain nodes and/or watchful bridges.

Process 3400 verifies (3420) a derivation of a sender address and/or from address public key in the transaction. In some embodiments, the blockchain node and/or the watchful bridge may reject the transaction when the derivation of the sender address and/or from address cannot be verified. When the sender address and/or from address can be verified, process 3400 may proceed to step 3430.

Process 3400 determines (3430) whether the sender address and/or from address was derived from a hot wallet derivation path. When the determination is “yes,” process 3400 processes (3440) the transaction. Processing the transaction may include transmitting the transaction to other nodes and/or watchful bridges, including the transaction in a candidate block for addition to the blockchain, digitally signing the transaction, and/or transmitting the transaction to a validator.

When the determination in step 3430 is “no”, process 3400 may proceed to step 3450.

Process 3400 verifies (3450) a derivation of the recipient address and/or to address. In some embodiments, the blockchain node and/or the watchful bridge may reject the transaction when the derivation of the recipient address and/or to address cannot be verified. When the recipient address and/or to address can be verified, actions may proceed to step 3460.

Process 3400 determines (3460) whether the recipient address and/or to address was derived from a wallet derivation path. When the determination is “yes,” process 3400 processes (3440) the transaction. Processing the transaction may include transmitting the transaction to other nodes and/or watchful bridges, including the transaction in a candidate block for addition to the blockchain, digitally signing the transaction, and/or transmitting the transaction to a validator.

When the determination in step 3460 is “no”, process 3400 rejects (3470) the transaction.

In some embodiments, steps 3410 to 3470 may be undertaken by a blockchain miner, validator, auditor, transaction orderer, and/or some other blockchain component instead of and/or as well as the blockchain node and/or watchful bridge.

While specific processes for verifying transactions are described above, any of a variety of processes may be utilized to respond to requests as appropriate to the requirements of specific applications. In numerous embodiments, steps may be executed or performed in any order or sequence not limited to the order and sequence shown and described. In many embodiments, some of the above steps may be executed or performed substantially simultaneously where appropriate or in parallel to reduce latency and processing times. In some embodiments, one or more of the above steps may be omitted.

In some embodiments, whether in addition to a seed phrase and/or instead of it, a user may request from a system and/or be provided from the system a set of seed phrase shards. For example, using a (k,n) secret sharing scheme to encode the seed value, n seed shares can be generated, wherein any k of these seed shares can be used to interpolate the associated polynomial and determine the seed value, but wherein no k−1 seed shared provides any information about the seed value. Each seed share is represented as a seed share phrase, which may have a similar format and structure as seed phrases, but which may also in some embodiments be shorter.

The account owner may store the seed phrase in a secure place, such as in a bank vault, and may distribute the seed share phrases to one or more entities that he trusts, and wherein such entities may be users, storage locations believed to be safe, and/or combinations of such. For example, when (k,n)=(5,8), the seed would be used to create 8 seed shares, any 5 of which can be used to generate the seed, but wherein no 4 shares can provide information about the seed. The eight seed share phrases are mapped by the system to seed share phrases, resulting in 8 such phrases. The user may keep one such phrase in his desk, may send another to himself or herself by email, and then distribute three of the other seed share phrases to his or her best friends, and the remaining three shares to his or her CPA, attorney, and dentist. The user may also have a seed phrase created, wherein this can be stored in a bank vault. As usual, the seed phrase can be used to determine the seed. However, the seed share phrases cannot, in isolation, but a total of at least 5 of them, in this illustrative example, would be needed to reconstitute the seed. A hacker that gains access to the seed share phrase stored in the email would not be able to access the crypto funds. A burglar that accesses the contents of the user's desk would also not. The three family members, colluding with each other, likewise would not be able to determine the seed, nor would the CPA, attorney and dentist. Some seed share phrases may be covertly incorporated in media, such as a photo of the user, e.g., using steganography. Thus, the representation of one seed share phrase does not have to be the same as that of another: one seed share phrase may be represented as a sequence of English words; another as a sequence of Spanish words; a third as a QR code on a sticker that may be placed on the user's refrigerator, and yet another as a steganographically encoded photo of an octopus. A variety of secret sharing schemes may be used, as will be appreciated by a person of skill in the art, and a (k,n) secret sharing scheme, such as Shamir secret sharing, is just one illustrative example. The system may automatically cause the rendering and/or transmission of these, e.g., by causing printouts to be made, emails to be sent, requests for photos to be enlarged, etc. The user may select the threshold (e.g., k) and the total number of shares (n), as well as the encoding methods and the manner of distribution, and/or some of these aspects.

In the co-pending U.S. patent application Ser. No. 18/155,662, titled “Crypto Wallet Configuration Data Retrieval,” filed Jan. 17, 2023, which is incorporated by reference, we introduce the use of an external storage, such as a cloud storage, for storing configuration information associated with a wallet. Such storage can be used in the context of the disclosed technology, as will be understood by a person of skill in the art, and its techniques integrate readily with the techniques disclosed herein. The use of external storage can be used to store any configuration data associated with a wallet and can be encrypted using a key derived from a seed, and/or from one or more seed shards. In one embodiment, described above, a (5,8) secret sharing is used for splitting a seed into 8 pieces, any five of which can be used to reconstitute the seed. Some functionality, such as the decryption of data stored in a cloud storage, can be performed using one specific such seed share, which corresponds to different access structures than those which are associated with the generation of private keys. Alternatively, the data stored in the cloud storage may be encrypted using a key that is derived from the seed. This key may be a public key, requiring an associated private key also derived from the seed to be decrypted. The key used for encryption and decryption may also be a symmetric key, which may be derived from the seed. When the wallet configuration data is stored in an encrypted format, it is not necessary to require that only authorized users access the encrypted data. The wallet configuration data may include naming of elements, such as keys, directories used for storing funds and/or NFTs, information about access rights such as what users associated with the wallet may perform which actions related to the tokens associated with the wallet, and more. Such access rights may be implemented by a second layer of encryption of resources (such as token information, including keys required to transfer tokens, and/or token payload information such as media content) using keys that some wallet users have stored in their partitions of the wallet, which may be protected using biometrically governed access control, and/or which they generate using user passwords, passcodes and/or other user-specific information. An authenticator app can be used to verify unique users with access to various resources. Other configuration information that can be stored includes but is not limited to data identifying layout of user interfaces (UIs), functional parameters such as parameters that govern the manner in which resources are presented, made accessible, etc. This may include icons and other graphics, executable code, rules, access control lists (ACLs), and more.

Such data may enable cross-platform unification of UIs, e.g., creating a similar and/or uniform User experience (UX) across different devices used to access the data. Such methods are disclosed in co-pending U.S. patent application Ser. No. 18/155,662, titled “Crypto Wallet Configuration Data Retrieval,” filed Jan. 17, 2023, which is incorporated by reference in its entirety. The encrypted wallet configuration data may also include personal data, such as biometric template information, calendar data, address book information, sensitive documents, and information related to user authentication information including but not limited to digital passports, digital driver licenses, keychains, information about access to financial accounts and other password management data. We envision the convergence of multiple security-sensitive services, such as crypto wallets, digital passports, keychains, and more, where different devices accessing the services may be associated with different access rights, whether these different devices correspond to different but related users, and/or to the same users employing different devices. This enables, for example, lower access capabilities from a user's regular cellular phone (as this may be exposed to high risk) than the access capabilities of a device stored in a vault (which is more secure against attack than the cellular phone that may be lost and/or stolen much more easily).

In one embodiment, the address associated with a token is tied to a physical address, such as a UUID and/or other machine identifier, as a manner of creating an identity that is associated with the physical entity with that physical address. This is an example of anchoring, which is disclosed in co-pending applications U.S. patent application Ser. No. 17/808,264, titled “Systems and Methods for Token Creation and Management,” filed Jun. 22, 2022; U.S. patent application Ser. No. 17/934,146, titled “Cryptographically Enabling Characteristic Assignment to Identities with Tokens, Token Validity Assessments and State Capture Processes,” filed Sep. 21, 2022; and U.S. patent application Ser. No. 17/933,659, titled “Systems and Methods for Token Content Unlocking, Biometric Authentication using Privacy-Protecting Tokens, Ownership-Based Limitations of Content Access, Policy-Based Time Capsule Technology, and Content Lock Mechanisms,” filed Sep. 20, 2022, incorporated by reference in their entireties. This effectively creates a token-to-entity link. By using the private key associated with the address, the token—and therefore also the physical entity—can be reassigned in terms of ownership, including putting in escrow while the physical entity is being shipped. Relevant methods for managing entities that are anchored are disclosed in co-pending U.S. patent application Ser. No. 17/401,687, titled “Proxy Management and Attribution,” filed Aug. 13, 2021, incorporated by reference in its entirety.

As disclosed in co-pending applications U.S. patent application Ser. No. 18/323,344, titled “Systems and Methods for Facilitating Access to Token Content,” filed May 24, 2023; and U.S. patent application Ser. No. 18/323,344, titled “Systems and Methods for Facilitating Access to Token Content,” filed May 24, 2023 (incorporated by reference in their entireties) tokens can own tokens. This ownership structure can be described by a directed acyclic graph (DAG). One or more of the nodes in such a DAG may be anchored. One type of anchoring is to a physical entity, as described above. Another type of anchoring is to a logical entity, e.g., an enterprise and/or a governing and/or managerial entity of a jurisdiction and/or geopolitical entity. For example, an enterprise may tie a collection of physical entities to itself by means of an expression of token-based ownership such as hardware servers, as well some collection of logical entities such as virtual machines associated with a domain of the enterprise, and wherein some of these physical and/or logical entities control, by means of ownership, some resources, such as other physical and/or logical entities, and wherein some of these entities may be tokens, such as NFTs and/or crypto currency tokens. Similarly, a distributed software entity, which may be described by one or more tokens referencing and/or containing software and/or machine learning components, can own some other collection of resources, whether physical and/or logical, and may transfer, reconfigure and/or otherwise process data using these resources.

One or more of the nodes of a DAG such as described above may (but do not have to be) associated with a user interface (UI) that enables the collection of user requests, user decisions, and more, where a user may be a typical end user and/or an admin, and/or a person with partial admin rights. The user interface of one or more of these nodes may be expressed in a manner that hides blockchain addresses, whereas some others may display blockchain addresses. One node may correspond to a first device, operated by a child, wherein this child can make a request for service that is propagated to a second node, corresponding to a second device, operated by the child's parents, and where the request is received, and a response is determined. The response may be a permission, the absence of a permission, and/or a suggested modification of the request. The UI associated with the first node may be different from the UI of the second node, and may have, for example, much less information (such as blockchain addresses).

Traditional blockchain based payments rely on online, and near-real-time access to the blockchain used, to identify attempts of double-spending. One goal of the present invention is to enable offline purchases and off-line transfers of non-fungible tokens. One approach to implement this is to relate an off-line coin to an escrowed resource, such as an escrow account containing sensitive information, large amounts of funds, real-estate title documents and associated private keys useful to transfer the title, and/or simply identifying information of a payer. Should the payer overspend the off-line coin then this will result in an ability of an entity (which may be a trusted entity) to access the escrowed resource.

In one embodiment, the on-line access to the blockchain is guaranteed to take place with some specified frequency, and/or statistically speaking accessible with a known distribution, at which time it is possible to determine whether an offline coin was overspent and to perform a penalty action, such as releasing the escrowed documents, transferring access rights to the escrowed documents, etc. In the case of the escrowed data corresponding to staked funds, the staking may be required to last for a time that exceeds a threshold time that is longer than the duration between assumed on-line accesses to the blockchain, thereby keeping the escrowed resource tied up to the escrow account for the duration during which the offline use of the coin may take place.

In another embodiment, every transaction may result in a forced online access to report the transaction to the blockchain, where the probability of such a report may depend on the value of the token that is being transacted, wherein higher values result in a larger probability of access, and therefore, reporting. This is a probabilistic detection scheme wherein massive overspending is overwhelmingly likely to be detected sooner than minimal overspending, and once detected, the corresponding offline coins may be blacklisted on a channel that is mostly constantly available to users, e.g., which is largely online. This enables the rapid blocking of coins that are overspent, whether the system also uses capabilities to unlock escrow accounts for purposes of exacting a punishment or not.

The capability to decrypt and access the escrowed information may reside with a set of collaborating trusted entities that, when collaborating (e.g., in a sufficient sized quorum) can decrypt the entry and prove to each other using standard zero-knowledge methods that their decryption action was performed correctly. The capability to access may also be linked to the double-spending itself, similar to how 1990s style digital cash could be traced when overspent. An example of such a scheme is the Chaumian ecash, where each spending corresponds to a point on a polynomial, and overspending results in the capability to interpolate the polynomial, thereby being able to access a master secret. This may identify the user, as in Chaumianesque ecash methods, but could also encode the private key and/or secret key needed for decryption of the escrowed data associated with the off-line payment. The offline payment token would include an indicator that, at least under some conditions, can be used to identify and access the contents of an escrowed data block.

The Chaumian ecash approach is primarily useful for non-fungible tokens and for tokens with limited granularity of fungibility, e.g., tokens that can be spent up to a hundred times.

To spend two units of such tokens, the payer may have to reveal two points on the polynomial. This can be avoided in the implementation where a trustee (which may be selected by the payer a priori) performs the de-escrowing, i.e., tracing and/or unlocking. The trustee may be distributed. A token may be associated with one or more trustees wherein any one of them is capable of performing the decryption associated with de-escrowing, and where such trustees may include multiple collaborating parties. A payee may require payments associated with trustees he and/or she finds acceptable.

In a possible embodiment of the Chaumianesque approach for the present disclosure, ownership of a plurality of amounts of fungible tokens may be transferred to a corresponding plurality of NFTs. Ownership of fungible tokens by NFT is disclosed in co-pending U.S. patent application Ser. No. 18/323,344, titled “Systems and Methods for Facilitating Access to Token Content,” filed May 24, 2023, which is incorporated by reference in its entirety. In an example of the possible embodiment of the Chaumian approach, presented for illustrative purposes only, and not meant to be limiting in any way, an amount of a fungible token, for example 20 units of the fungible token, may be transferred to a set of five NFTs, which may subsequently be transacted off-line.

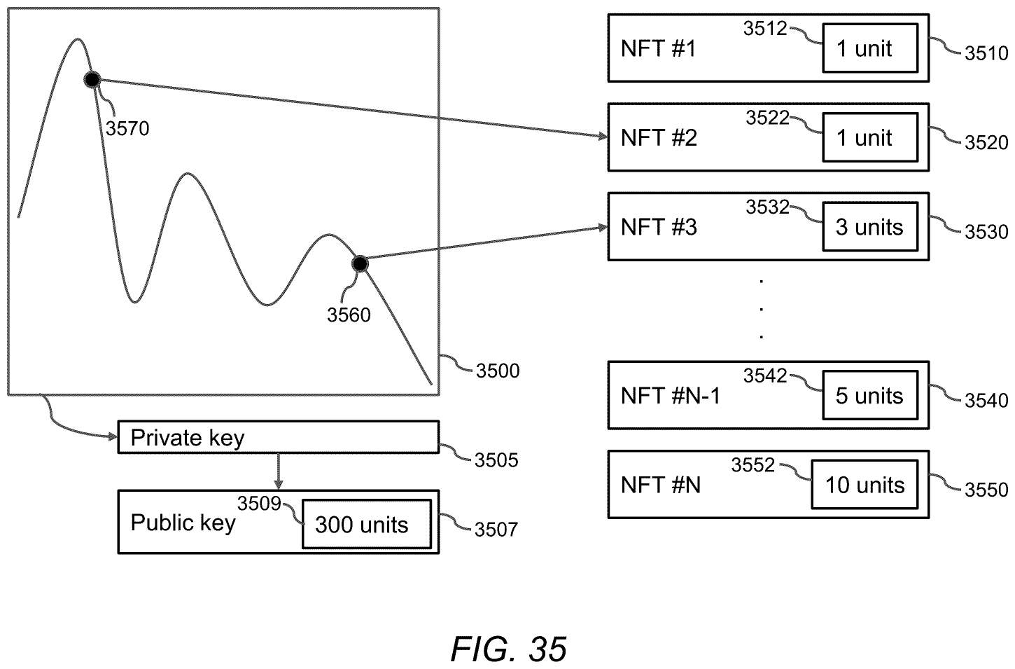

A block diagram depicting a Chaumian ecash approach, performing in accordance with various embodiments of the invention, for offline transactions of fungible tokens using non-fungible tokens, is illustrated in FIG. 35. The example illustrated in FIG. 35 has a function defining a polynomial 3500 may encode a private key 3505 controlling a public key 3507 owning an escrow amount of a fungible token 3509. When the polynomial is of order N, then when N+1 points on the polynomial are known, the function defining the polynomial 3500 may be determined, and thus the private key 3505.

N non-fungible tokens are also specified, each holding an amount of a fungible token. In FIG. 35, as part of the illustrative example, NFT #1 3510 may own 1 unit of the fungible token 3512, NFT #2 3520 may own 1 unit of the fungible token 3522, NFT #3 3530 may own 3 units of the fungible token 3532, and so on, through to NFT #4 3540, which may own 5 units of the fungible token 3542 and NFT #5 3550, which may own 10 units of the fungible token 3552. In general, the NFTs may own amounts of the fungible token that allow for a variety of totals to be constructed by combining subsets of the amounts of the fungible token.

To generate a valid transfer of an amount of the fungible token, new distinct points on the polynomial 3500 are revealed. For example, as shown in FIG. 35 for illustrative purposes only, to transfer 4 units of the fungible token, NFT #2 3520 owning 1 unit of the fungible token 3522 and NFT #3 3530 owning 3 units of the fungible token 3532 may be transferred by disclosing distinct point 570 and distinct point 560 on the polynomial.

When a total sum of all units stored in NFTs #1 through to NFT #N is less than the escrow amount of the fungible token 3509, it is not in the interest of the transactor to reveal more than N distinct points on the polynomial 3500, as this allows a second party to determine the exact coefficients of the polynomial 3500, construct the private key 3505, and hence transfer the escrow amount from the public key 3507 and/or a blockchain address derived from the public key 3507 to an address controlled by the second party.

Those skilled in the art will now appreciate, in light of the above disclosure, that the plurality of NFTs, each holding an amount of non-fungible token, function as a digital equivalent to banknotes with different denominations, and that the present method as described instantiates decentralized denominated electronic banknotes.

Escrow may be performed using other assets of value, such as a different cryptocurrency and/or fungible token, non-fungible token, and/or some other digital asset instantiated on the blockchain. The fungible token amount may be subdivided into a different collection of amounts owned by a different number of NFTs.

In one embodiment, a first wallet transfers funds to a second wallet with a specification indicating one or more allowed uses of the funds. The one or more allowed uses may specify the allowed recipient of the funds, after the second wallet transfers them; they may specify a given transaction, e.g., a description of the purpose of a transfer from the second wallet to a recipient wallet and/or provide a list of categories of transaction types that are permissible and/or prohibited; they may specify an amount allowed for a particular transaction; they may indicate a maximum spending limit per time period; they may specify conditions under which the funds may be spent, e.g., only when a particular event occurs; they may specify what happens when the funds are not spent, e.g., the ownership is reversed to the first wallet after a given time period.

The specification may be implemented using a smart contract. This mechanism is useful for a large variety of reasons. It can be used for a first wallet (the “parental wallet”) to indicate allowed transactions (“only educational games”) to a second wallet (the “child wallet”); it can be used to avoid fraud, since it would require both the first and the second wallet to be corrupted and/or their users social engineered, and it can be used to create new approval structures, where a manager (associated with one of the wallets) has to approve a purchase request from an employee (the other wallet).

The approach is not limited to chains of length two, as described above, but this could correspond to any length; it may also correspond to various graph structures wherein the selection of the next address and/or account in line is made by an entity currently reviewing a transfer possibility. Entities along the flow of the graph may add constraints to conditions set by previous nodes in the graph, and/or in some cases may be permitted to remove constraints. One or more of the nodes in the graph may correspond to an automated script that automatically evaluates a request and performs a corresponding determination. Such nodes may also make requests to other nodes, e.g., to generate a conditional transfer, to verify user approval using a user interface, to validate the authenticity of a transfer by requesting that a biometric verification is performed, etc. By modifying the graph structure based on the actions of one or more nodes (which may correspond to tokens, wallets, computational entities, physical users, and/or combinations thereof), a dynamic graph structure is implemented. This does not have to be a directed acyclic graph but may have loops as long as it satisfies criteria related to halting. This enables an expansion of flexibility of ownership, access and control in comparison with the approaches disclosed in co-pending U.S. patent application Ser. No. 18/323,344, titled “Systems and Methods for Facilitating Access to Token Content,” filed May 24, 2023; and U.S. patent application Ser. No. 18/323,344, titled “Systems and Methods for Facilitating Access to Token Content,” filed May 24, 2023, incorporated by reference in their entireties. Some of the nodes controlling the process may be distributed. One or more tokens may also be able to control the contents of a wallet, e.g., by being associated with one or more policies indicating the conditions of acquiring and selling tokens, and/or otherwise transfer tokens to other wallets, where such other wallets may correspond to one of the wallets described above, where that wallet may correspond to a token that owns tokens, and which initiates and/or approves of transfers, but where another wallet and/or token have to collaborate for the transfer to complete. Thus, the same techniques that are described for wallets herein may also be performed by one or more tokens that may be autonomous (e.g., using one or more scripts) and/or may be controlled by a user, at least in part.

A user may be associated with one or more addresses, each one of which may hold tokens, e.g., NFTs and crypto funds. Some addresses may be associated with fraud, e.g., be used to receive illegitimate payments. Examples of illegitimate payments include, but are not limited to, payments for releasing kidnapped people and/or other extortion attacks, funds stolen using breaches, hacks, phishing attacks, and various social engineering-based attacks such as Nigerian scams. An address receiving such payment may be associated with a negative reputation, where a very small payment (such as one Satoshi) results in a very small reduction of reputation while a larger payment (such as a payment corresponding to thousands of dollars) may have its reputation affected more. When a victim reports and provides evidence of abuse, the reputation reduction may be even greater.

In one embodiment, when a recipient refuses a payment, the associated reputation modification is not performed. Optionally, on the recipient side, a user interface associated with a wallet may inform a user of reputational impacts associated with accepting the transfer of a payment and/or an NFT, enabling the user to accept and/or deny the receipt of the associated token.

When an address is a repeat recipient of illegitimate funds, and/or a large portion of the received money cannot be verified to be legitimate, then the modification may also be larger. The determination of what reduction to make can be made using an AI trained on information where the legality of a payment is known and/or believed to be known. The same can be done to create a positive reputation, but causing increases in reputation. Receiving money (or NFTs) from an address that has a poor reputation reduces the reputation, whereas receiving tokens from an address with a good reputation increases the reputation. Receiving tokens from addresses without a reputation may be handled using an AI that determines the likelihood that the transfer is used to dilute an already reduced reputation and/or to pre-emptively improve the reputation of a new address. Since criminals may use multiple addresses to launder money, the reputation mechanism we describe may cause such laundering to reduce the reputation of these addresses.

Similarly, anybody receiving payments from a mix network and/or other mechanism used for laundering of funds may see his or her address to which these funds are received have its reputation negatively affected, where the extent of the reduction may depend on the size of the transfer as well as the reputation of the mix network and/or other laundry mechanism. An honest user would not want to be paid from an account with bad reputation and may therefore refuse such payments and/or require a risk premium to compensate for the “resale value” of the funds, based on yet-another user's requirements for risk premiums. The exact risk premium may be determined using a publicly agreed formula and/or using individually set formulae associated with the recipients. The same applies to receipt of NFTs, where the willingness to pay for these may be affected by the reputation of the address from which the NFT is transferred. This is a distributed mechanism for suppression of abusive behavior. Moreover, the reputation of an address may inform the actions of the trustees described above, where these trustees decrypt escrowed data in order to apply penalties to abusive users.

Second order and/or further order patterns may be examined to determine what reduction and/or increase in reputation score to apply. For example, an address under examination may regularly receive payments from addresses with a low reputation score, lowering the reputation of the address under examination, immediately and/or almost immediately followed by a payment from a single address with a high reputation score and a large balance. The reputation system may thus deduce that the single address is being used to improve the status of the address under examination and may therefore apply a further reputation penalty on the address under examination, and possibly also the single address.

Addresses can also be considered accounts. An account may correspond to one or more reputation scores, where a first reputation score indicates the extent to which illegal payments have been received at the account, which may include transfers of funds that are sent from collaborating accounts, where these collaborating accounts obtained the funds in a manner that is considered illegal and/or undesirable. Another reputation score may indicate the receipt of funds for which later complaints were filed by the payer, e.g., for not receiving the expected goods and/or services in return. As the first reputation score, this second reputation score may also indicate funds that were transferred from accounts that have a poor reputation of this type, and where it is determined that the accounts are collaborating, e.g., managed by the same entity and/or by two or more closely coordinated entities. A third reputation score may indicate a third type of undesirable behavior, and a fourth reputation score may correspond to an aggregate of the first, second and third reputation scores. This aggregate may be computed in a variety of manners and may be generated on a device where a determination will be made, whether by an algorithm, a user and/or a combination thereof, of whether to engage with a particular entity or not, such entity corresponding to the accounts.

A user interface coupled to a recipient device obtaining and/or otherwise generating one or more recommendation values and comparing these to one or more thresholds is used to display to a user a set of options. This set may not include all available options, as some options may correspond to a reputation score below a threshold set by the user and/or determined by an AI associated with the user, where said AI may observe the user's selections and actions and generate a model of risk. Different users may wish for an automated determination to be made to filter out some options based on the one or more reputation scores of the associated options, and/or a ranking to be made, where said ranking may be made based on one or more of the reputation scores, one or more of offering prices for the token and/or associated service to be acquired. The user interface may render previews for one or more of the options. When no options are available, based on a search query by the user, then the user interface may indicate the reason (e.g., too low reputation scores, unavailability of tokens and/or services in a given jurisdiction associated with the user, a price that exceeds a threshold associated with the user, and/or a combination of such indications, where the combination may be generated using an AI).

Smart contracts, like externally owned accounts and/or addresses, may also be associated with fraud, for example, to receive illegitimate payments and/or to disguise and/or launder funds obtained through criminal activity. Examples of illegitimate smart contract actions include, but are not limited to, transactions co-mingling tainted cryptocurrency and/or fungible tokens with clean cryptocurrency and/or tokens to launder funds, exchanging tainted cryptocurrency and/or fungible tokens for other cryptocurrency and/or fungible tokens, and/or purchasing NFTs using tainted cryptocurrency and/or fungible tokens on behalf of a criminal and/or fraudster.

As with addresses, smart contracts receiving such payment may be associated with a negative reputation, where a very small payment (such as one wei and/or gwei) results in a very small reduction of reputation while a larger payment (such as a payment corresponding to thousands of dollars) may have the contract's reputation affected more. When a victim reports and provides evidence of abuse, the reputation reduction may be even greater.

In one embodiment, a smart contract may include instructions and/or code that allow the smart contract to examine a registry of current reputational scores, and may permit the smart contract to refuse a payment from addresses with a score below a given reputational level. Under such circumstances, the associated reputation modification to the score of the smart contract is not performed. Optionally, a payment to the smart contract may be placed in escrow, and an owner of a smart contract may be able to assess the nature and origins of the payment, and may subsequently permit the smart contract to accept and/or deny the receipt of the associated token and/or payment.

When a smart contract is a repeat recipient of illegitimate funds, and/or a large portion of the received money cannot be verified to be legitimate, then the modification to the reputational score may also be larger. The determination of what reduction to make can be made using an AI trained on information where the legality of a payment is known and/or believed to be known. The same can be done to create a positive reputation, but causing increases in reputation. Receiving money (or NFTs) from an address that has a poor reputation reduces the reputation of the smart contract, whereas receiving tokens from an address with a good reputation increases the reputation.

Applications and methods in accordance with numerous embodiments of the invention are not limited to use within NFT platforms. Accordingly, it should be appreciated that the blockchain wallet configurations described herein may also be implemented outside the context of an NFT platform network architecture unrelated to the storage of fungible tokens and/or NFTs. Moreover, any of the wallet-directed systems and processes described herein with reference to FIGS. 31-35 may be utilized within any of the systems implemented within the NFT platforms described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for authenticating a token transaction, the method comprising:
receiving a request to perform a transaction from a device, wherein the transaction corresponds to a transfer of at least one token;
selecting, from a plurality of verifiers, a transaction verifier for the request;
transmitting a collection of data to the transaction verifier, wherein the collection of data:
corresponds to at least one of the transaction or the request; and
comprises a recipient identifier and an authentication value for a requesting user;
receiving, from the transaction verifier, a validity evaluation for the transaction, wherein the validity evaluation comprises:
a first preliminary assessment of whether the request is properly authenticated; and
a second preliminary assessment of whether the request complies with at least one security policy associated with the at least one token; and
evaluating the request, wherein evaluating the request:
is based, at least in part, on at least one of the first preliminary assessment or the second preliminary assessment, and
comprises:
when the request is evaluated as unsafe, rejecting the request; and
when the request is evaluated as safe, processing the request.

2. The method of claim 1, wherein:
rejecting the request comprises at least one of encrypting the request, removing authentication information from the request, requiring a second-factor authentication to proceed with the request, transmitting a request rejection to the device, or performing a direct verification of authorization to make the transaction; and
processing the request comprises at least one of transmitting the request to a blockchain node and transmitting a request acceptance to the device.

3. The method of claim 1, wherein a token of the at least one token is a non-fungible token (NFT).

4. The method of claim 1, wherein:
the authentication value comprises at least one of a digital signature, a message authentication code, a one-time code, a password, or a personal identification number; and
the first preliminary assessment comprises a verification of whether the authentication value for the requesting user corresponds to an owner of a first token of the at least one token.

5. The method of claim 1, wherein:
evaluating the request first comprises deriving a risk score for an initial sender of the transaction;
the risk score is derived based on at least one of: the identity of the requesting user, or potential maliciousness of the transaction;
the request is evaluated as unsafe when the risk score falls below a predetermined threshold; and
the request is evaluated as safe when the risk score meets or exceeds the predetermined threshold.

6. The method of claim 1, wherein:
each verifier in the plurality of verifiers is associated with a trust score; and
the trust score corresponds to an accuracy estimation of the verifier when authenticating requested transactions.

7. The method of claim 1, wherein the transaction verifier is an automated agent that executes in a secure environment.

8. The method of claim 7, wherein the automated agent is a machine learning model trained on evaluations performed for other requests by other verifiers of the plurality of verifiers.

9. The method of claim 1, the collection of data further comprises at least one of: a valuation of the transaction, a time limit corresponding to the transaction, a nonce corresponding to the transaction, a metadata file corresponding to the transaction, or a request header corresponding to the transaction.

10. The method of claim 9, wherein the at least one security policy comprises a requirement for one or more of:
the recipient identifier not being on a recipient banlist;
the recipient identifier being on a recipient allowlist;
an internet protocol address of the device not being a requestor banlist;
the internet protocol address of the device not being a requestor banlist;
the valuation of the transaction falling under a predetermined transaction maximum; or
the request being received during a certain time of day.

11. A non-transitory computer-readable medium comprising instructions that, when executed, are configured to cause a processor to perform a process for authenticating a token transaction, the process comprising:
receiving a request to perform a transaction from a device, wherein the transaction corresponds to a transfer of at least one token;
selecting, from a plurality of verifiers, a transaction verifier for the request;
transmitting a collection of data to the transaction verifier, wherein the collection of data:
corresponds to at least one of the transaction or the request; and
comprises a recipient identifier and an authentication value for a requesting user;
receiving, from the transaction verifier, a validity evaluation for the transaction, wherein the validity evaluation comprises:
a first preliminary assessment of whether the request is properly authenticated; and
a second preliminary assessment of whether the request complies with at least one security policy associated with the at least one token; and
evaluating the request, wherein evaluating the request:
is based, at least in part, on at least one of the first preliminary assessment or the second preliminary assessment, and
comprises:
when the request is evaluated as unsafe, rejecting the request; and
when the request is evaluated as safe, processing the request.

12. The non-transitory computer-readable medium of claim 11, wherein:
rejecting the request comprises at least one of encrypting the request, removing authentication information from the request, requiring a second-factor authentication to proceed with the request, transmitting a request rejection to the device, or performing a direct verification of authorization to make the transaction; and
processing the request comprises at least one of transmitting the request to a blockchain node and transmitting a request acceptance to the device.

13. The non-transitory computer-readable medium of claim 11, wherein a token of the at least one token is a non-fungible token (NFT).

14. The non-transitory computer-readable medium of claim 11, wherein:
the authentication value comprises at least one of a digital signature, a message authentication code, a one-time code, a password, or a personal identification number; and
the first preliminary assessment comprises a verification of whether the authentication value for the requesting user corresponds to an owner of a first token of the at least one token.

15. The non-transitory computer-readable medium of claim 11, wherein:
evaluating the request first comprises deriving a risk score for an initial sender of the transaction;
the risk score is derived based on at least one of: the identity of the requesting user, or potential maliciousness of the transaction;
the request is evaluated as unsafe when the risk score falls below a predetermined threshold; and
the request is evaluated as safe when the risk score meets or exceeds the predetermined threshold.

16. The non-transitory computer-readable medium of claim 15, wherein:
each verifier in the plurality of verifiers is associated with a trust score; and
the trust score corresponds to an accuracy estimation of the verifier when authenticating requested transactions

17. The non-transitory computer-readable medium of claim 11, wherein the transaction verifier is an automated agent that executes in a secure environment.

18. The non-transitory computer-readable medium of claim 17, wherein the automated agent is a machine learning model trained on evaluations performed for other requests by other verifiers of the plurality of verifiers.

19. The non-transitory computer-readable medium of claim 11, the collection of data further comprises at least one of: a valuation of the transaction, a time limit corresponding to the transaction, a nonce corresponding to the transaction, a metadata file corresponding to the transaction, or a request header corresponding to the transaction.

20. The non-transitory computer-readable medium of claim 19, wherein the at least one security policy comprises a requirement for one or more of:
the recipient identifier not being on a recipient banlist;
the recipient identifier being on a recipient allowlist;
an internet protocol address of the device not being a requestor banlist;
the internet protocol address of the device not being a requestor banlist;
the valuation of the transaction falling under a predetermined transaction maximum; or
the request being received during a certain time of day.
